(19) United States
(12) Patent Application Publication
(10) Pub. No.: US 2016/0217333 A1
(43) Pub. Date: Jul. 28, 2016

(54) INFORMATION PROCESSING APPARATUS AND INFORMATION PROCESSING SYSTEM

(71) Applicant: Kenichi OZAWA, Kanagawa (JP)

(72) Inventor: Kenichi OZAWA, Kanagawa (JP)

(73) Assignee: RICOH COMPANY, LTD., Tokyo (JP)

(21) Appl. No.: 15/000,163

(22) Filed: Jan. 19, 2016

(30) Foreign Application Priority Data
Jan. 26, 2015 (JP) 2015-012056
Jun. 15, 2015 (JP) 2015-120558

(51) Int. Cl. G06K 9/00; G06K 9/78; G08G 1/16; G06T 7/00

(52) U.S. Cl. CPC G06K 9/00805; G06T 7/004; G06K 9/78; G08G 1/167; G08G 1/164; G06T 2207/30261; G06T 2207/30244

(57) ABSTRACT

An information processing apparatus provides information to a user of a vehicle. The information processing apparatus includes a detector configured to detect a first obstacle around the vehicle, by using a monitoring unit configured to monitor an area around the vehicle; an acquirer configured to acquire information relating to a position of the detected first obstacle; an information transmitter configured to transmit first obstacle information including the acquired information relating to the position of the first obstacle, to a first external apparatus; an information receiver configured to receive second obstacle information including information relating to a position of a second obstacle, from a second external apparatus; and a display controller configured to display, on a displayer, information relating to the second obstacle, based on the received second obstacle information.

### BACKGROUND OF THE INVENTION

1. Field of the Invention

The present invention relates to an information processing apparatus and an information processing system.

2. Description of the Related Art

There is known a technology of using a photographing apparatus, an object recognition sensor, etc., installed in a vehicle such as an automobile, to recognize danger, etc., present in the surroundings of the vehicle, controlling the vehicle, and alerting the driver of the vehicle. Furthermore, there is known a safe driving viewpoint device that displays an alert screen by superimposing the alert screen on map information corresponding to a target detection area in which an obstacle is positioned, based on information including the obstacle in a target area received from a roadside machine and information including the own-vehicle position (see, for example, Patent Document 1).

The technology disclosed in Patent Document 1 includes acquiring the information of an obstacle in the target detection area by using an image sensor installed on the roadside, and sending the information of an obstacle to the vehicle that has travelled in the communication area of an optical beacon header. Therefore, for example, it is not possible to report, to the user of a travelling vehicle, etc., any information of an obstacle such as a fallen object that has fallen at a location other than the predetermined target detection area in which the image sensor is set.

As described above, in the conventional technology, it has been difficult to quickly report the information of an obstacle, etc., at any point on the road, to the user of a vehicle travelling near the obstacle.

Patent Document 1: Japanese Patent No. 4990421

### SUMMARY OF THE INVENTION

The present invention provides an information processing apparatus and an information processing system, in which one or more of the above-described disadvantages are eliminated.

According to an aspect of the present invention, there is provided an information processing apparatus for providing information to a user of a vehicle, the information processing apparatus including a detector configured to detect a first obstacle around the vehicle, by using a monitoring unit configured to monitor an area around the vehicle; an acquirer configured to acquire information relating to a position of the detected first obstacle; an information transmitter configured to transmit first obstacle information including the acquired information relating to the position of the first obstacle, to a first external apparatus; an information receiver configured to receive second obstacle information including information relating to a position of a second obstacle, from a second external apparatus; and a display controller configured to display, on a displayer, information relating to the second obstacle, based on the received second obstacle information.

According to an aspect of the present invention, there is provided an information processing system including an information processing apparatus for providing information to a user of a vehicle; and at least one external apparatus installed along a road, wherein the information processing apparatus includes a detector configured to detect a first obstacle around the vehicle, by using a monitoring unit configured to monitor an area around the vehicle, an acquirer configured to acquire information relating to a position of the detected first obstacle, an information transmitter configured to transmit first obstacle information including the acquired information relating to the position of the first obstacle, to a first external apparatus, an information receiver configured to receive second obstacle information including information relating to a position of a second obstacle, from a second external apparatus, and a display controller configured to display, on a displayer, information relating to the second obstacle, based on the received second obstacle information, and wherein the at least one external apparatus includes a receiver configured to receive the first obstacle information including the information relating to the position of the first obstacle sent from the information processing apparatus, and a reporter configured to report the received first obstacle information or information based on the first obstacle information, to at least one of the information processing apparatuses or at least one of the vehicles within a predetermined range.

According to an aspect of the present invention, there is provided a non-transitory computer-readable recording medium storing a program that causes a computer that constitutes an information processing apparatus for providing information to a user of a vehicle, to execute a process, the process including detecting a first obstacle around the vehicle, by using a monitoring unit configured to monitor an area around the vehicle; acquiring information relating to a position of the detected first obstacle; transmitting first obstacle information including the acquired information relating to the position of the first obstacle, to a first external apparatus; receiving second obstacle information including information relating to a position of a second obstacle, from a second external apparatus; and displaying, on a displayer, information relating to the second obstacle, based on the received second obstacle information.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are for describing an overview of an information processing system according to an embodiment (1);

FIG. 2 is for describing an overview of an information processing system according to an embodiment (2);

FIG. 3 illustrates a hardware configuration example of an information processing apparatus according to an embodiment;

FIG. 4 illustrates a hardware configuration example of a communication apparatus according to an embodiment;

FIG. 5 illustrates a functional configuration of the information processing system according to a first embodiment;

FIG. 6 is a flowchart indicating a process performed by the information processing apparatus according to the first embodiment (1);

FIG. 7 is a flowchart indicating a process performed by the information processing apparatus according to the first embodiment (2);

FIG. 8 is a flowchart indicating a process performed by the information processing apparatus according to the first embodiment (3);

FIG. 9 is a flowchart indicating a process performed by the communication apparatus according to the first embodiment (1);

FIG. 10 is a flowchart indicating a process performed by the communication apparatus according to the first embodiment (2);

FIG. 11 illustrates a configuration example of a control unit of the information processing apparatus according to a second embodiment;

FIG. 12 illustrates a configuration example of a report control unit of the communication apparatus according to the second embodiment;

FIGS. 13A and 13B illustrate examples of update frequency information according to the second embodiment;

FIGS. 14A and 14B are for describing an overview of the information processing system according to a third embodiment (1);

FIG. 15 is for describing an overview of the information processing system according to a third embodiment (2);

FIG. 16 illustrates a functional configuration of the information processing system according to the third embodiment;

FIG. 17 is a flowchart indicating a process of a standby mode performed by the information processing apparatus according to the third embodiment;

FIG. 18 is a flowchart indicating a process of a detection mode A performed by the information processing apparatus according to the third embodiment;

FIG. 19 is a flowchart indicating a process of selecting the update frequency information performed by the information processing apparatus according to the third embodiment;

FIG. 20 is a flowchart indicating a process of a standby mode performed by the communication apparatus according to the third embodiment;

FIGS. 21A and 21B are a flowchart indicating a process of a detection mode performed by the communication apparatus according to the third embodiment;

FIG. 22 is a flowchart indicating a process of setting the update frequency information performed by the communication apparatus according to the third embodiment;

FIGS. 23A and 23B are for describing an overview of the information processing system according to a fourth embodiment;

FIG. 24 illustrates a hardware configuration example of the communication apparatus according to the fourth embodiment;

FIG. 25 illustrates a functional configuration of the communication apparatus according to the fourth embodiment;

FIG. 26 illustrates an example of sorting information according to the fourth embodiment;

FIG. 27 is a flowchart indicating an example of a process of a standby mode performed by the communication apparatus according to the fourth embodiment;

FIG. 28 is a flowchart indicating an example of a setting change process performed by the communication apparatus according to the fourth embodiment;

FIGS. 29A and 29B are a flowchart indicating an example of a process of a detection mode performed by the communication apparatus according to the fourth embodiment;

FIGS. 30A and 30B are a flowchart indicating an example of a data analysis process performed by the communication apparatus according to the fourth embodiment;

FIG. 31 is a flowchart indicating an example of a process of a standby mode performed by the information processing apparatus according to the fourth embodiment;

FIG. 32 is a flowchart indicating an example of a process of a data reception mode performed by the information processing apparatus according to the fourth embodiment;

FIG. 33 is a flowchart indicating an example of a process of a detection mode performed by the information processing apparatus according to the fourth embodiment;

FIG. 34 illustrates a functional configuration of the communication apparatus according to a fifth embodiment;

FIG. 35 illustrates a functional configuration of the information processing apparatus according to the fifth embodiment;

FIGS. 36A through 36C indicate examples of the sorting information according to the fifth embodiment;

FIG. 37 is a flowchart indicating an example of a process of monitoring the surrounding environment performed by the communication apparatus according to the fifth embodiment;

FIG. 38 is a flowchart indicating an example of a setting change process performed by the communication apparatus according to the fifth embodiment;

FIGS. 39A and 39B are a flowchart indicating an example of a process of a detection mode performed by the communication apparatus according to the fifth embodiment;

FIGS. 40A through 40C are a flowchart indicating an example of a process of a data reception mode performed by the information processing apparatus according to the fifth embodiment;

FIGS. 41A and 41B are for describing an overview of the information processing system according to a sixth embodiment;

FIG. 42 illustrates a functional configuration of the information processing system according to the sixth embodiment;

FIGS. 43A through 43C illustrate an example of whether to receive obstacle information according to the sixth embodiment;

FIG. 44 is a flowchart indicating an example of a process of a standby mode performed by the information processing apparatus according to the sixth embodiment;

FIG. 45 is a flowchart indicating an example of a setting change process performed by the information processing apparatus according to the sixth embodiment;

FIGS. 46A through 46C are flowcharts indicating an example of a process of a data reception mode performed by the information processing apparatus according to the sixth embodiment; and

FIG. 47 is a flowchart indicating an example of a communication process between information processing apparatuses according to the sixth embodiment.

### DETAILED DESCRIPTION OF THE PREFERRED EMBODIMENTS

A description is given, with reference to the accompanying drawings, of embodiments of the present invention.

### <Overview of System>

First, a description is given of an overview of an information processing system 100 according to the present embodiment.

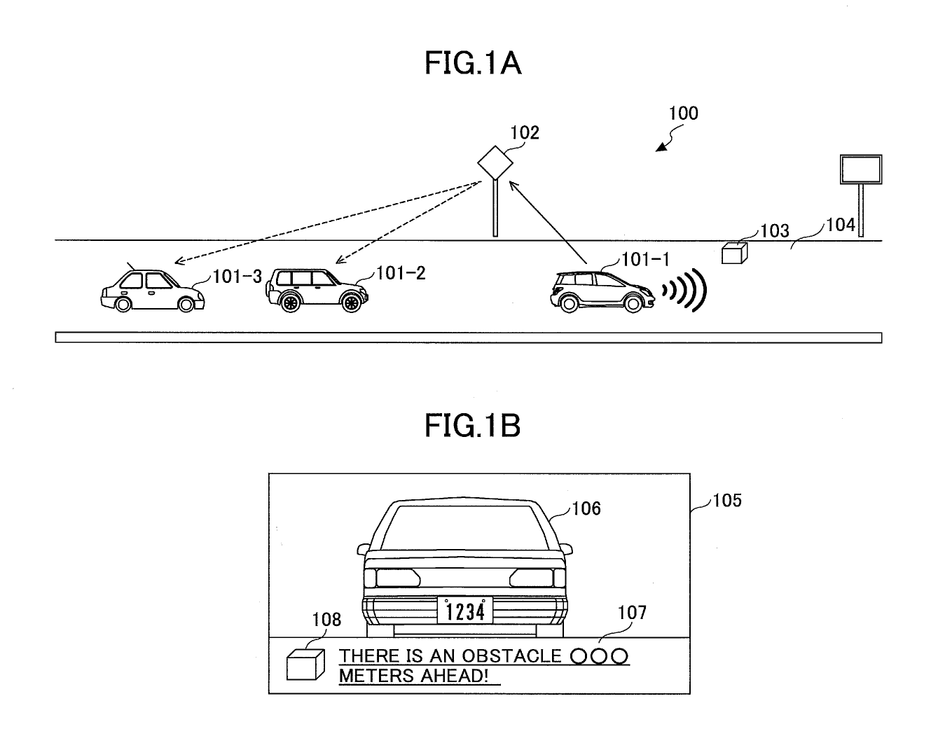

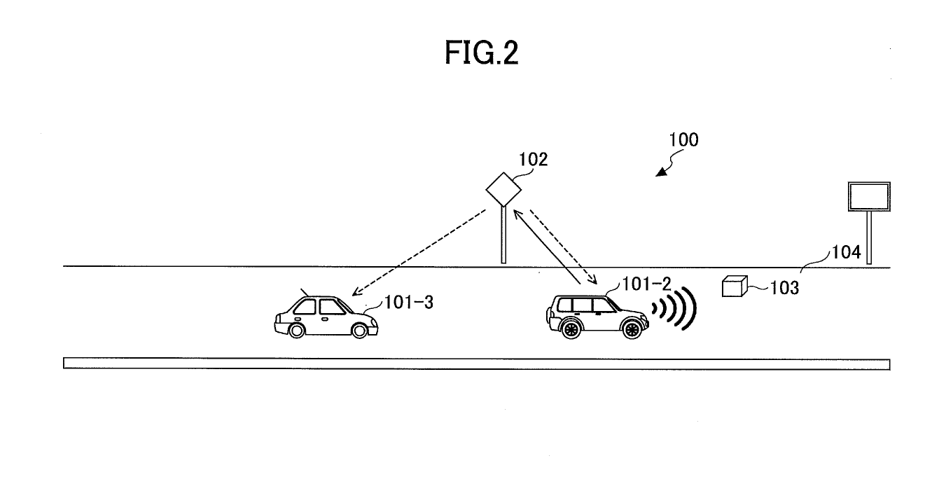

FIGS. 1A through 2 are for describing an overview of the information processing system 100 according to the present embodiment. In FIG. 1A, the information processing system 100 includes a plurality of information processing apparatuses 101-1 through 101-3 and a communication apparatus 102 capable of communicating with the plurality of information processing apparatuses 101-1 through 101-3. Note that in the following description, “information processing apparatus 101” is used for indicating any one of the plurality of information processing apparatuses 101-1 through 101-3.

The information processing apparatus 101 is, for example, an information device such as a car navigation device, a smartphone, a tablet terminal, a notebook PC (Personal Computer), etc., for providing information to the user (for example, the driver, the passenger, etc.) of a vehicle such as an automobile. Alternatively, the information processing apparatus 101 may be a vehicle such as an automobile in which the functions of the above information device are incorporated. Note that in FIG. 1A, as a matter of convenience, the information processing apparatus 101 is illustrated as a vehicle; however, the scope of the present invention is not so limited.

In FIG. 1A, it is assumed that the plurality of information processing apparatuses 101-1 through 101-3 are moving in a direction from the left to the right of a road 104 as viewed in the figure. Note that the number of the plurality of information processing apparatuses 101-1 through 101-3 is one example; the number of the information processing apparatuses may be other numbers.

The communication apparatus 102 is installed along the road 104, and is a communication device that can perform communication with the plurality of information processing apparatuses 101-1 through 101-3. The communication apparatus 102 can perform transmission and reception of data by wireless communication, etc., with a plurality of information processing apparatuses 101 within a predetermined range (for example, within several hundred meters). Note that in the example of FIG. 1A, it is assumed that the communication apparatus 102 is attached to a road sign set along the road 104. The road sign may be set at any position, as long as the position is in compliance with the road traffic law of the corresponding country. Note that an example in which the communication apparatus 102 is attached to a road sign is a preferred example; however, the scope of the present invention is not so limited. For example, the communication apparatus 102 may be attached to a guard rail or a sign board provided along the road 104, or the communication apparatus 102 may be installed alone along the road 104. Furthermore, the communication apparatus 102 is an example of an external device.

The information processing apparatus 101 according to the present embodiment can detect an obstacle around the vehicle, by using a camera, a sensor, etc., for monitoring the surroundings of the vehicle. Furthermore, the information processing apparatus 101 sends, to the communication apparatus 102, obstacle information including information relevant to the position of the detected obstacle (for example, the position information of the vehicle, the distance from the vehicle to the obstacle, etc.), to the communication apparatus 102, etc., by wireless communication, etc. Preferably, the obstacle information sent from the information processing apparatus 101 to the communication apparatus 102 includes the image of the detected obstacle.

For example, in FIG. 1A, the information processing apparatus 101-1 detects an obstacle 103 on the road 104, and sends first obstacle information including information relevant to the position of the detected obstacle 103, to the communication apparatus 102.

The communication apparatus 102 sends, for example, by simultaneous transmission (broadcast transmission), second obstacle information including information relevant to the position of the obstacle 103, to a plurality of information processing apparatuses 101-2 and 101-3 within a predetermined range, based on the obstacle information received from the information processing apparatus 101-1.

The information processing apparatus 101, which has received the second obstacle information from the communication apparatus 102, causes a display unit to display information relevant to the obstacle 103, based on the received second obstacle information.

FIG. 1B illustrates a display image of information relevant to the obstacle 103, in a vehicle in which a head-up display is attached. In the example of FIG. 1B, a vehicle 106 travelling ahead is seen through the windshield 105 of the vehicle. Furthermore, in the windshield 105, message information 107 indicating information of an obstacle 103 and image information 108 of the obstacle 103, are displayed by a head-up display. By the message information 107 of FIG. 1B, the user can recognize the distance, etc., to the obstacle 103, and by the image information 108, the user can recognize the appearance of the obstacle 103.

As described above, the information processing system 100 according to the present embodiment can quickly report information of an obstacle 103, etc., at any point on the road 104, to a user of a vehicle travelling near the obstacle.

Preferably, when the obstacle 103 is detected on the road 104, the communication apparatus 102 implements control such that the acquisition and the reporting of the obstacle information relevant to the obstacle 103, are performed at specified time intervals (for example, at one minute intervals).

FIG. 2 illustrates an example of a state after predetermined time has passed from the state of FIG. 1A. For example, the information processing apparatuses 101-2 and 101-3 detects an obstacle in response to an information update instruction, etc., sent from the communication apparatus 102 at every predetermined time point, and send obstacle information relevant to the detected obstacle 103, to the communication apparatus 102.

By implementing the above control, it is possible to reduce duplicate obstacle information, and to reduce an increase in the communication traffic, etc.

### <Hardware Configuration>

### (Hardware Configuration of Information Processing Apparatus)

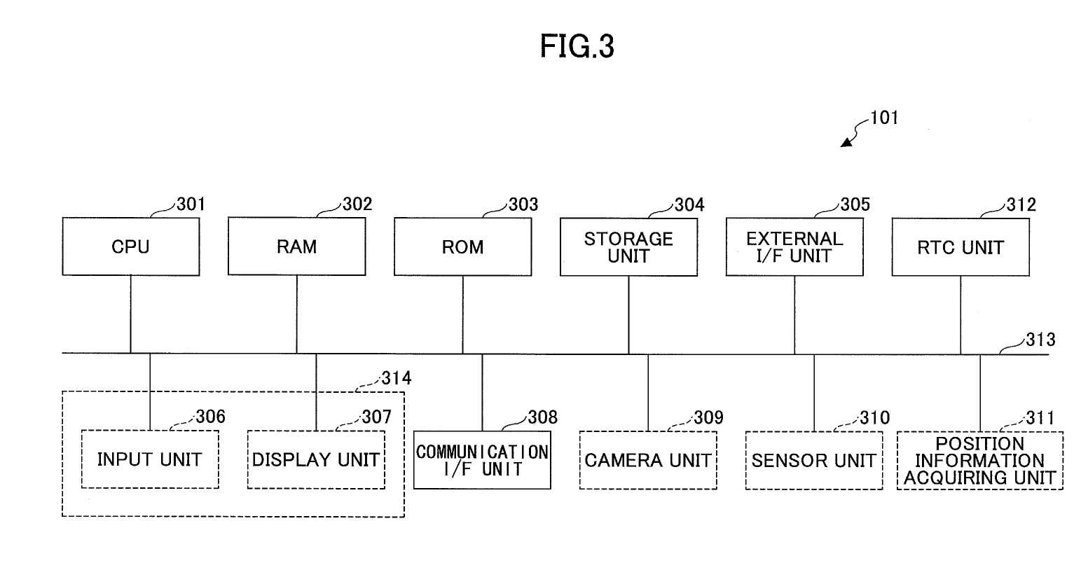

FIG. 3 illustrates a hardware configuration example of the information processing apparatus 101 according to an embodiment. The information processing apparatus 101 has a configuration of a general-purpose computer, and includes, for example, a CPU (Central Processing Unit) 301, a RAM (Random Access Memory) 302, a ROM (Read Only Memory) 303, a storage unit 304, an external I/F unit 305, an input unit 306, a display unit 307, a communication I/F (interface) unit 308, a camera unit 309, a sensor unit 310, a position information acquiring unit 311, a RTC (Real Time Clock) unit 312, a bus 313, etc.

The CPU 301 is an arithmetic device for implementing various functions of the information processing apparatus 101, by loading the programs and data stored in the ROM 303, the storage unit 304, etc., into the RAM 302, and executing processes. The RAM 302 is a volatile memory used as a work area, etc., of the CPU 301. The ROM 303 is a non-volatile memory that can hold programs and data even after the power is turned off. The storage unit 304 is a storage device such as a HDD (Hard Disk Drive), SSD (Solid State Drive), a flash ROM etc., and stores an OS, an application program, various kinds of data, etc.

The external I/F unit 305 is an interface for connecting, to the information processing apparatus 101, for example, a recording medium such as a USB (Universal Serial Bus) memory, etc., and an external device such as a car navigation device, a head-up display, a camera, a sensor, etc.

The input unit 306 is an input device for receiving operations of the user, such as a touch panel, a keyboard, a pointing device, a remote controller, etc. The display unit 307 is a display device such as a LCD (Liquid Crystal Display) panel, a head-up display, etc. The input unit 306 and the display unit 307 may be integrated in a single body, such as a display input unit 314 that is a touch panel display. Furthermore, at least one of the input unit 306 and the display unit 307 may be provided outside the information processing apparatus 101.

The communication I/F unit 308 is a wireless communication device for performing transmission and reception of data with the communication apparatus 102 by a predetermined wireless communication method. The predetermined wireless communication method used in the present embodiment may be any wireless communication method, as long as data communication can be performed in a bi-directional manner with the communication apparatus 102, at a communication distance of approximately several hundred meters or more. Furthermore, the communication I/F unit 308 may further include a communication function for connecting to a network such as the Internet, by a mobile communication network such as LTE (Long Term Evolution), etc., and wireless LAN (Local Area Network), etc.

The camera unit 309 includes, for example, one or more cameras for capturing an image of the surroundings of the vehicle, etc. The camera unit 309 may be, for example, an external camera, or a camera attached to the vehicle. The camera unit 309 may include a stereo camera, or a plurality of cameras attached at predetermined intervals, and may be used for measuring the distance between the vehicle and the obstacle.

The sensor unit 310 includes, for example, one or more distance sensors for measuring the distance from the vehicle to an obstacle, such as a laser range finder. The sensor unit 310 may be, for example, a sensor attached to the vehicle, an external sensor, etc. Furthermore, the information processing apparatus 101 may not necessarily include a distance sensor, if the information processing apparatus 101 includes a function for measuring the distance by the camera unit 309.

The position information acquiring unit 311 is a position information acquiring device such as GPS (Global Positioning System), etc., for acquiring the position information including the position and the movement direction of the information processing apparatus 101. Note that the information processing apparatus 101 may acquire the position information from a car navigation device, etc., installed in the vehicle.

The RTC unit 312 is a timekeeping device for timing the present date, time, etc. The bus 313 is connected to the above elements, and transmits address signals, data signals, various control signals, etc.

### (Hardware Configuration of Communication Apparatus)

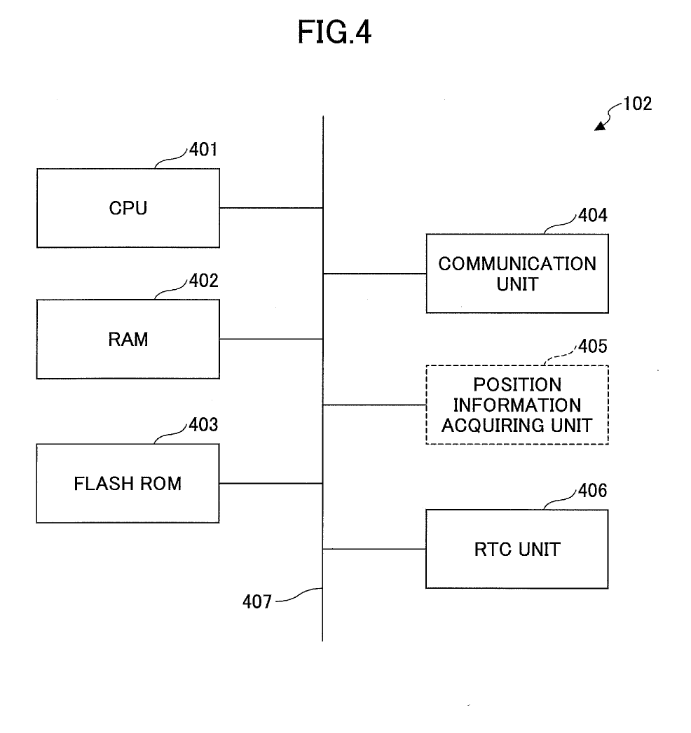

FIG. 4 illustrates a hardware configuration example of the communication apparatus 102 according to an embodiment. The communication apparatus 102 includes, for example, a CPU 401, a RAM 402, a flash ROM 403, a communication unit 404, a position information acquiring unit 405, an RTC unit 406, a bus 407, etc.

The CPU 401 is an arithmetic device for implementing various functions of the communication apparatus 102, by executing programs stored in the flash ROM 403, etc. The RAM 402 is a volatile memory used as the work area, etc., of the CPU 401. The flash ROM 403 is a non-volatile memory for storing various kinds of information such as programs, position information, etc., of the communication apparatus 102.

The communication unit 404 is a wireless communication device for performing transmission and reception of data with the plurality of information processing apparatuses 101, etc., by a predetermined wireless communication method. The communication unit 404 can perform data communication in a bi-directional manner with the plurality of information processing apparatuses 101, within a predetermined communication range (approximately several hundred meters). Preferably, the communication unit 404 has a function of performing communication with another communication apparatus 102, by performing the above wireless communication, or by other wired/wireless communication, etc. Furthermore, the communication unit 404 may have a function of connecting to a network such as the Internet, LAN, etc., for example, by a mobile communication network such as LTE (Long Term Evolution), etc., and wired/wireless LAN, etc.

The position information acquiring unit 405 is a position information acquiring device such as GPS, etc., for acquiring the position information of the communication apparatus 102. Note that when the communication apparatus 102 is fixed at a predetermined position, and the position information of the communication apparatus 102 is recorded in advance in the flash ROM 403, the communication apparatus 102 does not necessarily need to include the position information acquiring unit 405.

The RTC unit 406 is a timer device for timing the present date, time, etc. The bus 407 is connected to the above elements, and transmits address signals, data signals, various control signals, etc.

### First Embodiment

### Functional Configuration

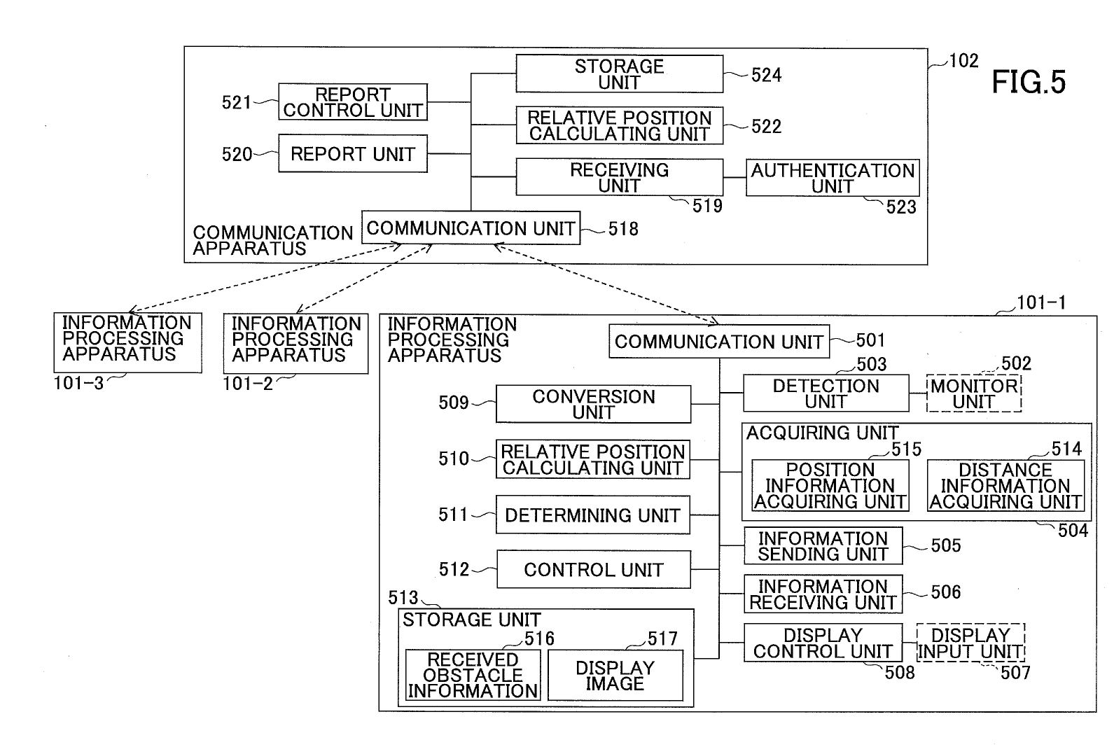

FIG. 5 illustrates a functional configuration of the information processing system 100 according to a first embodiment.

### (Functional Configuration of Information Processing Apparatus)

The information processing apparatus 101 includes, for example, a communication unit 501, a detection unit 503, an acquiring unit 504, an information sending unit 505, an information receiving unit 506, a display control unit 508, a conversion unit 509, a relative position calculating unit 510, a determining unit 511, a control unit 512, a storage unit 513, etc. Furthermore, the information processing apparatus 101 may further include a monitor unit 502, a display input unit 507, etc., or may use a monitor unit 502 and a display input unit 507 that are externally provided.

The communication unit 501 is a unit for transmitting and receiving obstacle information, various kinds of control information, etc., with the communication apparatus 102, and is realized by, for example, the communication I/F unit 308, etc., of FIG. 3.

The monitor unit 502 is a unit for monitoring the surroundings of the communication apparatus 102, and is realized by, for example, the camera unit 309, the sensor unit 310, etc., of FIG. 3. The monitor unit 502 is not necessarily included in the information processing apparatus 101; for example, a camera, a sensor, etc., attached to the vehicle may be used as the monitor unit 502.

The detection unit 503 is a unit for detecting an obstacle (first obstacle) around the vehicle by using the monitor unit 502, and is realized by, for example, a program operating in the CPU 301 of FIG. 3. For example, the detection unit 503 analyzes an image captured by the camera unit 309 included in the monitor unit 502, and detects an obstacle. An example of an obstacle is an object other than vehicles travelling on the road 104, such as a fallen object, an animal, a person, a stopped vehicle, a bicycle, etc.; however, in the present embodiment, the type of obstacle is not particularly limited.

The acquiring unit 504 is a unit for acquiring information relevant to the position of the obstacle detected by the detection unit 503, and is realized by, for example, a program operating in the CPU 301 of FIG. 3. Furthermore, the acquiring unit 504 includes a distance information acquiring unit 514, a position information acquiring unit 515, etc.

The distance information acquiring unit 514 is a unit for acquiring distance information indicating the distance between a vehicle and an obstacle detected by the detection unit 503. For example, the distance information acquiring unit 514 acquires the distance between a vehicle and an obstacle, by using the sensor unit 310 (distance sensor, etc.) included in the monitor unit 502. Alternatively, the distance information acquiring unit 514 may analyze a plurality of images captured by the camera unit 309, and acquire the distance information by using, for example, the principle of triangulation, etc.

The position information acquiring unit 515 is a unit for acquiring position information including the position and the movement direction, etc., of the vehicle. For example, the position information acquiring unit 515 may acquire the position information from a car navigation device, etc., of the vehicle, or may acquire the position information by a GPS device, etc., included in the position information acquiring unit 311, etc., of FIG. 3.

Note that in the above example, the information relevant to the position of the obstacle acquired by the acquiring unit 504, includes position information indicating the position, the movement direction, etc., of the vehicle, and the distance information indicating the distance between the vehicle and the obstacle.

The information sending unit 505 is a unit for sending obstacle information including information relevant to the position of the obstacle acquired by the acquiring unit 504, to an external device such as the communication apparatus 102, etc., and is realized by, for example, a program operating in the CPU 301 of FIG. 3. Preferably, the obstacle information sent by the information sending unit 505 includes an image of the obstacle captured by the monitor unit 502. Alternatively, the information sending unit 505 may send only the requested information, etc., in response to a request from an external device such as the communication apparatus 102, etc.

The information receiving unit 506 is a unit for receiving obstacle information including information relevant to the position of an obstacle (second obstacle), from an external device such as the communication apparatus 102, etc., and is realized by, for example, a program operating in the CPU 301 of FIG. 3. Preferably, the obstacle information received by the information receiving unit 506 includes an image of the obstacle.

The display input unit 507 is a unit for displaying, for example, information relevant to the obstacle 103 described with reference to FIG. 1B, and for receiving input operations of the user, and is realized by, for example, the input unit 306, the display unit 307, the display input unit 314, etc., of FIG. 3. Furthermore, the display input unit 507 is not necessarily included in the information processing apparatus 101; for example, a head-up display, a display of a car navigation device attached to the vehicle may be used as the display input unit 507. Furthermore, the display input unit 507 may be divided into a display unit for displaying information and an input unit for receiving input operations.

The display control unit 508 displays information relevant to the obstacle (second obstacle) on the display input unit 507, based on obstacle information (second obstacle information) received by the information receiving unit 506. Furthermore, the display control unit 508 also performs a process of causing the display input unit 507 to display a setting screen, etc., such that a selection can be made, and receiving a selection operation of the user. The display control unit 508 is realized by, for example, a program operating in the CPU 301 of FIG. 3.

The conversion unit 509 is a unit for converting an image of an obstacle included in the obstacle information received by the information receiving unit 506, into an image corresponding to the viewpoint of the user of the information processing apparatus 101 (driver of a vehicle, etc.), and is realized by, for example, a program operating in the CPU 301 of FIG. 3. For example, the conversion unit 509 generates an image corresponding to the viewpoint of the user of the information processing apparatus 101 by reducing and rotating an image of an obstacle included in the obstacle information received by the information receiving unit 506, and stores the generated image as a display image 517 in the storage unit 513, for example.

The relative position calculating unit 510 is a unit for calculating the distance and the required time between the present position of the vehicle and the obstacle (second obstacle), and is realized by, for example, a program operating in the CPU 301 of FIG. 3.

The determining unit 511 is a unit for determining whether the information received from the information receiving unit 506 is data received from a predetermined external device such as the communication apparatus 102, etc., and is realized by, for example, a program operating in the CPU 301 of FIG. 3. The information, which is determined by the determining unit 511 to be information received from a predetermined external device, is stored as received obstacle information 516 in the storage unit 513, for example.

The control unit 512 is a unit for controlling the entire information processing apparatus 101 including the detection unit 503, the acquiring unit 504, the information sending unit 505, the information receiving unit 506, the storage unit 513, etc., and is realized by, for example, a program operating in the CPU 301 of FIG. 3.

The storage unit 513 is a unit for storing various kinds of information such as the received obstacle information 516, the display image 517, etc., and is realized by, for example, the storage unit 304, the RAM 302, etc., of FIG. 3.

Note that in FIG. 5, it is assumed that the information processing apparatuses 101-2 and 101-3 have the same functional configurations as those of the information processing apparatus 101-1.

### (Functional Configuration of Communication Apparatus)

The communication apparatus 102 includes a communication unit 518, a receiving unit 519, a report unit 520, a report control unit 521, a relative position calculating unit 522, an authentication unit 523, a storage unit 524, etc.

The communication unit 518 is a unit for performing transmission and reception of obstacle information, various kinds of control information, etc., with the plurality of information processing apparatuses 101-1 through 101-3, and is realized by, for example, the communication unit 404, etc., of FIG. 4.

The receiving unit 519 is a unit for receiving obstacle information including information relevant to the position of the obstacle, from the information processing apparatus 101 within a predetermined range (for example, within a communication range of the communication apparatus 102). The receiving unit 519 is realized by, for example, a program operating in the CPU 401 of FIG. 4.

The report unit 520 is a unit for reporting (for example, broadcast transmission) information based on the obstacle information received by the receiving unit 519, to the information processing apparatus 101 within a predetermined range, according to control by the report control unit 521. The report unit 520 is realized by, for example, a program operating in the CPU 401 of FIG. 4. Note that the information reported by the report unit 520 may be information generated based on the obstacle information received by the receiving unit 519, or the obstacle information received by the receiving unit 519.

The report control unit 521 is a unit for controlling the report contents, the reporting frequency, or the necessity of reporting, etc., with respect to the information reported by the report unit 520, based on the obstacle information received by the receiving unit 519, and is realized by, for example, a program operating in the CPU 401 of FIG. 4. For example, the report control unit 521 compares the information of an obstacle received by the receiving unit 519 with the information of an obstacle received previously by the receiving unit 519, and determines how much the data has changed. Furthermore, the report control unit 521 controls the reporting frequency, the necessity of reporting, the reporting contents, etc., by the report unit 520, according to the change amount of data.

The relative position calculating unit 522 calculates the relative position of the obstacle with respect to the communication apparatus 102, based on the obstacle information received by the receiving unit 519.

The authentication unit 523 is a unit for authenticating the data received by the receiving unit 519, and securing the security of the received data, and is realized by, for example, a program operating in the CPU 401 of FIG. 4.

The storage unit 524 is a unit for storing various kinds of information including, for example, position information indicating the position, the direction, etc., of the communication apparatus 102, and is realized by, for example, the flash ROM 403, etc., of FIG. 4. Note that in the example of FIG. 5, it is assumed that the position information of the communication apparatus 102 is recorded in the storage unit 524 in advance. Note that when the communication apparatus 102 is a portable device, etc., the communication apparatus 102 preferably includes a position information acquiring unit for acquiring the position information of the communication apparatus 102.

### <Process Flow>

### (Flow of Process by Information Processing Apparatus)

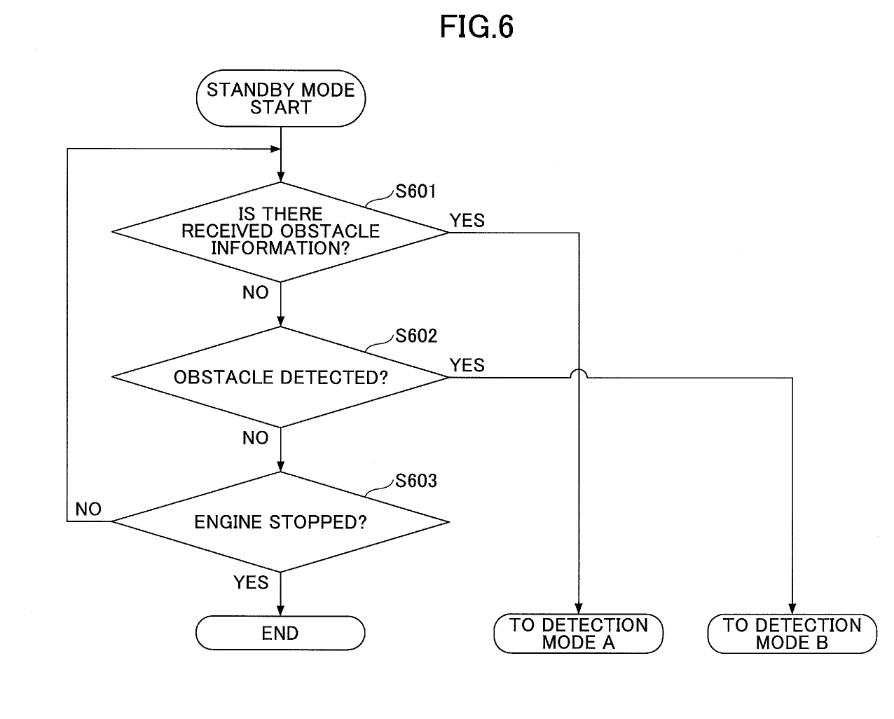

FIGS. 6 through 8 are flowcharts indicating processes performed by the information processing apparatus 101 according to the first embodiment.

In FIG. 6, for example, the information processing apparatus 101 starts a process of a standby mode, according to the startup of the engine of a vehicle, in which the information processing apparatus 101 is installed.

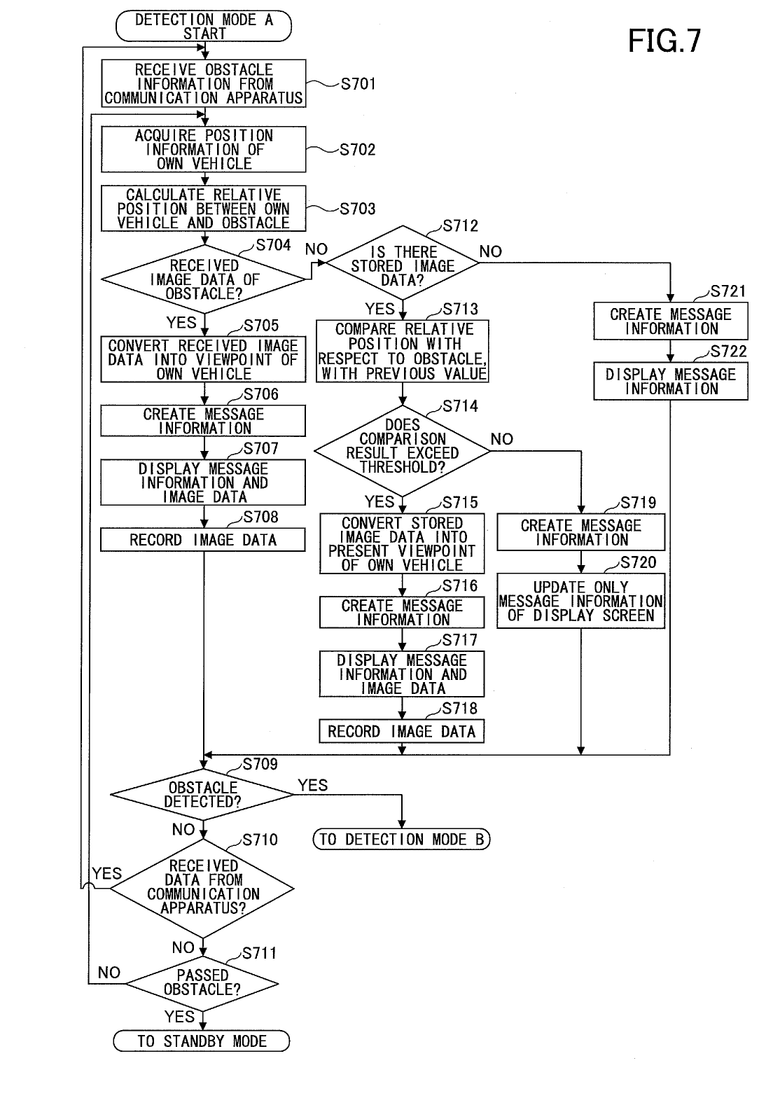

In step S601, the information processing apparatus 101 determines whether there is obstacle information received from a predetermined external device such as the communication apparatus 102, etc. When there is no received obstacle information, the information processing apparatus 101 shifts the process to step S602. On the other hand, when there is received obstacle information, the information processing apparatus 101 shifts the process to “detection mode A”. Note that the detection mode A is described below with reference to FIG. 7.

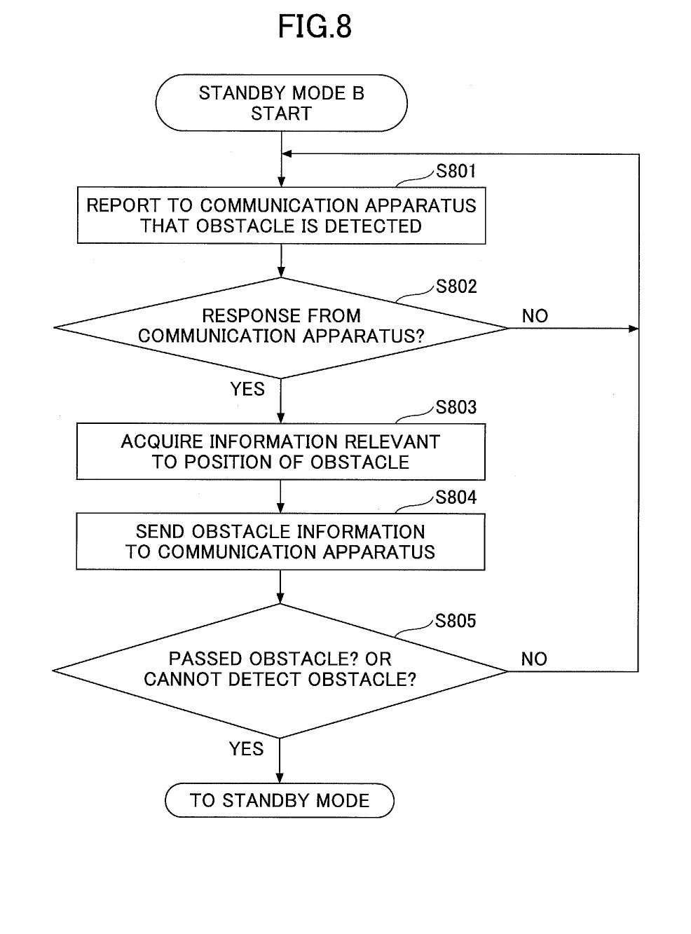

When the process shifts to step S602, the information processing apparatus 101 determines whether the detection unit 503 has detected an obstacle. When an obstacle is not detected, the information processing apparatus 101 shifts the process to step S603. On the other hand, when an obstacle is detected, the information processing apparatus 101 shifts the process to “detection mode B”. Note that the detection mode B is described below with reference to FIG. 8.

When the process shifts to step S603, the information processing apparatus 101 determines whether the engine of the vehicle, in which the information processing apparatus 101 is installed, has stopped. When the engine of the vehicle has not stopped, the information processing apparatus 101 returns to step S601, and repeats the same process. On the other hand, when the engine of the vehicle has stopped, the information processing apparatus 101 ends the process.

Next, with reference to FIG. 7, a description is given of a process of detection mode A. Note that detection mode A is an example of a process of a case where the information processing apparatus 101 has received a report of obstacle information from an external device such as the communication apparatus 102.

In step S701, the information receiving unit 506 of the information processing apparatus 101 receives obstacle information from the communication apparatus 102, and stores the obstacle information as, for example, the received obstacle information 516, in the storage unit 513.

In step S702, the position information acquiring unit 515 of the information processing apparatus 101 acquires the position information of the vehicle corresponding to the information processing apparatus 101 (hereinafter, “own vehicle”).

In step S703, the relative position calculating unit 510 calculates the relative position of the own vehicle with respect to the obstacle, by the position information of the own vehicle acquired by the position information acquiring unit 515 and the received obstacle information 516 stored in the storage unit 513. The relative position of the own vehicle with respect to the obstacle calculated by the relative position calculating unit 510 may be information such as the distance between the own vehicle and the obstacle or the time required to reach the obstacle (predicted value).

In step S704, when the received obstacle information 516 includes image data of the obstacle, the information processing apparatus 101 shifts the process to step S705. On the other hand, when the received obstacle information 516 does not include image data of the obstacle, the information processing apparatus 101 shifts the process to step S712.

When the process shifts to step S705, the conversion unit 509 of the information processing apparatus 101 creates a display image by converting the image data of the obstacle included in the received obstacle information 516, to the viewpoint of the own vehicle. For example, when the distance to the obstacle is long, the conversion unit 509 reduces the image data of the obstacle, and when the distance to the obstacle is short, the conversion unit 509 decreases the reduction ratio (or does not reduce) of the image data of the obstacle. Preferably, for example, when the angle of the view from the own vehicle to the obstacle is different from that of the image data of the obstacle, such as when the road 104 is curved, the conversion unit 509 converts the image data of the obstacle to the viewpoint of the own vehicle, by performing a rotation process on the image of the obstacle, etc.

In step S706, the display control unit 508 of the information processing apparatus 101 creates message information to be displayed on the display input unit 507, by using the relative position information calculated in step S703, etc. The message information created at this time preferably includes, for example, the distance from the own vehicle to the obstacle, and the required time to reach the obstacle.

In step S707, the display control unit 508 causes the display input unit 507 to display the display image created in step S705 and the message information created in step S706.

In step S708, the information processing apparatus 101 stores the display image displayed in step S707, as the display image 517 in the storage unit 513.

When the process shifts to step S709, the information processing apparatus 101 determines whether the detection unit 503 has detected an obstacle. When an obstacle is not detected, the information processing apparatus 101 shifts the process to step S710. On the other hand, when an obstacle is detected, the information processing apparatus 101 shifts the process to “detection mode B”. Note that the process of detection mode B is described below with reference to FIG. 8.

When the process shifts to step S710, the information processing apparatus 101 determines whether data (obstacle information, etc.) has been received from the communication apparatus 102, etc. When the data has been received, the information processing apparatus 101 returns to step S701, and repeats the same process. On the other hand, when the data has not been received, the information processing apparatus 101 shifts the process to step S711.

When the process shifts to step S711, the information processing apparatus 101 determines whether the own vehicle has passed the obstacle, based on, for example, the present position of the own vehicle, the time required to reach the obstacle, etc. When the information processing apparatus 101 determines that the own vehicle has passed the obstacle, the information processing apparatus 101 shifts the process to the standby mode (FIG. 6). On the other hand, when the information processing apparatus 101 determines that the own vehicle has not passed the obstacle, the information processing apparatus 101 returns to step S702 and repeats the same process.

As described above, a description is given of a process where the received obstacle information 516 includes image data of the obstacle in step S704; next, a description is given of a process where the received obstacle information 516 does not include image data of the obstacle.

In step S704, when the received obstacle information 516 does not include image data of the obstacle, the process shifts to step S712, and the information processing apparatus 101 determines whether the storage unit 513 includes the display image 517 stored in step S708.

In step S712, when the storage unit 513 does not include the stored display image 517, the display control unit 508 of the information processing apparatus 101 creates message information (step S721), and causes the display input unit 507 to display the created message information (step S722). On the other hand, when the storage unit 513 includes the stored display image 517, the information processing apparatus 101 executes the processes of step S713 and onward.

In step S713, the information processing apparatus 101 compares the relative position of the own vehicle with respect to the obstacle, with the previous value (step S713).

In step S714, the information processing apparatus 101 determines whether the comparison result of the relative position of the own vehicle with respect to the obstacle exceeds a predetermined threshold. When the comparison result does not exceed the threshold, the display control unit 508 of the information processing apparatus 101 creates message information (step S719), and updates only the created message information without updating the image (step S720). On the other hand, when the comparison result exceeds the threshold, the information processing apparatus 101 executes the processes of step S715 and onward.

In step S715, the conversion unit 509 of the information processing apparatus 101 creates a display image, by converting the image data of the obstacle stored in the storage unit 513, to the viewpoint of the own vehicle (step S715).

In step S716, the display control unit 508 of the information processing apparatus 101 creates message information to be displayed by the display input unit 507.

In step S717, the display control unit 508 causes the display input unit 507 to display the display image created in step S715 and the message information created in step S716.

In step S718, the information processing apparatus 101 stores the display image displayed in step S717, as the display image 517 in the storage unit 513, and shifts the process to step S709.

Next, with reference to FIG. 8, a description is given of the process of detection mode B. Note that detection mode B is an example of a process when the information processing apparatus 101 has detected an obstacle.

In step S801, the information sending unit 505 of the information processing apparatus 101 reports to the communication apparatus 102 that the detection unit 503 has detected an obstacle.

In step S802, the information processing apparatus 101 determines whether there is a response from the communication apparatus 102. When there is no response from the communication apparatus 102, the information processing apparatus 101 returns to step S801 and repeats the same process. On the other hand, when there is a response from the communication apparatus 102, the information processing apparatus 101 shifts the process to step S803.

In step S803, the acquiring unit 504 of the information processing apparatus 101 acquires information relevant to the position of the obstacle detected by the detection unit 503. For example, the acquiring unit 504 acquires, by the position information acquiring unit 515, the position information indicating the position and the movement direction of the own vehicle, etc., and also acquires, by the distance information acquiring unit 514, distance information indicating the distance between the own vehicle and the obstacle.

In step S804, the information sending unit 505 of the information processing apparatus 101 sends, to the communication apparatus 102, the obstacle information including information relevant to the position of the obstacle acquired by the acquiring unit 504.

In step S805, for example, the information processing apparatus 101 determines whether the detection unit 503 cannot detect any obstacles any more. Alternatively, for example, the information processing apparatus 101 may determine whether the own vehicle has passed the obstacle, based on the distance information, etc., between the own vehicle and the obstacle calculated by the relative position calculating unit 510. When the own vehicle has passed the obstacle, or when the obstacle cannot be detected anymore, the information processing apparatus 101 shifts the process to the standby mode (FIG. 6). On the other hand, when the own vehicle has not passed the obstacle, or when the obstacle can be detected, the information processing apparatus 101 returns to step S801 and repeats the same process.

As described above, the information processing apparatus 101 detects the obstacle 103 (first obstacle) around the vehicle by using the monitor unit 502 for monitoring the surroundings of the vehicle. Furthermore, the information processing apparatus 101 acquires the information relevant to the position of the detected obstacle 103, and sends, to the communication apparatus 102 (first external device), the obstacle information (first obstacle information) including the acquired information relevant to the position of the obstacle 103.

Furthermore, when the information processing apparatus 101 receives obstacle information (second obstacle information) including the information relevant to the position of the obstacle (second obstacle) from the communication apparatus 102 (second external device), the information processing apparatus 101 causes the display input unit 507 to display the information relevant to the obstacle, based on the received obstacle information.

Note that the processes of FIGS. 6 through 8 are merely examples. For example, in step S801 of FIG. 8, the information processing apparatus 101 may also report, to the communication apparatus 102, obstacle information together with the information for reporting that an obstacle is detected. Furthermore, in step S803 of FIG. 8, the information processing apparatus 101 may acquire an image of the obstacle, and the obstacle information sent in step S804 may include the image data of the obstacle. Furthermore, in step S603 of FIG. 6, the information processing apparatus 101 may determine whether the process has ended by an operation of an application program, etc., operating in the information processing apparatus 101, without detecting the stop of the engine.

### (Flow of Process by Communication Apparatus)

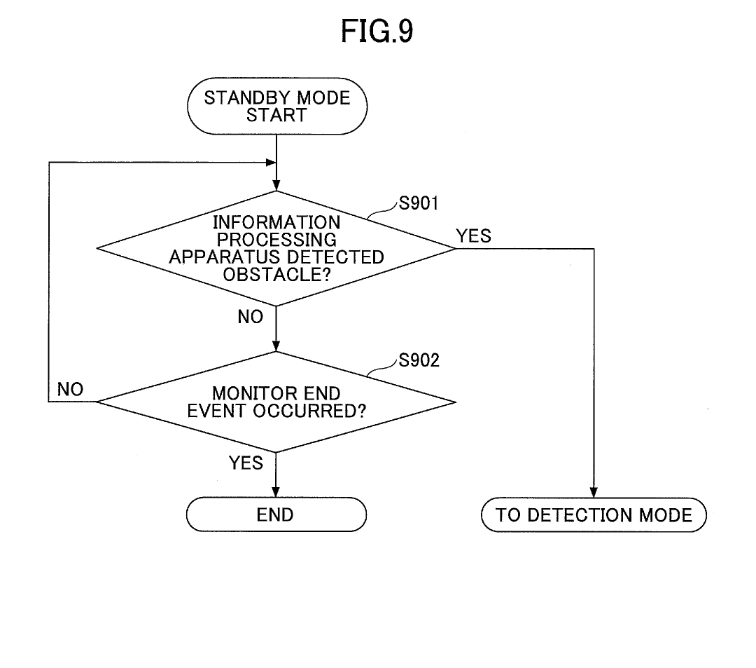

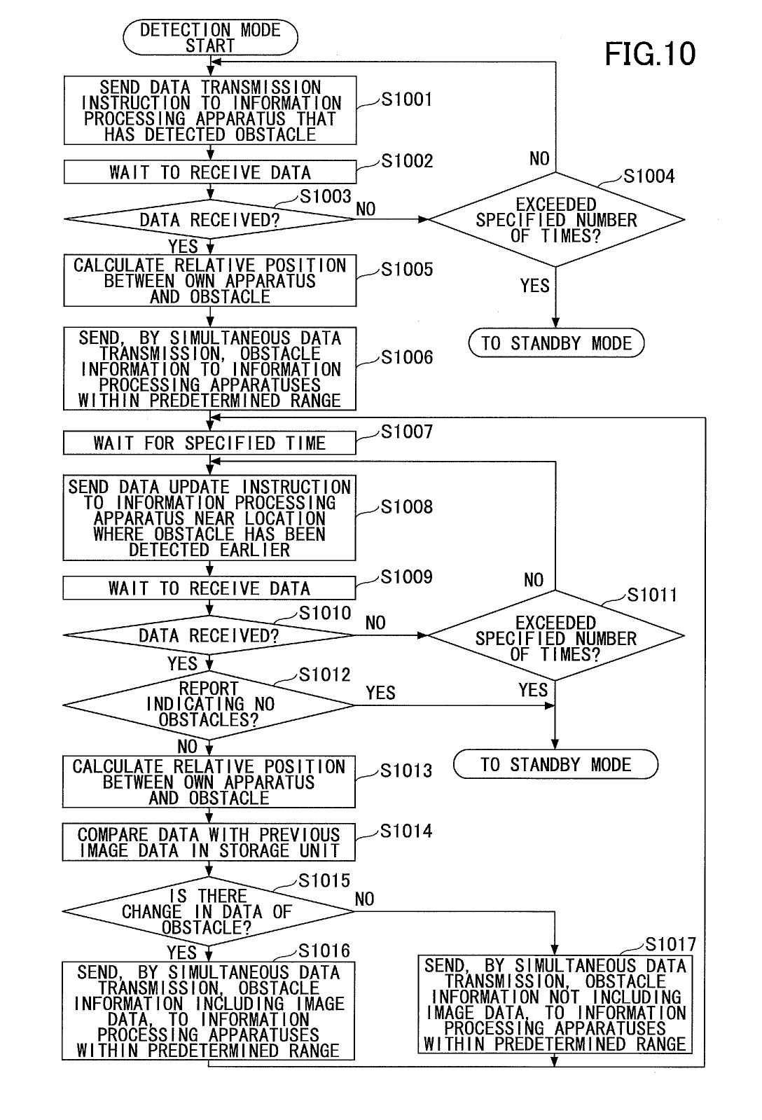

FIGS. 9 and 10 are flowcharts indicating processes performed by the communication apparatus 102 according to the first embodiment.

In FIG. 9, when the communication apparatus 102 starts the process of the standby mode, in step S901, the communication apparatus 102 determines whether the information processing apparatus 101 has detected an obstacle. For example, the communication apparatus 102 determines whether the information processing apparatus 101 has detected an obstacle, based on whether a report indicating the detection of an obstacle is received from the information processing apparatus 101. When the communication apparatus 102 determines that the information processing apparatus 101 has detected an obstacle, the communication apparatus 102 shifts the process to detection mode. Note that the detection mode is described below with reference to FIG. 10. When the communication apparatus 102 determines that the information processing apparatus 101 has not detected an obstacle, the communication apparatus 102 shifts the process to step S902.

When the process is shifts to step S902, the communication apparatus 102 determines whether a predetermined monitor end event has occurred. An example of monitor end event is an operation of ending the monitoring by the administrator, the expiration of a monitor period defined in advance, etc. In step S902, when a monitor end event has not occurred, the communication apparatus 102 returns to step S901 and repeats the same process. On the other hand, in step S902, when a monitor end event has occurred, the communication apparatus 102 ends the process of the standby mode.

FIG. 10 is a flowchart indicating an example of a process of the detection mode performed by the communication apparatus 102. When the communication apparatus 102 shifts to the detection mode, in step S1001, the communication apparatus 102 sends a data transmission instruction to request the transmission of the obstacle information, to the information processing apparatus 101 that has detected an obstacle.

In step S1002, the communication apparatus 102 waits for data reception for a predetermined period.

In step S1003, when data cannot be received from the information processing apparatus 101 to which the data transmission instruction has been sent, the communication apparatus 102 repeats to send the data transmission instruction until a specified number of times is exceeded (step S1004). Furthermore, when the number of times of sending the data transmission instruction exceeds the specified number in step S1004, the communication apparatus 102 shifts the process to the standby mode (FIG. 9). On the other hand, when the data is received from the information processing apparatus 101 to which the data transmission instruction has been sent, the communication apparatus 102 executes the processes of step S1005 and onward.

When the process shifts to step S1005, the relative position calculating unit 522 of the communication apparatus 102 calculates the relative position between the own apparatus and the obstacle (for example, the distance between the own apparatus and the obstacle, etc.), based on the received obstacle information.

In step S1006, the communication apparatus 102 sends, by simultaneous data transmission (broadcast transmission), the obstacle information (second obstacle information) including the calculated relative position, to the information processing apparatuses 101 within a predetermined range (for example, in the communication range of the communication apparatus 102).

After waiting for a specified time in step S1007, in step S1008, the communication apparatus 102 sends a data update instruction to the information processing apparatus 101 near the location where the obstacle has been detected earlier. For example, the communication apparatus 102 may include a plurality of antennas disposed along the road 104, and send the data update instruction by using an antenna that has received the obstacle information earlier. Note that the operation of sending a data update instruction to the information processing apparatus 101 near the location where the obstacle has been detected, is one example; the data update instruction may be sent to information processing apparatuses 101 within a predetermined range by broadcast communication.

In step S1009, the communication apparatus 102 waits for data reception for a predetermined period, and in step S1010, when data cannot be received, the communication apparatus 102 repeats to send the data update instruction until a specified number of times is exceeded (step S1011). Furthermore, in step S1011, when the number of times of sending the data update instruction exceeds the specified number, the communication apparatus 102 shifts the process to the standby mode (FIG. 9). On the other hand, when the data is received in step S1010, the communication apparatus 102 executes the processes of step S1012 and onward.

When the process shifts to step S1012, the communication apparatus 102 determines whether there is a report indicating that there are no obstacles. A report indicating that there are no obstacles may be, for example, sent from the information processing apparatus 101 or from another communication apparatus 102. Alternatively, the report indicating that there are no obstacles may be sent from an administrator, a management server, etc. When there is a report indicating that there are no obstacles, the communication apparatus 102 shifts the process to the standby mode (FIG. 9). On the other hand, when there is no report indicating that there are no obstacles, the communication apparatus 102 shifts the process to step 1013.

When the process shifts to step S1013, the relative position calculating unit 522 of the communication apparatus 102 calculates the relative position of the own apparatus (communication apparatus 102) and the obstacle.

In step S1014, the communication apparatus 102 compares the image data of the obstacle with the previous data of the obstacle stored in the storage unit (storage unit 524), and determines whether there is a change in the data of the obstacle.

In step S1015, when there is a change in the data of the obstacle, the communication apparatus 102 shifts process to step S1016, simultaneously sends the obstacle information including the image data to the information processing apparatuses 101 in a predetermined range, and returns to step S1007. On the other hand, when there is no change in the data of the obstacle in step S1015, the communication apparatus 102 shifts the process to step S1017, simultaneously sends the obstacle information that does not include the image data to the information processing apparatuses 101 in a predetermined range, and returns to step S1007.

For example, as described above, when the communication apparatus 102 receives a report indicating that an obstacle has been detected from the information processing apparatus 101, the communication apparatus 102 shifts to a detection mode of sending the data update instruction to the information processing apparatus 101 at specified time intervals. Furthermore, for example, when there are no more obstacles, the communication apparatus 102 returns to the standby mode.

Note that the processes indicated in FIGS. 9 and 10 are preferable examples, and do not limit the scope of the present invention. For example, the communication apparatus 102 may report the obstacle information at specified time intervals to the information processing apparatus 101, and the information processing apparatus 101 may detect an obstacle in response to the received report. Alternatively, the information processing apparatus 101 may send the obstacle information as needed to the communication apparatus 102 at the time point of detecting an obstacle, and the communication apparatus 102 may selectively report the required information included in the received obstacle information, to information processing apparatuses 101 within a predetermined range.

As described above, according to the information processing system 100 according to the present embodiment, the obstacle information including information relevant to the position of the obstacle detected by one information processing apparatus 101, is reported to one or more information processing apparatuses 101 in the surrounding area via the communication apparatus 102. Therefore, the information of an obstacle, etc., at any point on the road can be easily and quickly reported to a user of a vehicle travelling near the obstacle.

### Second Embodiment

In a second embodiment, a description is given of an example in which the information processing system 100 includes a configuration for setting the report contents, the reporting frequency, the necessity of reporting, etc., of the obstacle information, in addition to the configurations of the first embodiment.

The setting of the report contents, the reporting frequency, the necessity of reporting, etc., of the obstacle information may be performed on the communication apparatus 102 side, or may be performed on the information processing apparatus 101 side. Furthermore, the setting of the report contents, the reporting frequency, the necessity of reporting, etc., of the obstacle information may be performed by both the communication apparatus 102 and the information processing apparatus 101.

### <Functional Configuration>

### (Functional Configuration of Information Processing Apparatus)

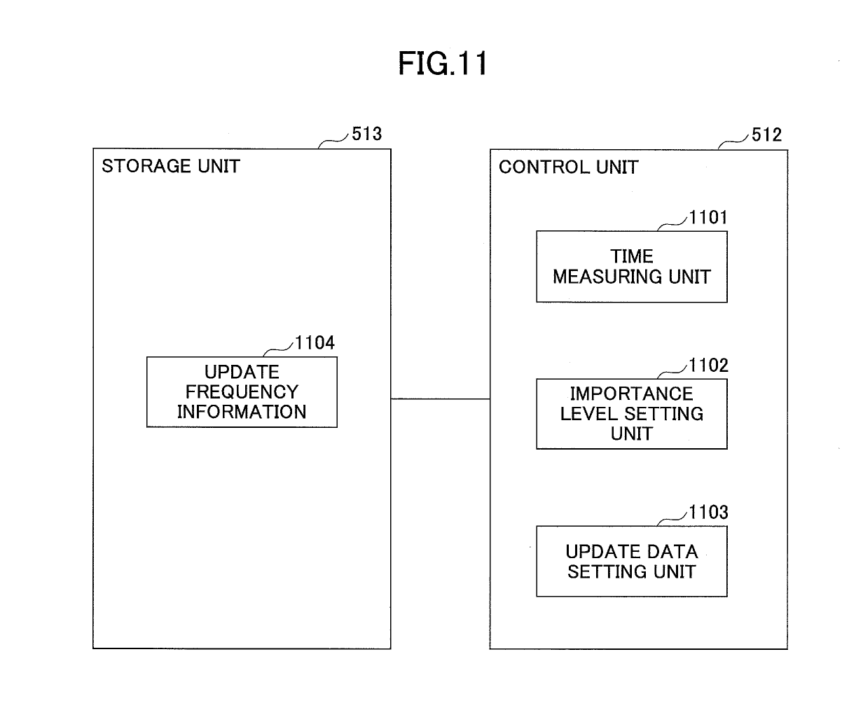

FIG. 11 illustrates a configuration example of the control unit 512 of the information processing apparatus 101 according to the second embodiment. In FIG. 11, the control unit 512 of the information processing apparatus 101 includes, for example, a time measuring unit 1101, an importance level setting unit 1102, an update data setting unit 1103, etc. Note that the other functional configurations of the information processing apparatus 101 are the same as the functional configurations of the first embodiment illustrated in FIG. 5, and therefore the differences are mainly described herein.

The time measuring unit 1101 measures the time intervals, etc., of sending the obstacle information, for example, by using the RTC unit 312, etc., of FIG. 3. Preferably, the time measuring unit 1101 includes a function of setting the time intervals, etc., of sending the obstacle information.

The importance level setting unit 1102 is a unit for, for example, setting the importance level of data, by the user, etc., of the information processing apparatus 101, before the vehicle starts to travel, etc. Note that the importance level of data is, for example, information indicating the importance level of the information relevant to the obstacle 103 (obstacle information), such as the weather (“fine”, “cloudy”, “rainy”, “foggy”, etc.), whether the obstacle has moved, the skill of the driver of the vehicle, etc.

For example, when the weather is “fine”, the range that the user (driving the vehicle) can visibly see the obstacle 103 and the surroundings of the vehicle, becomes wide, and even when unexpected information arises, such as the vehicle in front puts on the brake, the user can sufficiently respond to this. Therefore, when the weather is “fine”, the importance level of the obstacle information becomes relatively low. On the other hand, when the weather is “foggy”, the range that the user can visibly see becomes narrow, and the danger level of the obstacle 103 increases, and therefore the importance level of the obstacle information increases.

Furthermore, when the obstacle is moving, the danger level increases compared to the case where the obstacle is still, and therefore the importance level of the obstacle information increases.

The information processing apparatus 101 stores update frequency information 1104 corresponding to the importance level of the data in the storage unit 513 in advance. The update frequency information 1104 defines whether the information relevant to the obstacle 103 is to be updated, and the intervals of the updating, etc. Furthermore, the importance level setting unit 1102 causes the display input unit 314, etc., of the information processing apparatus 101 to display a setting screen of the importance level of data, and the importance level of data is set by an operation of the user. Alternatively, importance level setting unit 1102 may automatically set the importance level of the data, according to the weather information and the information indicating whether the obstacle has moved, received from the communication apparatus 102.

The update data setting unit 1103 is a unit for setting the type of information to be included in the obstacle information to be sent to the communication apparatus 102, such as whether the relative position information of an obstacle information is to be included, whether the image data is to be included, whether the sensor value of the monitor unit 502 is to be included, etc.

By the above configuration, for example, when the weather is “rainy”, the information processing apparatus 101 is able to control the transmission frequency of the obstacle information to be sent to the communication apparatus 102, to be a higher frequency than usual. Note that the configuration of the information processing apparatus 101 of changing the transmission frequency of the obstacle information according to the importance level of data is one example; the information processing apparatus 101 may change whether an image is to be included in the obstacle information and may change the type of data, etc., according to the importance level of the data.

### (Functional Configuration of Communication Apparatus)

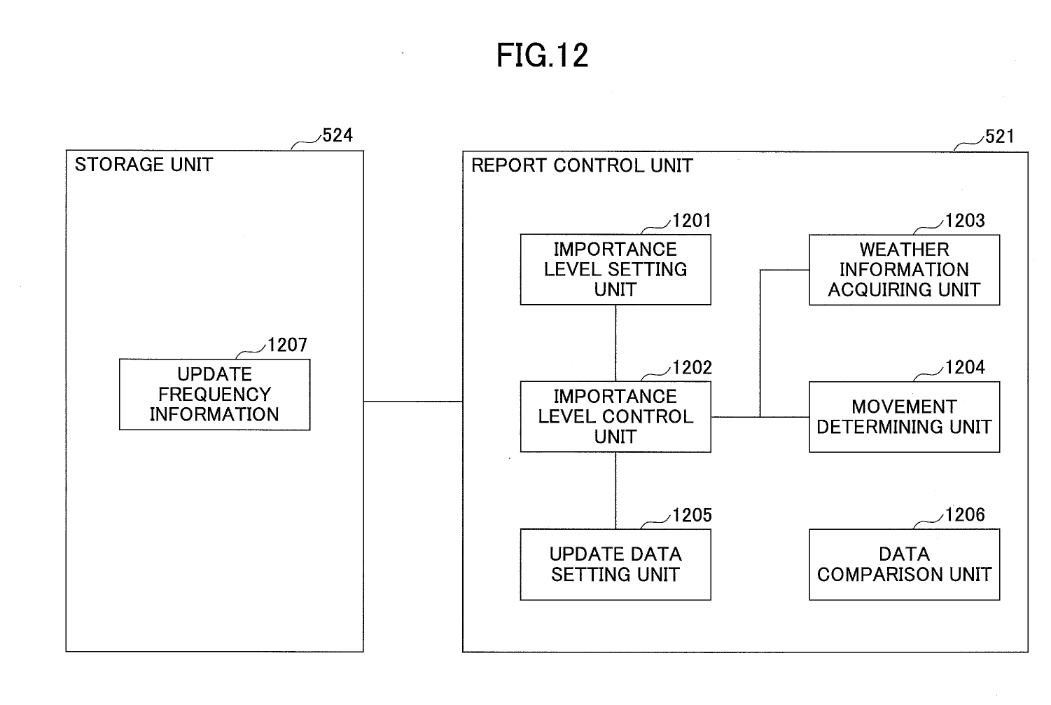

FIG. 12 illustrates a configuration example of the report control unit 521 of the communication apparatus 102 according to the second embodiment. in FIG. 12, the report control unit 521 of the communication apparatus 102 includes, for example, an importance level setting unit 1201, an importance level control unit 1202, a weather information acquiring unit 1203, a movement determining unit 1204, an update data setting unit 1205, etc. Furthermore, the report control unit 521 includes a data comparison unit 1206 that compares the information of an obstacle received by the receiving unit 519 with the information of an obstacle received previously by the receiving unit 519, and determines how much the data has changed. Note that the other functional configurations of the communication apparatus 102 are the same as the functional configurations of the first embodiment illustrated in FIG. 5, and therefore the differences are mainly described herein.

The importance level setting unit 1201 is a unit for setting the importance level of data at the communication apparatus 102. Similar to the information processing apparatus 101, the communication apparatus 102 stores update frequency information 1207 corresponding to the importance level of the data, in the storage unit 524 in advance. The update frequency information 1207 indicates whether the information relevant to the obstacle 103 is to be updated, and defines the intervals of the updating, etc. Furthermore, the importance level setting unit 1102 sets the importance level of data according to operations by the administrator, etc., and control by the importance level control unit 1202, etc.

Note that the importance level of data and the update frequency information 1207 are the same as those of the information processing apparatus 101 described with reference to FIG. 11.

For example, the importance level control unit 1202 automatically controls the setting of the importance level of data by the importance level control unit 1202, for example, according to weather information and whether the obstacle has moved. For example, when the weather is bad, the importance level control unit 1202 automatically increases the importance level of data such as the obstacle information, and implements control to increase the update frequency of data such as the obstacle information. Alternatively, for example, when the obstacle is not moving, the importance level control unit 1202 automatically decreases the importance level of data such as the obstacle information, and implements control to decrease the update frequency of data such as the obstacle information.

The weather information acquiring unit 1203 acquires the weather information form, for example, an external server, etc.

The movement determining unit 1204 determines whether the obstacle is moving based on, for example, information relevant to the position of the obstacle included in the obstacle information received form a plurality of information processing apparatuses 101.

The update data setting unit 1205 is a unit for setting the type of information to be included in the obstacle information that the information processing apparatus 101 is requested to send, such as whether the relative position information of an obstacle is to be included, whether the image data is to be included, whether the sensor value of the monitor unit 502 is to be included, etc. Note that the setting of the type of information by the update data setting unit 1205 may be automatically done by the importance level control unit 1202, etc., or may be done by the administrator, etc.

By the above configuration, for example, the communication apparatus 102 can automatically change the transmission frequency of the obstacle information, whether an image is to be included in the obstacle information, the type of data to be included in the obstacle information, etc., according to the importance level of data such as the weather, whether the obstacle is moving, etc.

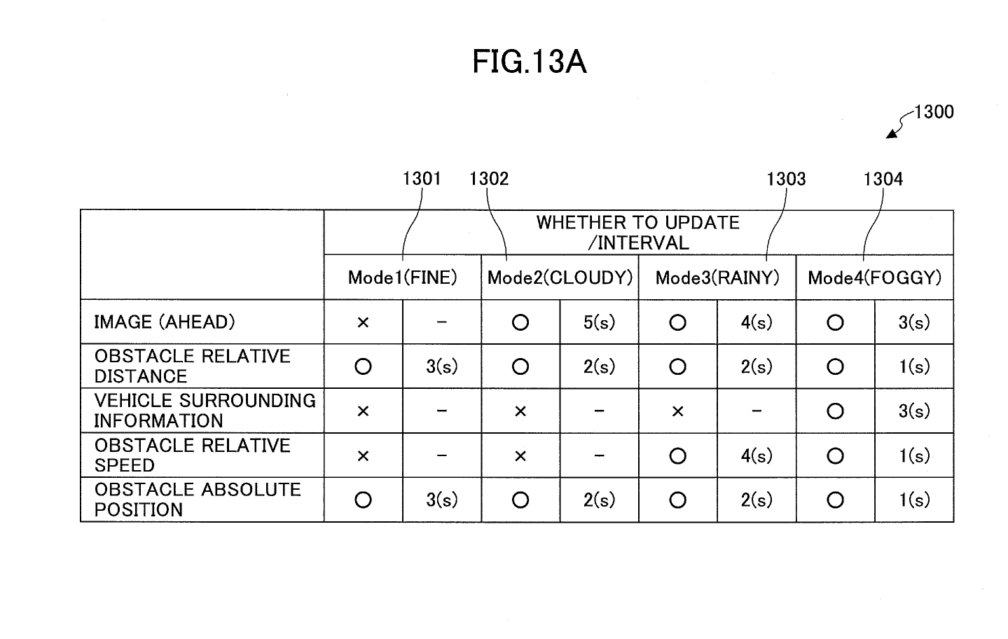

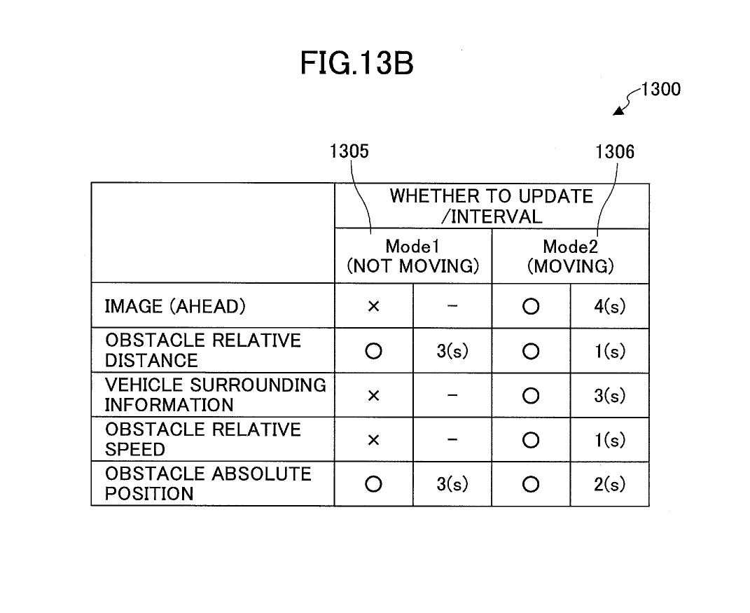

FIGS. 13A and 13B illustrate examples of the update frequency information according to the second embodiment.

FIG. 13A illustrates an example of update frequency information according to the weather. In FIG. 13A, in update frequency information 1300, whether to make an update and the update intervals are recorded, according to four importance levels corresponding to a plurality of weather conditions, i.e., Mode 1 (fine) 1301, Mode 2 (cloudy) 1302, Mode (rainy) 1303, and Mode 4 (foggy) 1304.

In FIG. 13A, “O” indicates to update the obstacle information, and “x” indicates not to update the obstacle information. Furthermore, “3(s)” described next to “O” indicates that the obstacle information is to be updated at intervals of three seconds. In the example of FIG. 13A, Mode 1 (fine) 1301 has the lowest importance level, and therefore a smaller number of information items are updated, and the update interval is set to be longer. Meanwhile, Mode 4 (foggy) 1304 has the highest importance level, and therefore a larger number of information items are updated, and the update interval is set to be shorter.

FIG. 13B illustrates an example of update frequency information according to whether the obstacle is moving. In FIG. 13B, in update frequency information 1300, whether to make an update and the update intervals are recorded, according to the two importance levels corresponding to whether the obstacle is moving, i.e., Mode 1 (not moving) 1305 and Mode 2 (moving) 1306.

In the example of FIG. 13B, Mode 1 (not moving) 1305 has a lower importance level, and therefore a smaller number of information items are updated, and the update interval is set to be longer. Meanwhile, Mode 2 (moving) 1306 has a higher importance level, and therefore a larger number of information items are updated, and the update interval is set to be shorter.

For example, the importance level setting unit 1102 of the information processing apparatus 101 is used for selecting one of the plurality of importance levels in FIG. 13B, i.e., Mode 1 (not moving) 1305 or Mode 2 (moving) 1306. Furthermore, the update data setting unit 1103 of the information processing apparatus 101 is used for changing the settings of whether to update each item, the update intervals, etc., with respect to the selected importance level. The same applies to the communication apparatus 102.

### Third Embodiment

In a third embodiment, a description is given of a case where the information processing system 100 includes a plurality of communication apparatuses 102.

### <System Configuration>

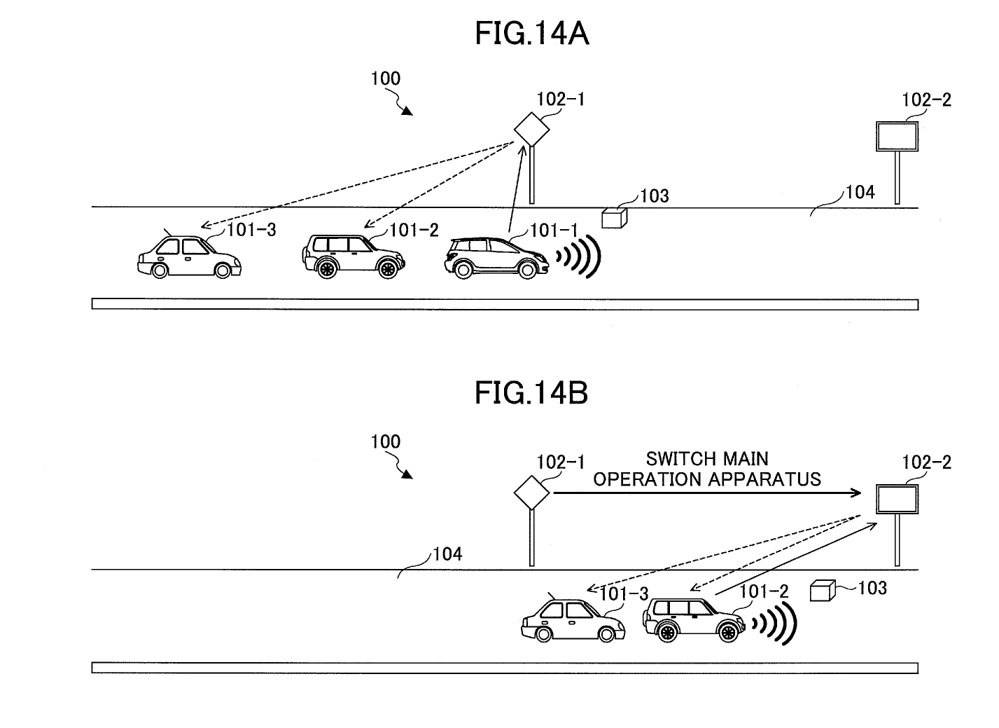

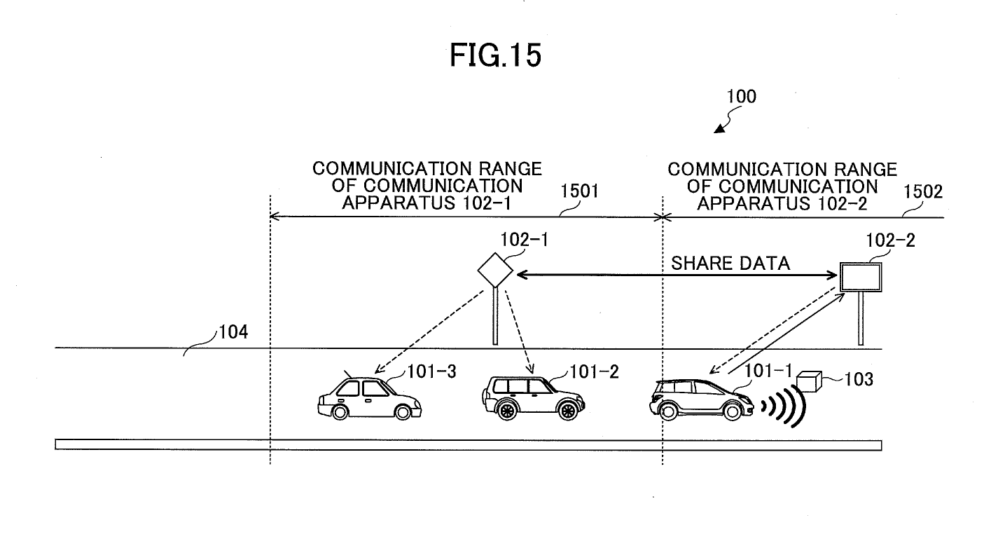

FIGS. 14A through 15 are for describing an overview of the information processing system 100 according to the third embodiment. In FIG. 14A, the information processing system 100 according to the third embodiment includes a plurality of communication apparatuses 102-1, 102-2 installed along the road 104, and a plurality of information processing apparatuses 101-1 through 101-3 moving along the road 104. Note that the number of the plurality of communication apparatuses 102-1, 102-2 is one example; the number may be any number greater than or equal to two. Similarly, the number of the plurality of information processing apparatuses 101-1 through 101-3 is one example; the number may be any number greater than or equal to two. Furthermore, in the following description, “communication apparatus 102” is used for indicating any one of the plurality of communication apparatuses 102-1, 102-2.

In FIG. 14A, it is assumed that the communication apparatus 102-1 reports information relevant to the obstacle 103 to the information processing apparatuses 101-2 and 101-3, based on the information of an obstacle 103 received from the information processing apparatus 101-1. Furthermore, it is assumed that the position of the obstacle 103 has moved after a predetermined time has passed, from the position near the communication apparatus 102-1 as in the state of FIG. 14A, to near the communication apparatus 102-2 as in the state of FIG. 14B.

In this case, the communication apparatus 102-1 according to the present embodiment has a function of switching the communication apparatus 102-2 that is closer to the obstacle 103, to be the communication apparatus 102 (main operation apparatus) that mainly receives the information relevant to the obstacle 103 and performs processes relevant to reporting.

Furthermore, as illustrated in FIG. 15, when the obstacle 103 is between the communication apparatus 102-1 and the communication apparatus 102-2, the communication apparatus 102-1 according to the present embodiment has function of sharing the information of an obstacle 103 with the communication apparatus 102-2. Accordingly, the communication apparatus 102-1 according to the present embodiment is able to perform the processes of receiving and reporting the information of an obstacle 103, etc., together with another communication apparatus 102-2.

Note that the main operation apparatus, which mainly performs the processes of receiving and reporting the information of an obstacle 103, etc., corresponds to the communication apparatus 102-2 that receives the obstacle information of an obstacle 103, in the example of FIG. 15. For example, the main operation apparatus receives obstacle information from the information processing apparatus 101 within the communication range of the main operation apparatus, and reports information based on the received obstacle information to information processing apparatuses 101 within the communication range of the main operation apparatus and to communication apparatuses 102 sharing data with the main operation apparatus.

In the example of FIG. 15, the communication apparatus 102-2 that is the main operation apparatus receives obstacle information relevant to the obstacle 103, from the information processing apparatus 101-1 within a communication range 1502 of the communication apparatus 102-2. Furthermore, the communication apparatus 102-2 reports information based on the received obstacle information, to the information processing apparatus 101-1 within the communication range 1502 of the communication apparatus 102-1, and also to the communication apparatus 102-1 that is sharing data with the communication apparatus 102-2.

Meanwhile, the communication apparatus 102-1 that is sharing data with the communication apparatus 102-2 reports information relevant to the obstacle 103 based on the information reported from the main operation apparatus, to the information processing apparatuses 101-2 and 101-3 within a communication range 1501 of the communication apparatus 102-1.

Preferably, the communication apparatus 102-2, which is the main operation apparatus, requests the information processing apparatus 101-1, etc., within the communication range 1502 of the communication apparatus 102-2, to send obstacle information, at specified time intervals. As described above, in the information processing system 100 according to the present embodiment, two or more communication apparatuses 102 can share the information (data) of the obstacle 103, and the obstacle information can be provided to information processing apparatuses 101 in a wider range. Furthermore, in the information processing system 100 according to the present embodiment, a plurality of communication apparatuses 102 perform the process of reporting the obstacle information, and therefore the load of each communication apparatus 102 can be reduced.

### <Functional Configuration>

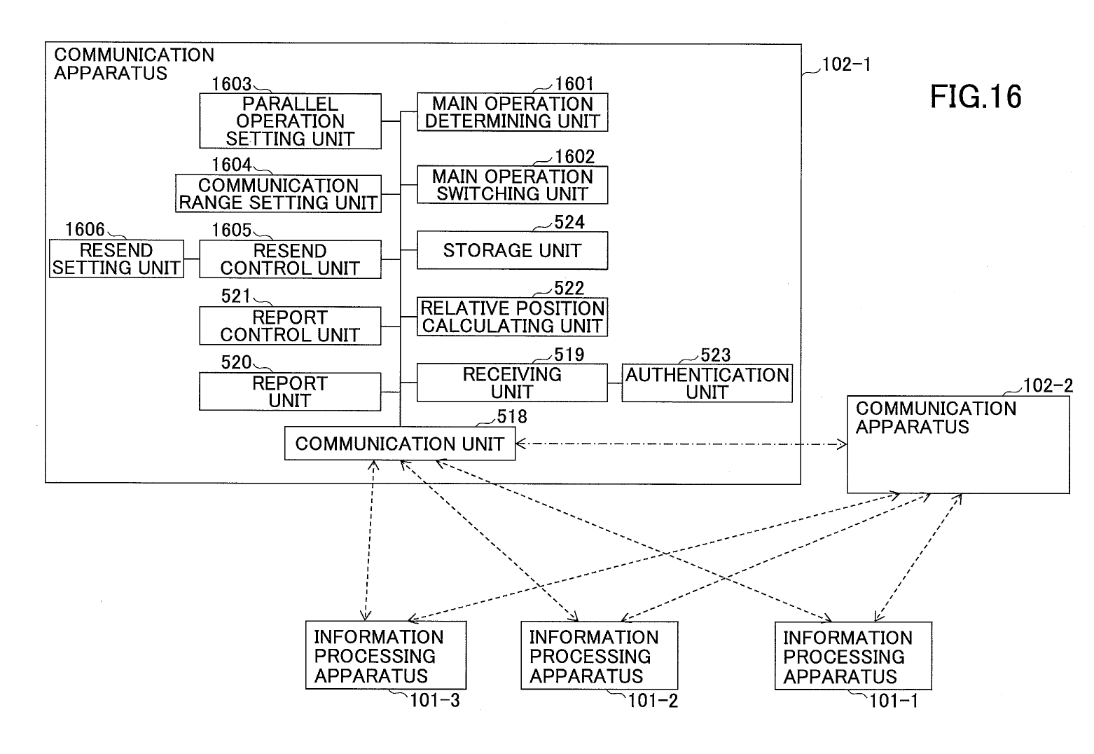

FIG. 16 illustrates a functional configuration of the information processing system according to the third embodiment. The communication apparatus 102 according to the present embodiment includes a main operation determining unit 1601, a main operation switching unit 1602, a parallel operation setting unit 1603, a communication range setting unit 1604, etc., in addition to the functional configurations of the first and second embodiments. Preferably, the communication apparatus 102 further includes a resend control unit 1605 and a resend setting unit 1606. Furthermore, the communication unit 518 according to the present embodiment is assumed to have a communication function of communicating with other communication apparatuses 102.

Note that the other functional configurations are the same as those of the second embodiment, and therefore the differences are mainly described herein. Furthermore, in FIG. 16, it is assumed that the communication apparatus 102-2 has the same functional configuration as the communication apparatus 102-1.

The main operation determining unit 1601 determines whether the communication apparatus 102 is presently operating as a main operation apparatus that mainly performs the processes of receiving and reporting the information of an obstacle 103, etc.

The main operation switching unit 1602 switches the communication apparatus 102 that is closer to the obstacle 103 to become the main operation apparatus, in cases where, for example, the obstacle 103 is a moving obstacle such as a vehicle, an animal, etc.

The parallel operation setting unit 1603 makes settings and implements control for parallel operations including sharing data between the communication apparatus 102-1 and the communication apparatus 102-2, in cases where, for example, the obstacle 103 is between the communication apparatus 102-1 and the communication apparatus 102-2.

Preferably, the communication apparatus 102-1 and the communication apparatus 102-2, which are performing parallel operation, respectively set the communication range for performing communication and report the information of an obstacle 103 to the information processing apparatuses 101 within their own communication ranges. Accordingly, the load of the communication process of the communication apparatuses 102 can be distributed, and the communication traffic of each communication apparatus 102 can be reduced.

The communication range setting unit 1604 has a function of setting the communication range of the communication apparatus 102. For example, the communication apparatus 102 may have a plurality of antennas along the road 104, and set the communication range by switching the number of antennas to be used. Alternatively, the communication apparatus 102 may set the communication range by changing the reception gain, the transmission output, the antenna properties, etc., of the communication unit 518.

The resend control unit 1605 requests a plurality of information processing apparatuses 101 to resend the information of an obstacle 103, for example, when the information of an obstacle 103 received from the information processing apparatus 101 is significantly different from the information received previously. Furthermore, the resend control unit 1605 compares the plurality of pieces of information that have been resent, and determines whether the information of an obstacle 103 that has been received earlier is correct. Furthermore, the resend control unit 1605 selects the appropriate information of an obstacle 103 based on the plurality of pieces of information that have been resent, and reports the selected information to the plurality of information processing apparatuses 101.

The resend setting unit 1606 sets the number of information items to be compared at the resend control unit 1605, and the time, etc.

Note that the main operation determining unit 1601, the main operation switching unit 1602, the parallel operation setting unit 1603, the communication range setting unit 1604, the resend control unit 1605, and the resend setting unit 1606 are realized by, for example, programs, etc., operating in the CPU of FIG. 4.

### <Process Flow>

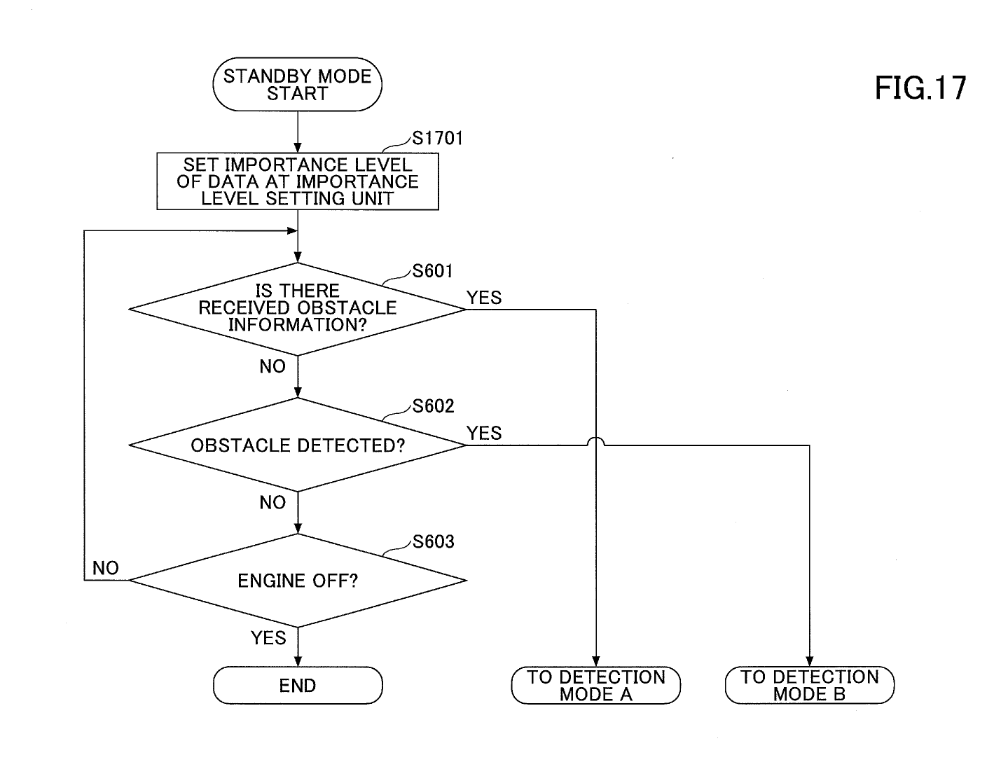

Next, with reference to the flowcharts of FIGS. 17 through 22, a description is given of processes performed by the information processing system 100 according to the third embodiment. Note that the flowcharts of FIGS. 17 through 22 also include the processes of the second embodiment.

### (Process Flow of Information Processing Apparatus)

FIG. 17 is a flowchart indicating a process of the standby mode performed by the information processing apparatus 101 according to the third embodiment. Note that the processes of steps S601 through S603 of FIG. 17 are the same as those of the process of the first embodiment illustrated in FIG. 6, and therefore the differences are mainly described herein.

In FIG. 17, for example, the information processing apparatus 101 starts a process of the standby mode, according to the startup of the engine of a vehicle, in which the information processing apparatus 101 is installed.

In step S1701, when the information processing apparatus 101 starts the process of the standby mode, the information processing apparatus 101 sets the importance level of the data, by the importance level setting unit 1102 of FIG. 11. For example, the importance level setting unit 1102 causes the display input unit 507 to display a GUI (Graphical User Interface) for setting the importance level of the data, and sets the importance level of the data according to an operation of the user. Alternatively, when the information received from the communication apparatus 102 includes weather information and information indicating whether the obstacle is moving, etc., the importance level setting unit 1102 may automatically set the importance level of the data according to weather information and information indicating whether the obstacle is moving, etc. Furthermore, when the information received from the communication apparatus 102 does not include weather information or information indicating whether the obstacle is moving, etc., the importance level setting unit 1102 may set the importance level of the data by a default setting.

When the setting of the importance level of the data in step S1701 is completed, the information processing apparatus 101 performs the processes of steps S601 through S603. Note that the process of step S1701 is a process relevant to the second embodiment.

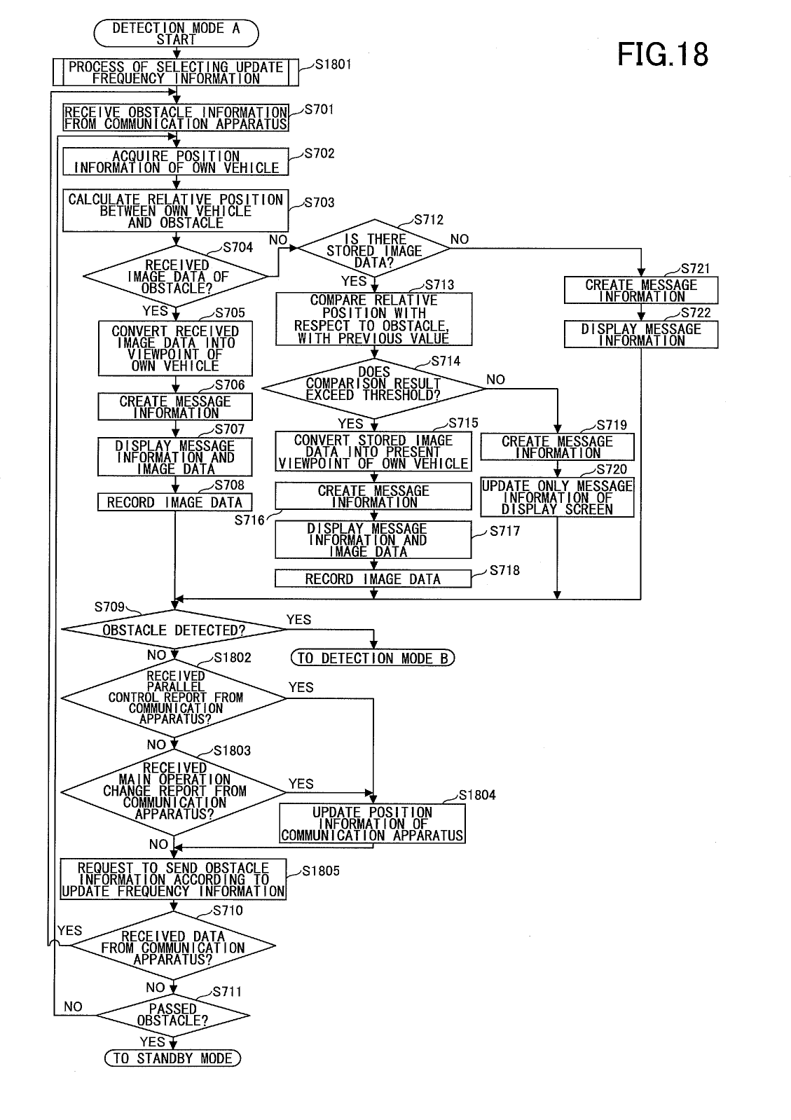

FIG. 18 is a flowchart indicating a process of the detection mode A performed by the information processing apparatus 101 according to the third embodiment. Note that the processes of steps S701 through S722 of FIG. 18 are the same as those of the process of the first embodiment illustrated in FIG. 10, and therefore the differences are mainly described herein.

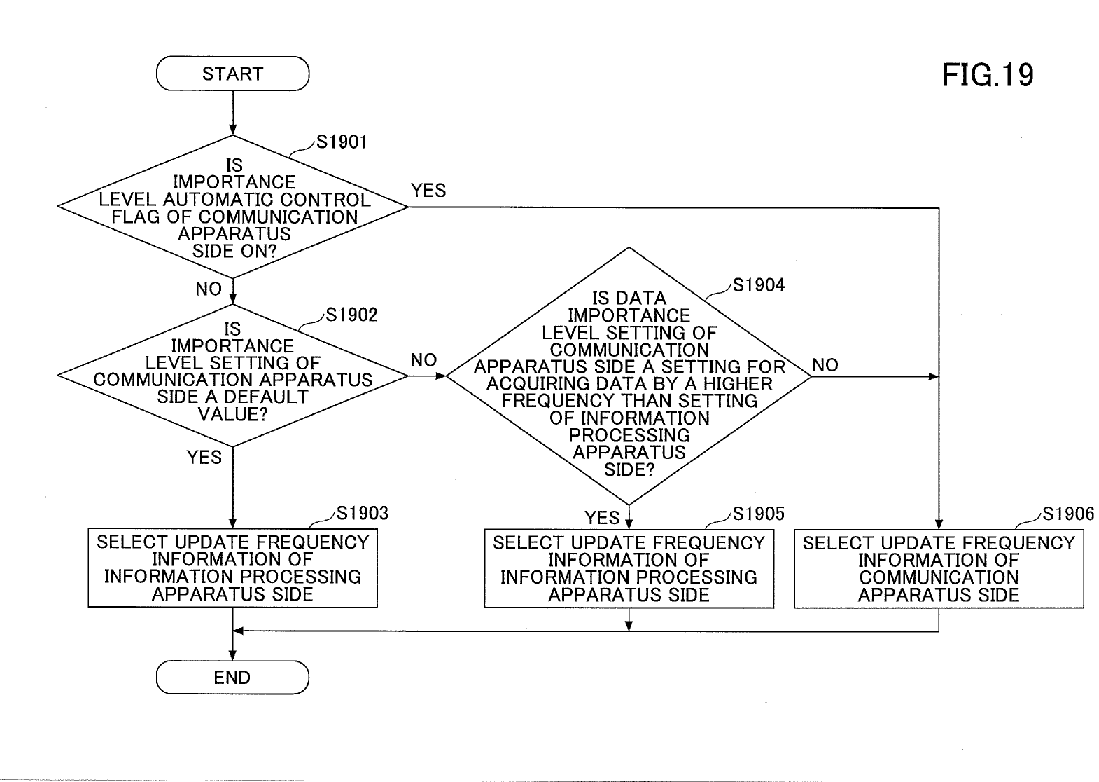

When the information processing apparatus 101 starts the process of the detection mode A, in step S1801, the information processing apparatus 101 performs a process of selecting update frequency information. Note that the process of selecting update frequency information is described below with reference to FIG. 19. Furthermore, the process of step S1801 is a process relevant to the second embodiment.

The processes from step S701 through S709 are the same as those of the first embodiment. When the detection unit 503 has not detected an obstacle in step S709, the information processing apparatus 101 executes the processes of step S1802 and onward.

In step S1802, the information processing apparatus 101 determines whether a parallel control report reporting that a plurality of the communication apparatuses 102 will perform a parallel process, has been received from the communication apparatus 102. This parallel control report includes, for example, information of the communication apparatus 102 to become the main operation apparatus, etc.

In step S1802, when a parallel control report has been received, the information processing apparatus 101 updates (calculates) the position information (absolute position, relative position, etc.) of the communication apparatus 102 to become the main operation apparatus, and shifts the process to step S1804. On the other hand, when a parallel control report has not been received in step S1802, the information processing apparatus 101 shifts the process to step S1803.

When the process shifts to step S1803, the information processing apparatus 101 determines whether a main operation change report reporting the change of the main operation apparatus, has been received from the communication apparatus 102. The main operation change report includes, for example, information of the communication apparatus 102 to become the new main operation apparatus, etc.

When the main operation change report has been received in step S1803, in step S1804, the information processing apparatus 101 updates (calculates) the position information (absolute position, relative position, etc.) of the communication apparatus 102 to become the new main operation apparatus, and shifts the process to step S1804. On the other hand, when a main operation change report has not been received in step S1803, the information processing apparatus 101 shifts the process to step S1805.

When the process shifts to step S1805, the information processing apparatus 101 sends information requesting the transmission of obstacle information to the communication apparatus 102 (when there are a plurality of communication apparatuses 102, to the communication apparatus 102 to become the main operation apparatus), according to the update frequency information selected in step S1801. Note that the processes of step S710 and onward are the same as those of the first embodiment.

By the above process, when a plurality of communication apparatuses 102 start a parallel operation, or when the main operation apparatus has been changed, the information processing apparatus 101 can perform a predetermined process with respect to the communication apparatus 102 to become the new main operation apparatus.

Note that also in the third embodiment, the process of the detection mode B is the same as the process of the first embodiment illustrated in FIG. 8, and therefore descriptions thereof are omitted.

FIG. 19 is a flowchart indicating a process of selecting the update frequency information performed by the information processing apparatus 101 according to the third embodiment.

In step S1801 of FIG. 18, when the process of selecting the update frequency information is started, in step S1901 of FIG. 19, the information processing apparatus 101 determines whether the importance level automatic control flag of the communication apparatus 102 side is enabled (ON). Note that the importance level automatic control flag is assumed to be included in the information (for example, the obstacle information, etc.) reported from the communication apparatus 102.

When the importance level automatic control flag of the communication apparatus 102 side is enabled in step S1901, in step S1906, the information processing apparatus 101 selects the update frequency information of the communication apparatus 102 side. In this case, the information processing apparatus 101 performs the process according to the update frequency information of the communication apparatus 102 side. On the other hand, when the importance level automatic control flag of the communication apparatus 102 side is disabled in step S1901, the information processing apparatus 101 shifts the process to step S1902.

When the process shifts to step S1902, the information processing apparatus 101 determines whether the importance level setting of the communication apparatus 102 is a default value. Note that the information, which is used for determining whether the importance level setting of the communication apparatus 102 is a default value, is assumed to be included in the information reported from the communication apparatus 102, etc. (for example, the obstacle information).

When the importance level setting of the communication apparatus 102 is a default value in step S1902, the information processing apparatus 101 selects the update frequency information of the information processing apparatus 101 side (step S1903). The default value of the importance level setting is set such that the number of update data items is relatively small, and the update frequency is relatively low (the interval is long), as in the case of, for example, Mode 1 (fine) in FIG. 13A. Therefore, when the importance level setting of the communication apparatus 102 side is the default value, the information processing system 100 is preferably able to set whether each data item is to be updated, the update interval, etc., by using the update frequency information of the information processing apparatus 101 side. On the other hand, when the importance level setting of the communication apparatus 102 is not the default value in step S1902, the information processing apparatus 101 shifts the process to step S1904.

When the process shifts to step S1904, the information processing apparatus 101 determines whether the data importance level of the communication apparatus 102 side has a setting of acquiring data by a higher frequency than the setting of the information processing apparatus 101 side. Note that the information, which is used for determining whether the data importance level of the communication apparatus 102 side has a setting of acquiring data by a higher frequency than the setting of the information processing apparatus 101 side, is assumed to be included in the information reported from the communication apparatus 102, etc. (for example, the obstacle information).

When the data importance level of the communication apparatus 102 side has a setting of acquiring data by a higher frequency than the setting of the information processing apparatus 101 side in step S1904, the information processing apparatus 101 selects the update frequency information of the information processing apparatus 101 side (step S1905). On the other hand, when the data importance level of the communication apparatus 102 side does not has a setting of acquiring data by a higher frequency than the setting of the information processing apparatus 101 side in step S1904, the information processing apparatus 101 selects the update frequency information of the communication apparatus 102 side (step S1906).

Note that the process of selecting the update frequency information illustrated in FIG. 19 is one example. For example, when the importance level setting is automatically controlled according to weather information, whether the obstacle moves, etc., the information processing system 100 performs the process according to the importance level setting and the update frequency information that are automatically controlled. This automatic control may be implemented on the communication apparatus 102 side or on the information processing apparatus 101 side. Furthermore, when the importance level setting is not automatically controlled, the information processing system 100 performs the process according to the importance level setting and the update frequency information of the communication apparatus 102 side or the importance level setting and the update frequency information of the information processing apparatus 101 side. Preferably, the information processing system 100 performs the process according to the higher update frequency, between the data update frequency of the communication apparatus 102 side and the data update frequency of the information processing apparatus 101 side.

### (Process Flow of Communication Apparatus)

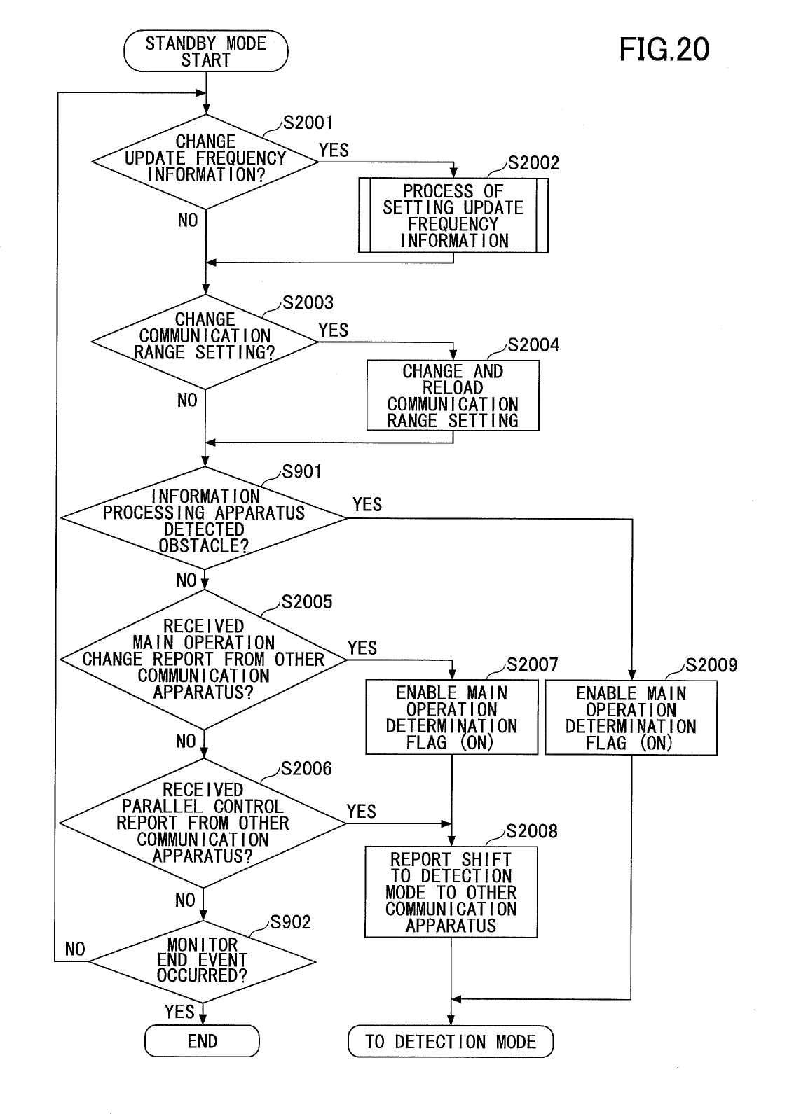

FIG. 20 is a flowchart indicating a process of a standby mode performed by the communication apparatus 102 according to the third embodiment.

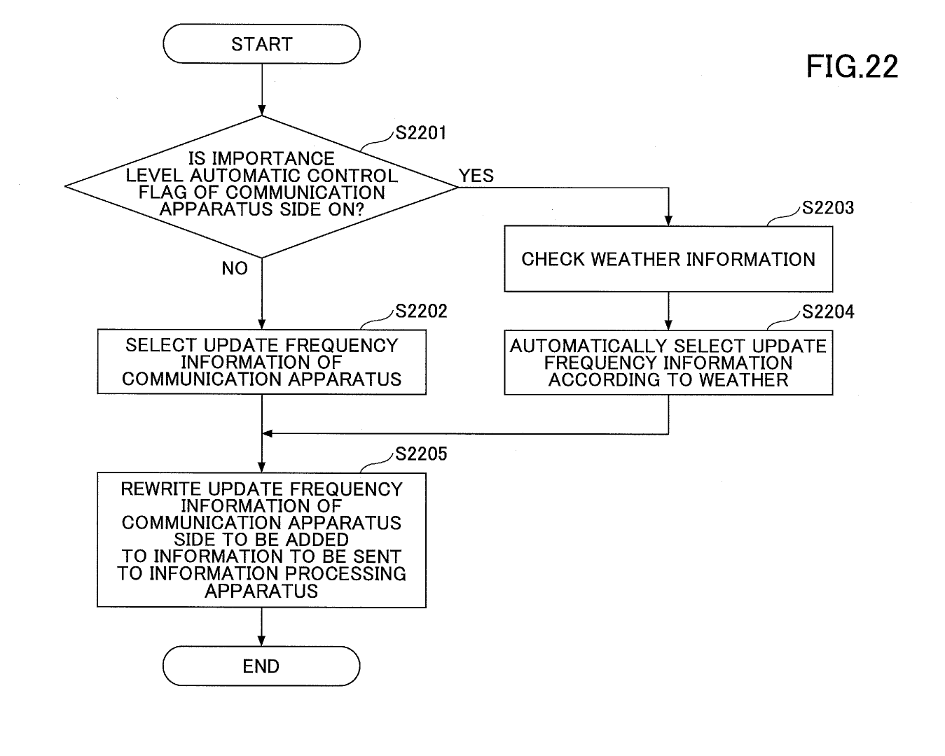

When the communication apparatus 102 starts the process of the standby mode, in step S2001, the communication apparatus 102 determines whether to change the update frequency information, and when the update frequency information is to be changed, the communication apparatus 102 performs a process of setting the update frequency information (step S2002). Note that the process of setting the update frequency information is described below with reference to FIG. 22. On the other hand, when the update frequency information is not to be changed, the communication apparatus 102 shifts the process to step S2003.

When the process shifts to step S2003, the communication apparatus 102 determines whether to change the communication range setting. For example, in the example of FIG. 15, the communication apparatus 102-1, which shares data with the communication apparatus 102-2 that is the main operation apparatus, determines whether to change the communication range according to an instruction from the communication apparatus 102-2. Furthermore, when the communication apparatus 102-2 that is the main operation apparatus starts sharing data with, for example, the communication apparatus 102-1, the communication apparatus 102-2 changes the communication range 1502 of the communication apparatus 102-2, and instructs the communication apparatus 102-1 to change the communication range 1501 of the communication apparatus 102-1. In step S2003, when the communication apparatus 102 determines to change the communication range setting, in step S2004, the communication apparatus 102 changes the setting value of the communication range setting, and changes the communication range of the communication apparatus 102 by, for example, reloading the changed setting value, etc.

In step S901, similar to the first embodiment, the communication apparatus 102 determines whether the information processing apparatus 101 has detected an obstacle. When the communication apparatus 102 determines that the information processing apparatus 101 has detected an obstacle in step S901, the communication apparatus 102 enables the main operation determination flag (ON) (step S2009), and shifts the process to the detection mode. On the other hand, when the communication apparatus 102 determines that the information processing apparatus 101 has not detected an obstacle, the communication apparatus 102 executes the processes of step S2005 and onward.

In step S2005, the communication apparatus 102 determines whether a main operation change report has been received from another communication apparatus 102. When a main operation change report has been received from another communication apparatus 102 in step S2005, the communication apparatus 102 enables the main operation determination flag (ON) (step S2007). Furthermore, the communication apparatus 102 sends a report indicating that the communication apparatus 102 will shift to the detection mode to the other communication apparatus 102, which has sent the main operation change report (step S2008), and shifts the process to the detection mode. On the other hand, when a main operation change report has not been received from another communication apparatus 102 in step S2005, the communication apparatus 102 shifts the process to step S2006.

When the process shifts to step S2006, the communication apparatus 102 determines whether a parallel control report has been received from another communication apparatus 102. When a parallel control report has been received from another communication apparatus 102 in step S2006, the communication apparatus 102 sends a report indicating that the communication apparatus 102 will shift to the detection mode to the other communication apparatus 102, which has sent the parallel control report (step S2008), and shifts the process to the detection mode. On the other hand, when a parallel control report has not been received from another communication apparatus 102 in step S2006, the communication apparatus 102 shifts the process to step S902.

When the process shifts to step S902, similar to the first embodiment illustrated in FIG. 9, the communication apparatus 102 determines whether a predetermined monitor end event has occurred. In step S902, when a monitor end event has not occurred, the communication apparatus 102 returns to step S2001 and repeats the same process. On the other hand, in step S902, when a monitor end event has occurred, the communication apparatus 102 ends the process of the standby mode.

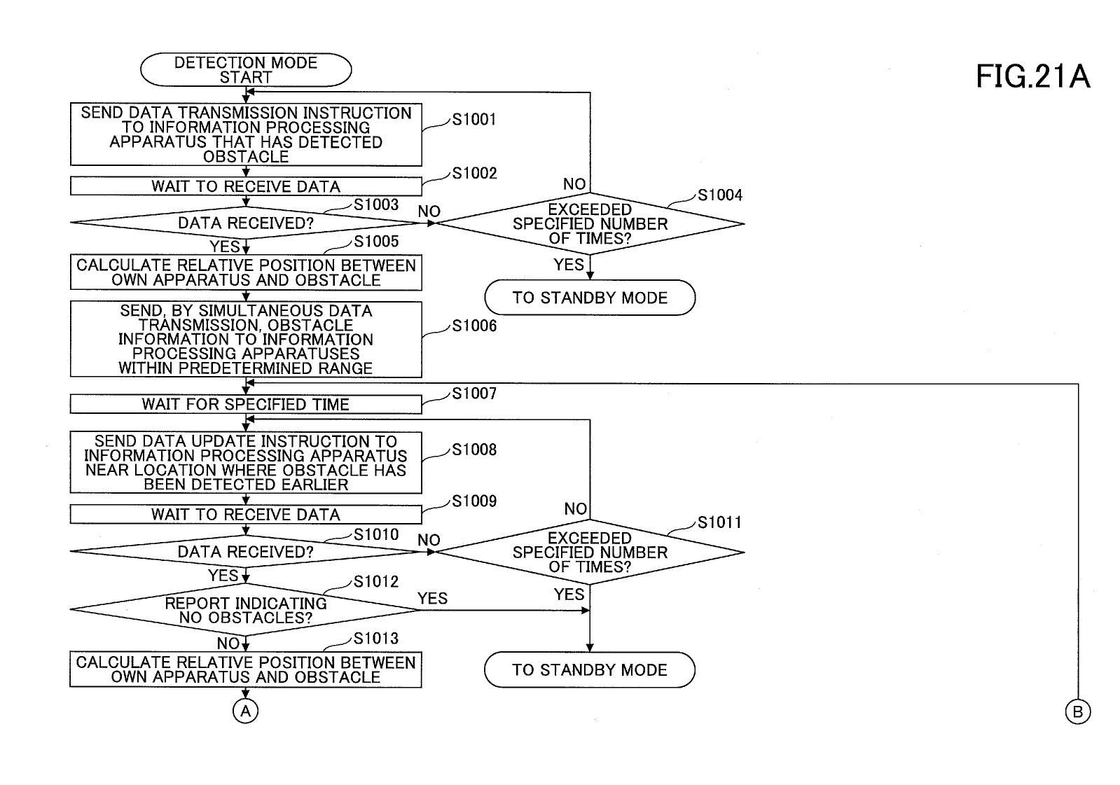

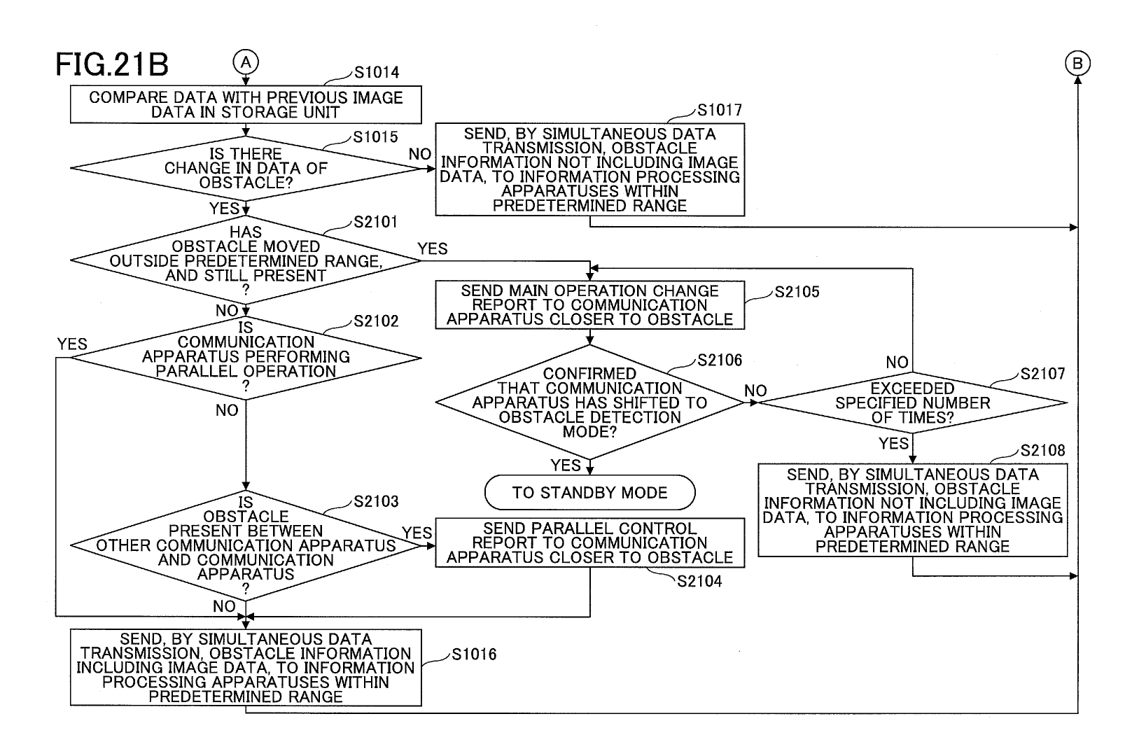

FIGS. 21A and 21B are a flowchart indicating a process of a detection mode performed by the communication apparatus 102 according to the third embodiment. Note that the processes of steps S1001 through S1017 of FIGS. 21A and 21B are the same as those of the first embodiment illustrated in FIG. 10, and therefore the differences are mainly described herein.

In step S1015 of FIGS. 21A and 21B, when it is determined that there is a change in the data of the obstacle, the communication apparatus 102 according to the present embodiment executes the processes of step S2101 and onward.

In step S2101, the communication apparatus 102 determines whether the obstacle has moved outside a predetermined range, and is still present.

For example, in FIG. 15, when the position of the obstacle 103 moves from the communication range 1501 of the communication apparatus 102-1 to the communication range 1502 of the communication apparatus 102-2, the communication apparatus 102-1 can determine that the obstacle has moved outside of a predetermined range. Alternatively, when the distance between the communication apparatus 102-1 and the obstacle 103 becomes longer than the distance between the communication apparatus 102-2 and the obstacle 103, the communication apparatus 102-1 may determine that the obstacle has moved outside of a predetermined range. Furthermore, based on the obstacle information received from the information processing apparatus 101, the communication apparatus 102 may determine whether the obstacle is still present.

When the communication apparatus 102 determines that the obstacle has moved outside a predetermined range, and is still present in step S2101, the communication apparatus 102 executes the processes of step S2105 and onward. On the other hand, when the communication apparatus 102 does not determine that the obstacle has moved outside a predetermined range, and is still present in step S2101, the communication apparatus 102 executes the processes of step S2102 and onward.

In step S2102, the communication apparatus 102 determines whether the communication apparatus 102 is performing parallel operation. When the communication apparatus 102 is performing parallel operation, the communication apparatus 102 shifts the process to step S1016. On the other hand, when the communication apparatus 102 is not performing parallel operation, the communication apparatus 102 shifts the process to step S2103.

When the process shifts to step S2103, the communication apparatus 102 determines whether an obstacle is present between the communication apparatus 102 and another communication apparatus 102 with which communication is possible. When an obstacle is not present between the communication apparatus 102 and another communication apparatus 102, the communication apparatus 102 shifts the process to step S1016. On the other hand, when an obstacle is present between the communication apparatus 102 and another communication apparatus 102, the communication apparatus 102 sends a parallel control report to another communication apparatus 102 that is closer to the obstacle (step S2104), and shifts the process to step S1016.

Note that the process of step S1016 is the same as that of the first embodiment.

Next, a description is given of a process in a case where the communication apparatus 102 determines that the obstacle has moved outside a predetermined range, and is still present in step S2101.

In step S2101, when the communication apparatus 102 determines that the obstacle has moved outside a predetermined range, and is still present, in step S2105, the communication apparatus 102 sends a main operation change report to another communication apparatus 102 that is closer to the obstacle.

In step S2106, the communication apparatus 102 confirms that the other communication apparatus 102, to which the main operation change report has been sent, has shifted to the obstacle detection mode. For example, the communication apparatus 102 determines whether (confirms that) the other communication apparatus 102 has shifted to the obstacle detection mode, based on whether a report indicating that the other communication apparatus 102 will shift to the detection mode has been received from the other communication apparatus 102.

When the communication apparatus 102 confirms that the other communication apparatus 102, to which the main operation change report has been sent, has shifted to the obstacle detection mode in step S2106, the communication apparatus 102 shifts the process to the standby mode. On the other hand, when the communication apparatus 102 cannot confirm that the other communication apparatus 102, to which the main operation change report has been sent, has shifted to the obstacle detection mode in step S2106, in step S2107, the communication apparatus 102 repeats to retry sending the main operation change report until a specified number of times is exceeded. Furthermore, when the number of times of retrying to send the main operation change report exceeds the specified number in step S2107, the communication apparatus 102 shifts the process to step S2108.

In step S2108, similar to step S1017, the communication apparatus 102 simultaneously sends the obstacle information that does not include the image data to the information processing apparatuses 101 in a predetermined range.

FIG. 22 is a flowchart indicating a process of setting the update frequency information performed by the communication apparatus 102 according to the third embodiment.

In step S2002 of FIG. 20, when the process of setting the update frequency information is started, in step S2201 of FIG. 22, the communication apparatus 102 determines whether the importance level automatic control flag of the communication apparatus 102 is enabled (ON).

When the importance level automatic control flag of the communication apparatus 102 is enabled (ON), in step S2203, the communication apparatus 102 checks the weather information by the weather information acquiring unit 1203 of FIG. 12, and determines the present weather. Furthermore, in step S2204, the communication apparatus 102 automatically selects the update frequency information according to the weather, and shifts the process to step S2205. For example, when the weather is “rainy” in step S2203, in step S2204, the communication apparatus 102 automatically selects the information of the importance level Mode 3 (rainy) 1303 of FIG. 13A.

On the other hand, when the importance level automatic control flag of the communication apparatus 102 is disabled (OFF), in step S2202, the communication apparatus 102 selects the update frequency information of the communication apparatus 102 side, and shifts the process to step S2205. For example, when the administrator or the management server, etc., has not set the importance level of the update frequency information, in step S2202, the communication apparatus 102 selects a default importance level, for example, the information of the importance level Mode 1 (fine) 1301 in FIG. 13A, etc.

When the process shifts to step S2205, the communication apparatus 102 rewrites the update frequency-information of the communication apparatus 102 side to be added to the information (obstacle information, etc.) to be sent to the information processing apparatus 101, by using the information selected in step S2202 or S2204.

Note that the process of setting the update frequency information illustrated in FIG. 22 is one example. For example, the communication apparatus 102 may select the importance level of the update frequency information based on information other than the weather, for example, the time period, the temperature, the season, etc.

As described above, by the information processing system 100 according to the third embodiment, by using two or more communication apparatuses 102 provided along the road 104, the obstacle information can be reported to information processing apparatuses 101 in a wider range. Furthermore, in the information processing system 100, the communication apparatus 102 to be the apparatus mainly performing the receiving, the reporting, etc., of the obstacle information, can be automatically switched according to the movement of an obstacle.

### Fourth Embodiment

The communication apparatus 102 according to the first embodiment uses one communication unit 518 to send the information relevant to the obstacle, to a plurality of information processing apparatuses 101. However, there may be cases where an information processing apparatus 101 near the obstacle and an information processing apparatus 101 away from the obstacle need different information and different update frequencies.

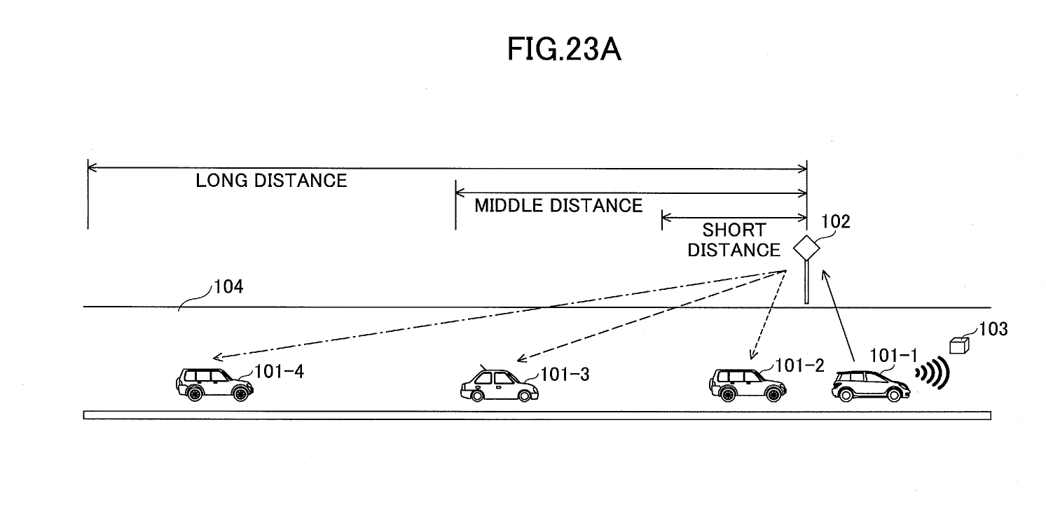

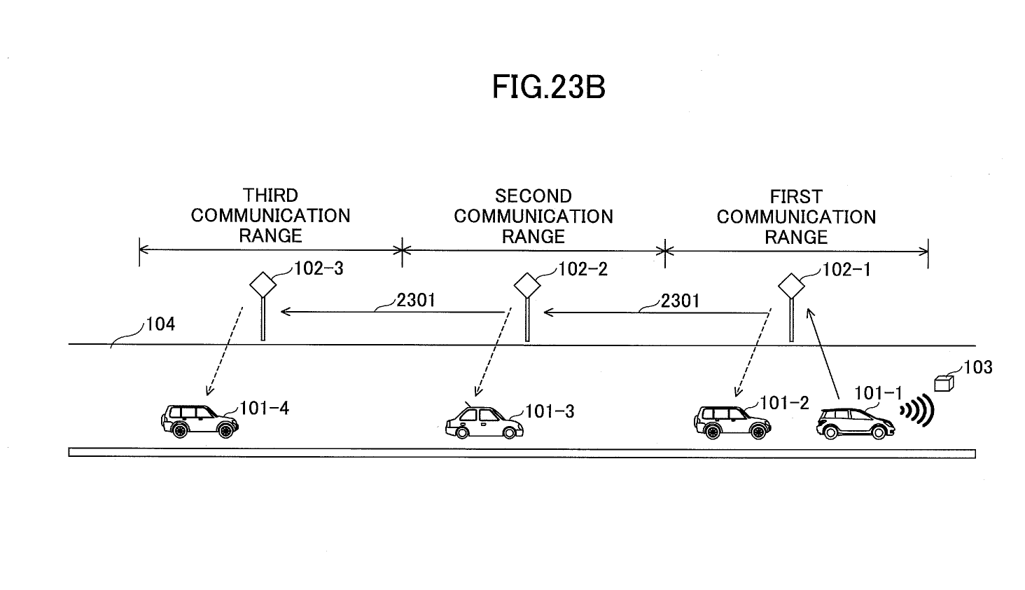

FIGS. 23A and 23B are for describing an overview of the information processing system 100 according to a fourth embodiment.

FIG. 23A illustrates an example of a configuration of the information processing system 100. In FIG. 23A, for the information processing apparatus 101-4, which is most far away from the obstacle 103, it is considered that information relevant to still obstacles such as a work signboard and a stopped vehicle, etc., is more important than information of a moving obstacle. This is because a moving obstacle may have moved to another point by the time the information processing apparatus 101 reaches the point where the obstacle is found. Furthermore, in this case, the information of obstacle does not necessarily need to be updated frequently.

Meanwhile, for the information processing apparatus 101-2 that is near the obstacle, information relevant to a moving obstacle, such as a person, a two-wheeled vehicle, an animal, etc., is more dangerous and therefore more important than information relevant to still obstacles. In this case, the information of an obstacle is preferably updated at relatively short time intervals (for example, at five second intervals, etc.).

In the example of FIG. 23A, the communication apparatus 102 is assumed to include three communication units having different communication ranges, i.e., a communication unit for a short distance (for example, less than 100 m), a communication unit for a middle distance (for example, less than 1 km), and a communication unit for a long distance (for example, greater than or equal to 1 km). Note that three communication units is one example; the number of the plurality of communication units having different communication ranges may be any other number of two or more. Furthermore, the values of the distances are also examples.

By the above configuration, for example, the communication apparatus 102 sends information of a moving obstacle by using a communication unit for a short distance, at a relatively short time intervals (for example, at five second intervals, etc.). Furthermore, the communication apparatus 102 sends information of a moving obstacle by using a communication unit for a middle distance, at time intervals longer than the case of the communication unit for short distance (for example, at 30 second intervals, etc.). Furthermore, the communication apparatus 102 sends information of a still obstacle by using a communication unit for a long distance, at relatively long time intervals (for example, at one minute intervals, etc.). For example, by implementing the above control, appropriate information according to the distance from the obstacle 103 can be reported to the respective information processing apparatuses 101. Note that the above time intervals and the contents of the reported information are merely examples.

FIG. 23B illustrates another example of a configuration of the information processing system 100. FIG. 23B illustrates an example where a plurality of vehicles are travelling in the same direction as in a high-speed way, etc., and a plurality of communication apparatuses 102-1 through 102-3 are set along the road 104. Note that it is assumed that the communication apparatus 102-1 can communicate with the communication apparatus 102-2, and the communication apparatus 102-2 can communicate with the communication apparatus 102-3. In this case, the communication apparatus 102-1 can use the communication apparatus 102-2 as a communication unit of for a middle distance, and use the communication apparatus 102-3 as a communication unit of for a long distance.

For example, the communication apparatus 102-1 sends information of a moving object at relatively short time intervals (for example, at five second intervals) from the own apparatus. Furthermore, the communication apparatus 102-1 instructs the communication apparatus 102-2 to send information of a moving obstacle at longer time intervals (for example, at 30 second intervals). Furthermore, the communication apparatus 102-1 instructs the communication apparatus 102-3 via the communication apparatus 102-2, to send information of a still obstacle, at even longer time intervals (for example, at one minute intervals). As described above, the communication apparatus 102 can use other communication apparatuses 102 as a plurality of communication units having different communication ranges.

Note that the system configurations in FIGS. 23A and 23B are examples. There may be other examples of system configurations as long as the communication apparatus 102 according to the present embodiment uses a plurality of communication units having different communication ranges to report communication of obstacles to the information processing apparatus 101 according to the distance from the obstacles. Furthermore, the communication units having different communication ranges may be included in the communication apparatus 102 as in the example of FIG. 23A, or communication units outside the communication apparatus 102 may be used as in the example of FIG. 23B.

### <Hardware Configuration>

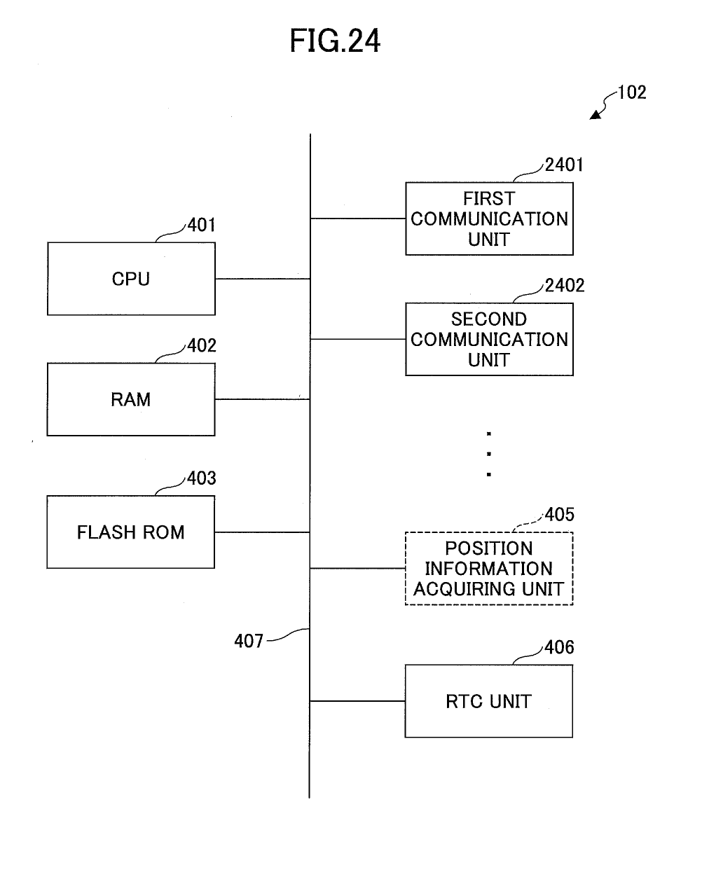

FIG. 24 illustrates a hardware configuration example of the communication apparatus 102 according to the fourth embodiment. The communication apparatus 102 according to the present embodiment includes a plurality of communication units (a first communication unit 2401, a second communication unit 2402, and so on), instead of the communication unit 404 of the communication apparatus 102 according to an embodiment illustrated in FIG. 4. Note that the communication apparatus 102 according to the present embodiment may have the configuration of the communication apparatus 102 illustrated in FIG. 4, when external communication units are used as the plurality of communication units.

### <Functional Configuration>

### (Functional Configuration of Communication Apparatus)

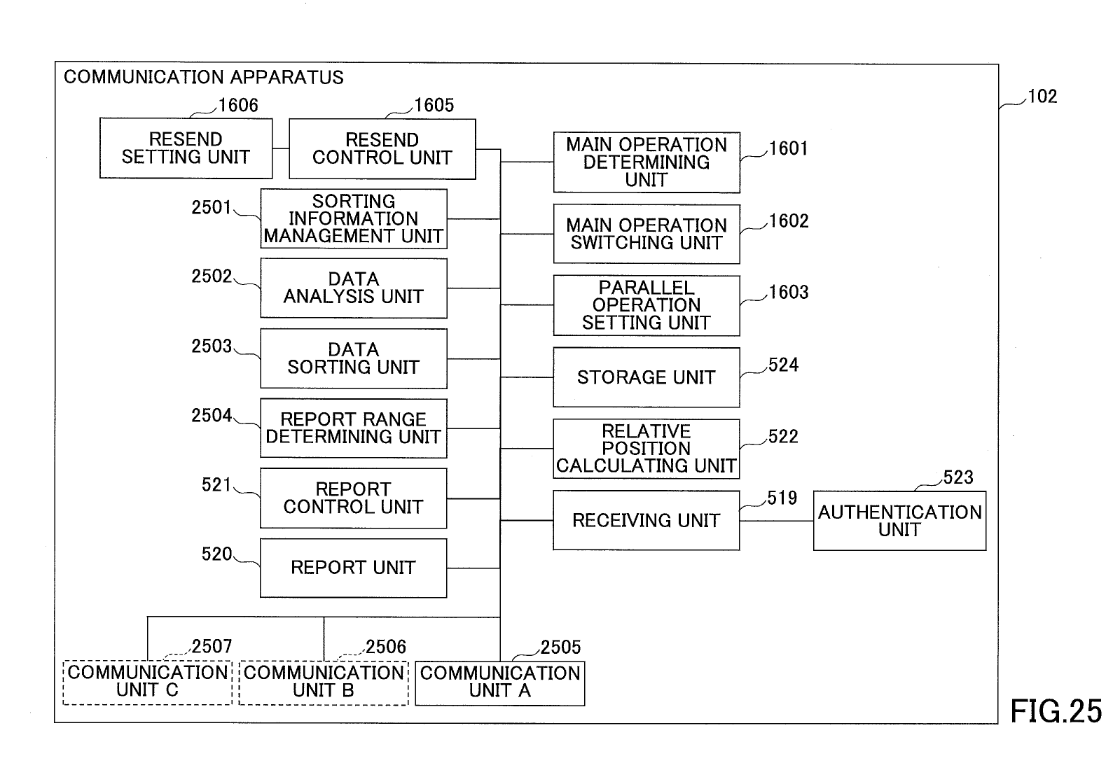

FIG. 25 illustrates a functional configuration of the communication apparatus 102 according to the fourth embodiment. The communication apparatus 102 according to the present embodiment includes a sorting information management unit 2501, a data analysis unit 2502, a data sorting unit 2503, a report range determining unit 2504, etc., in addition to the configurations of the communication apparatus 102 according to the third embodiment illustrated in FIG. 16. Note that the sorting information management unit 2501, the data analysis unit 2502, the data sorting unit 2503, and the report range determining unit 2504 are realized by, for example, programs operating in the CPU 401.

Furthermore, the communication apparatus 102 according to the present embodiment includes a plurality of communication units having different communication ranges, for example, a communication unit A 2505, a communication unit B 2506, a communication unit C 2507, etc. Note that the number of the plurality of communication units is one example; the number of communication units may be any number that is two or more. Furthermore, the communication unit B 2506, the communication unit C 2507, etc., other than the communication unit A 2505 may be provided outside the communication apparatus 102.

Note that configurations other than the above are the same as those of the communication apparatus 102 according to the third embodiment illustrated in FIG. 16, and therefore the differences are mainly described herein. Furthermore, the configuration of the information processing apparatus 101 may be the same as that of the information processing apparatus 101 according to the first embodiment illustrated in FIG. 5.

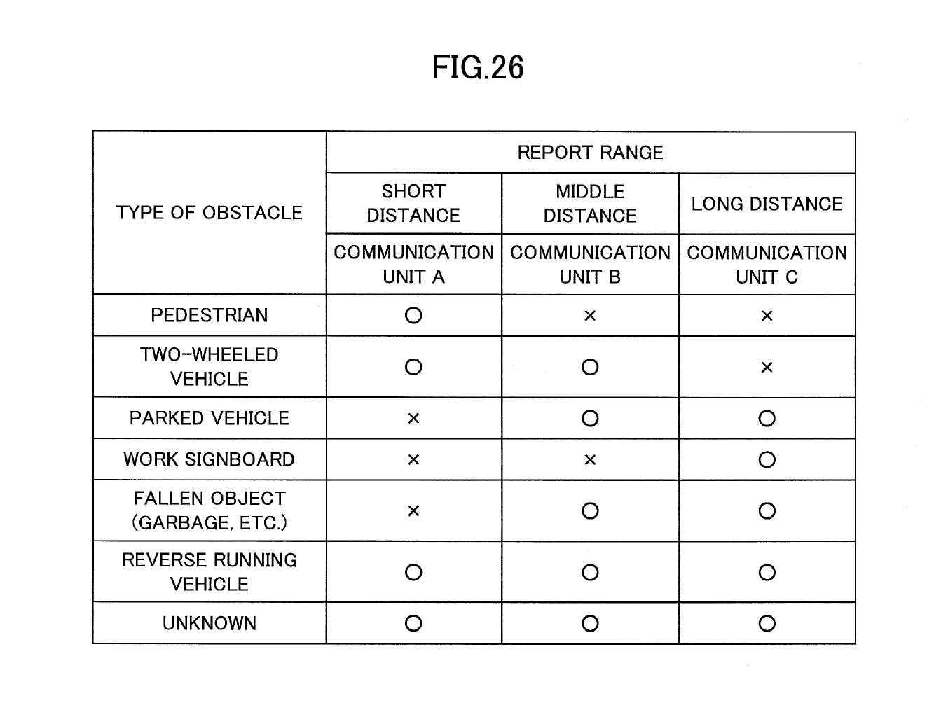

The sorting information management unit 2501 stores and manages sorting information in the storage unit 524. In the sorting information, the types of a plurality of obstacles (for example, a pedestrian, a signboard, a vehicle, etc.) and the report ranges of the information of obstacles (for example, short distance, middle distance, long distance, etc.) are stored in association with each other. An example of the sorting information managed by the sorting information management unit 2501 is illustrated in FIG. 26.

FIG. 26 illustrates an example of sorting information according to the fourth embodiment. In the sorting information in the example of FIG. 26, the types of a plurality of obstacles and the corresponding report ranges are stored in association with each other. Note that in the report range, “O” indicates “to report”, and “x” indicates “not to report”. For example, when the type of obstacle is “pedestrian”, the report range is “short distance (communication unit A)”. Furthermore, when the type of obstacle cannot be identified, the type of obstacle becomes “unknown”, and the report range becomes “short distance (communication unit A)”, “middle distance (communication unit B)”, and “long distance (communication unit C)”.

In the example of FIG. 26, an obstacle that may move according to the passage of time (pedestrian, two-wheeled vehicle, etc.) is highly likely to endanger the vehicle, and therefore relevant information is reported to an information processing apparatus 101 that is located near the obstacle. Meanwhile, with respect to an information processing apparatus 101 that is located away from the obstacle, the obstacle is likely to have moved and disappeared by the time the information processing apparatus 101 reaches the location where the obstacle is found, and therefore a setting is made not to report the information to this information processing apparatus 101.

Furthermore, with respect to an obstacle that is highly likely to be still regardless of the passage of time (a still signboard, etc.), the danger level is low even when the information processing apparatus 101 comes near the obstacle, and therefore it is considered that information indicating that there is an obstacle, is to be reported beforehand, at a location that is distanced away from the obstacle. This is because at a location near the obstacle, the driver can obtain the information of the obstacle by actually seeing the obstacle in the surroundings. Therefore, in the example of FIG. 26, a setting is made not to report the information of a still obstacle to vehicles travelling near the still obstacle.

In the example of FIG. 26, from the communication unit A, information of a pedestrian, a two-wheeled vehicle, and a reverse running vehicle is sent, and from the communication unit B, information of a two-wheeled vehicle, a parked vehicle, a fallen object (garbage), and a reverse running vehicle is sent, by broadcast transmission to the information processing apparatuses 101. Furthermore, from the communication unit C, information of a parked vehicle, a work signboard, a fallen object (garbage), and a reverse running vehicle is sent, by broadcast transmission to the information processing apparatuses 101.

Note that the above sorting method is merely an example; the method of sorting the transmission ranges according to the types of obstacles may be any method.

Referring back to FIG. 25, a description of the functional configuration of the communication apparatus 102 is continued.

The data analysis unit 2502 compares the distance information (relative distance) relevant to an obstacle, image data, etc., received from the information processing apparatus 101, with, for example, an existing database, etc., and analyzes the type, the size, etc., of the obstacle. For example, the communication apparatus 102 stores in advance the feature information of obstacles included in the types of obstacles of FIG. 26, in the storage unit 524. Furthermore, the data analysis unit 2502 can analyze the type of obstacle by extracting the feature information of an obstacle received from the information processing apparatus 101 and comparing the extracted feature information with feature information of an obstacle stored in advance.

Furthermore, the data analysis unit 2502 compares information of an obstacle received by the receiving unit 519 with information of an obstacle of the same type received previously by the receiving unit 519, and analyzes how much the data has changed.

The data sorting unit 2503 sorts obstacles into a plurality of types of obstacles in the sorting information described above, according to the type and size of the obstacle information analyzed by the data analysis unit 2502.

The report range determining unit 2504 determines the report range of sending the information of an obstacle, the communication unit, etc., based on the type of obstacle into which the obstacle has been sorted by the data sorting unit 2503 and the sorting information managed by the sorting information management unit 2501. Furthermore, the report range determining unit 2504 also sets the communication ranges (for example, reach distance of radio waves) of the communication unit A through the communication unit C.

The communication unit A 2505 corresponds to the communication unit 518 according to the third embodiment illustrated in FIG. 16, and performs communication with the information processing apparatus 101 and other communication apparatuses 102.

Similar to the communication unit A 2505, the communication unit B 2506 performs communication with the information processing apparatus 101 and other communication apparatuses 102, but has a different communication range (for example, reach distance of radio waves) from that of the communication unit A 2505.

Similar to the communication unit A 2505 and the communication unit B 2505, the communication unit C 2507 performs communication with the information processing apparatus 101 and other communication apparatuses 102, but has a different communication range (for example, reach distance of radio waves) from those of the communication unit A 2505 and the communication unit B 2506.

The communication unit A 2505, the communication unit B 2506, and the communication unit C 2507 are realized by, for example, the first communication unit 2401, the second communication unit 2402, etc., illustrated in FIG. 24.

The communication unit A 2505, the communication unit B 2506, and the communication unit C 2507 perform wireless communication by different communication methods (protocols) from each other. For example, the communication unit A 2505 may use wireless communication having a relatively narrow communication range, such as Near Field Communication, wireless PAN (Personal Area Network), etc. Furthermore, the communication unit B 2506 may use wireless communication such as wireless LAN, a combination of wireless LANs, etc. Furthermore, the communication unit C 2507 may use wireless communication such as 3G (3rd Generation), WiMAX (registered trademark) (Worldwide Interoperability for Microwave Access), LTE (Long Term Evolution), etc.

However, these wireless communication methods are merely examples; the communication unit A 2505, the communication unit B 2506, and the communication unit C 2507 may use wireless communication of a communication method that is at least partially the same.

By the above configuration, the communication apparatus 102 sorts obstacles reported from the information processing apparatus 101 into a plurality of types of obstacle. Furthermore, the communication apparatus 102 determines the report range of the information of an obstacle based on the type of obstacle into which the obstacle is sorted and sorting information stored in advance, and sends information of an obstacle to the information processing apparatus 101 by using a communication unit corresponding to the report range.

### <Process Flow>

Next, a description is given of a process flow according to the fourth embodiment. Note that the basic processes are the same as those of the third embodiment, and therefore the differences are mainly described herein.

### (Process of Standby Mode of Communication Apparatus)

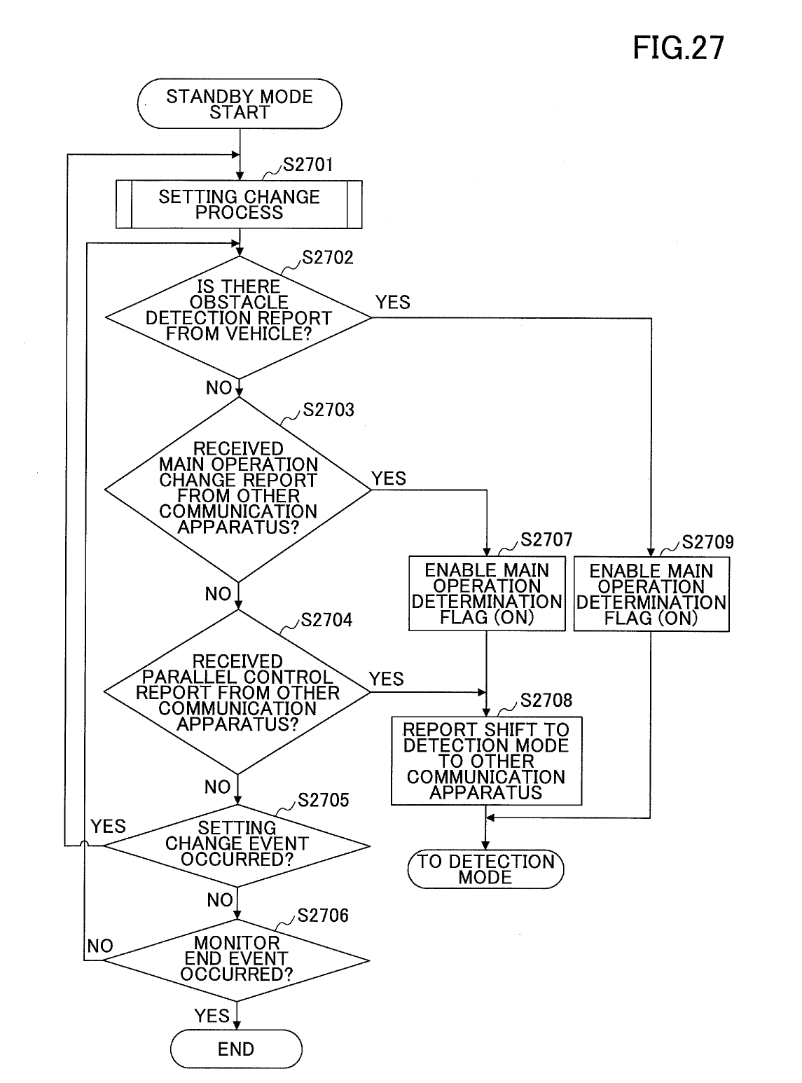

FIG. 27 is a flowchart indicating an example of a process of a standby mode performed by the communication apparatus 102 according to the fourth embodiment.

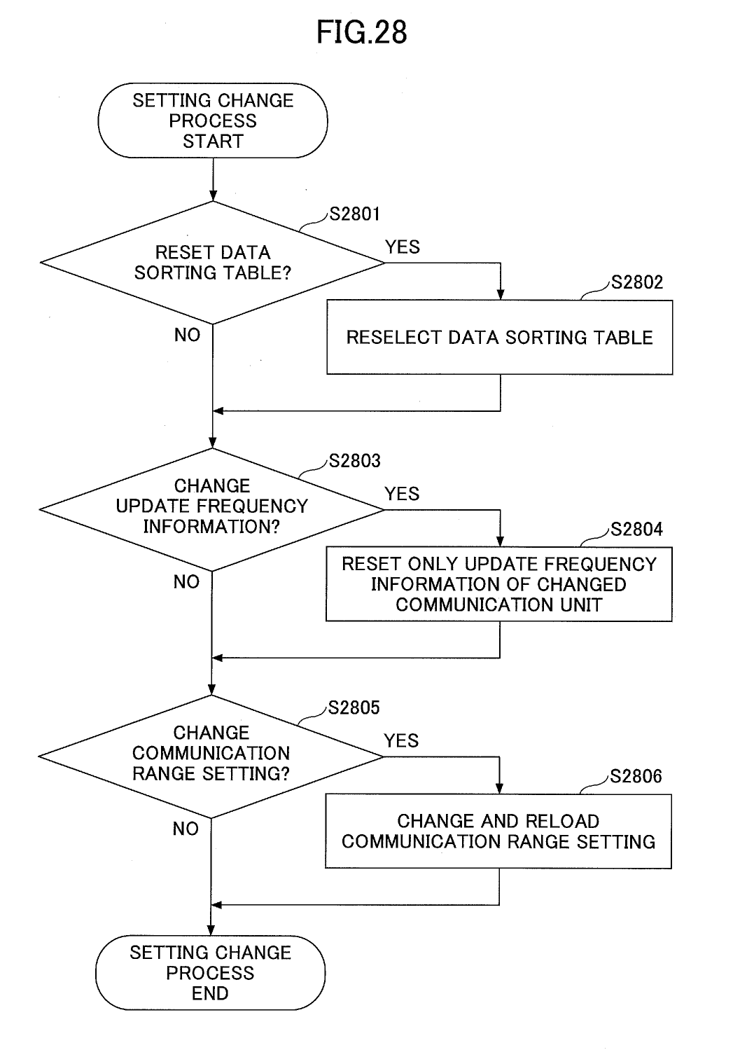

In step S2701, when communication apparatus 102 starts the process of the standby mode, the communication apparatus 102 performs a setting change process of making various initial settings for sending the obstacle data. Note that an example of a setting change process is described with reference to FIG. 28.

When the process shifts to step S2702, the communication apparatus 102 determines whether the information processing apparatus 101 has detected an obstacle, based on whether there is an obstacle detection report received from the information processing apparatus 101 installed in a vehicle, etc., for example. When there is a received obstacle detection report, in step S2709, the communication apparatus 102 enables the main operation determination flag (ON), and shifts the process to the detection mode. On the other hand, when there is no received obstacle detection report, the communication apparatus 102 executes the processes of step S2703 and onward.

When the process shifts to step S2703, the communication apparatus 102 determines whether a main operation change report has been received from another communication apparatus 102. When a main operation change report has been received from another communication apparatus 102, in step S2707, the communication apparatus 102 enables the main operation determination flag (ON). Furthermore, the communication apparatus 102 sends a report indicating that the communication apparatus 102 will shift to the detection mode to the other communication apparatus 102, which has sent the main operation change report, in step S2708, and shifts the process to the detection mode. On the other hand, when a main operation change report has not been received from another communication apparatus 102, the communication apparatus 102 shifts the process to step S2704.

When the process shifts to step S2704, the communication apparatus 102 determines whether a parallel control report has been received from another communication apparatus 102. When a parallel control report has been received from another communication apparatus 102, in step S2708, the communication apparatus 102 sends a report indicating that the communication apparatus 102 will shift to the detection mode to the other communication apparatus 102, which has sent the parallel control report, and shifts the process to the detection mode. On the other hand, when a parallel control report has not been received from another communication apparatus 102, the communication apparatus 102 shifts the process to step S2705.

When the process shifts to step S2705, the communication apparatus 102 determines whether a setting change event has occurred. When a setting change event has occurred in step S2705, the communication apparatus 102 shifts the process to step S2701, and performs a setting change process. When a setting change event has not occurred, the communication apparatus 102 shifts the process to step S2706. Note that a setting change event occurs, for example, when a setting operation by the administrator is received, a predetermined report of requesting the setting change is received, etc.

When the process shifts to step S2706, the communication apparatus 102 determines whether a predetermined monitor end event has occurred. In step S2706, when a monitor end event has not occurred, the communication apparatus 102 returns to step S2702 and repeats the same process. On the other hand, in step S2706, when a monitor end event has occurred, the communication apparatus 102 ends the process of the standby mode. Note that a monitor end event occurs, for example, when a setting operation by the administrator is received, a predetermined report of requesting the setting change is received, etc.

### (Setting Change Process of Communication Apparatus)

FIG. 28 is a flowchart indicating an example of a setting change process performed by the communication apparatus 102 according to the fourth embodiment. The communication apparatus 102 makes various settings for sending the information of an obstacle, by this setting change process.

In step S2801, the communication apparatus 102 determines whether to reset the sorting information (data sorting table), for example, based on whether the user (administrator), etc., has made a predetermined operation, whether a predetermined report is received, etc. When the communication apparatus 102 determines to reset the sorting information, in step S2802, the sorting information management unit 2501 of the communication apparatus 102 changes the setting of the sorting information, for example, based on whether the user (administrator), etc., has made a predetermined operation, whether a predetermined report is received, etc., and shifts to step S2803. For example, the sorting information management unit 2501 may store a plurality of pieces of sorting information in the storage unit 524 in advance, and select the sorting information to be used in step S2802. Alternatively, the sorting information management unit 2501 may store, in the storage unit 524 as sorting information, the information that is received according to a predetermined operation by the user (administrator), etc., a predetermined report, etc.

On the other hand, when the communication apparatus 102 determines not to reset the sorting information, the communication apparatus 102 shifts the process to step S2803.

When the process shifts to step S2803, the report control unit 521 of the communication apparatus 102 determines whether to change the setting of the information sending frequency by the communication unit A through communication unit C, based on whether the user (administrator), etc., has made a predetermined operation, whether a predetermined report is received, etc. When the report control unit 521 determines to change the information sending frequency, in step S2804, the report control unit 521 sets intervals of sending information by the respective communication units, for example, based on whether the user (administrator), etc., has made a predetermined operation, whether a predetermined report is received, etc., and shifts the process to step S2805. When the report control unit 521 determines not to change the information sending frequency in step S2803, the communication apparatus 102 shifts the process to step S2805.

When the process shifts to step S2805, the communication apparatus 102 determines whether to set the communication ranges of the communication unit A through the communication unit C, for example, based on whether the user (administrator), etc., has made a predetermined operation, whether a predetermined report is received, etc. For example, when a specified communication range of the communication unit A is 100 m, it is assumed that the setting of the communication range can be changed within a range of approximately 80 m through 120 m, by adjusting the transmission output, etc. Furthermore, it is assumed that the settings of the communication ranges of the communication unit B and the communication unit C can be changed in a similar manner. When the communication apparatus 102 determines to change the setting of the communication range, in step S2806, the report range determining unit 2504 of the communication apparatus 102 sets a setting value of the communication range for each communication unit, for example, based on whether the user (administrator), etc., has made a predetermined operation, whether a predetermined report is received, etc. Furthermore, each of the communication unit A through the communication unit C reads the setting value that has been newly set, to set (change) the communication range of each communication unit.

### (Process of Detection Mode of Communication Apparatus)

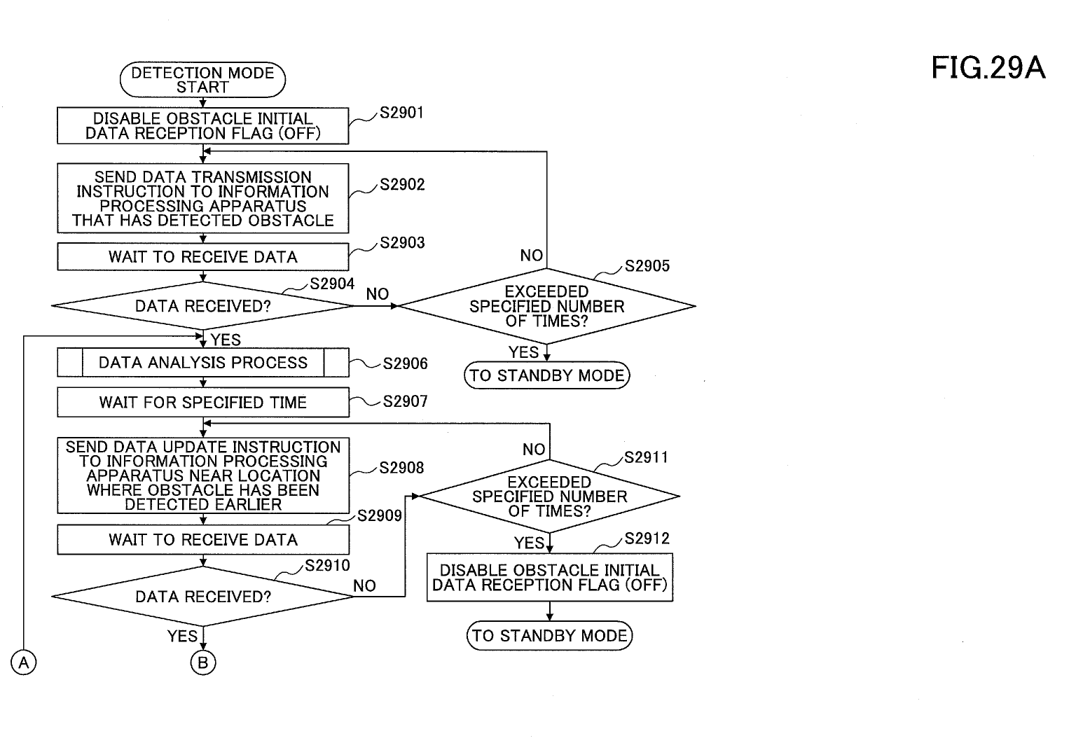

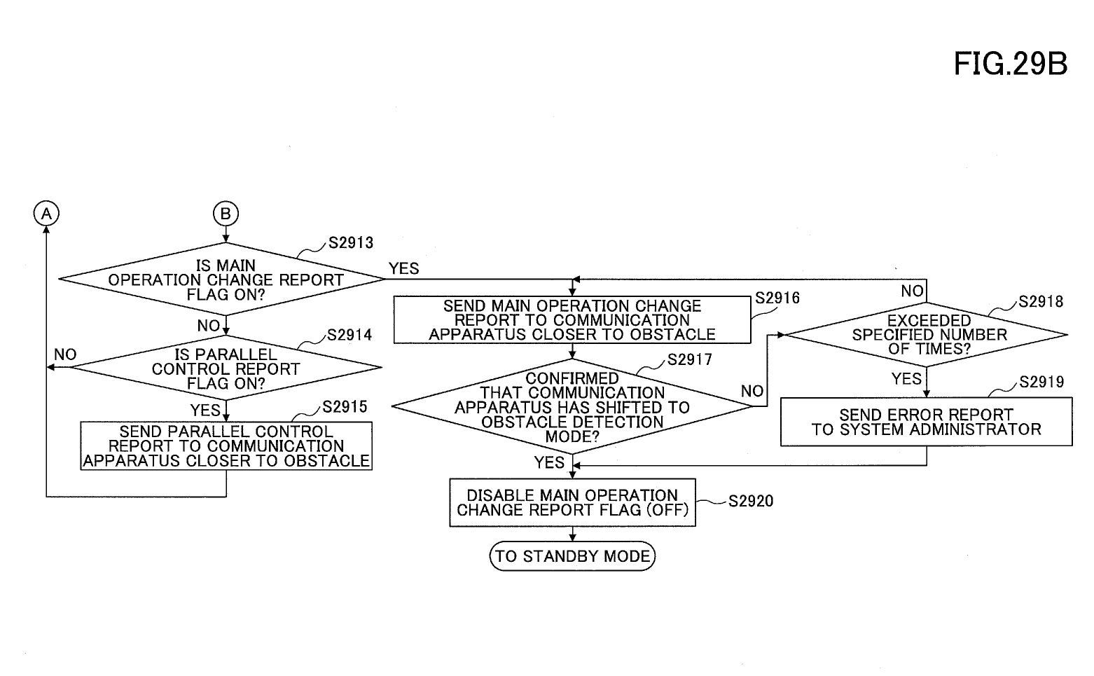

FIGS. 29A and 29B are a flowchart indicating an example of a process of a detection mode performed by the communication apparatus 102 according to the fourth embodiment. By the process of the detection mode indicated in FIGS. 29A and 29B, the communication apparatus 102 acquires the information of an obstacle from the information processing apparatus 101 and analyzes the acquired information, and sends the information of the obstacle to another information processing apparatus.

In step S2901, the communication apparatus 102 disables an obstacle initial data reception flag (OFF) indicating that the received data is the first detection information of an obstacle, and shifts the process to step S2902.

When the process shifts to step S2902, the communication apparatus 102 sends a data transmission instruction to request the transmission of the information of an obstacle, to the information processing apparatus 101 that has detected an obstacle.

In step S2903, the communication apparatus 102 waits for data reception for a predetermined period.

In step S2904, when data cannot be received from the information processing apparatus 101 to which the data transmission instruction has been sent, the communication apparatus 102 repeats to send the data transmission instruction until a specified number of times is exceeded (step S2905). Furthermore, when the number of times of sending the data transmission instruction exceeds the specified number in step S2905, the communication apparatus 102 shifts the process to the standby mode (FIG. 5). On the other hand, when the data is received from the information processing apparatus 101 to which the data transmission instruction has been sent, the communication apparatus 102 executes the processes of step S2906 and onward.

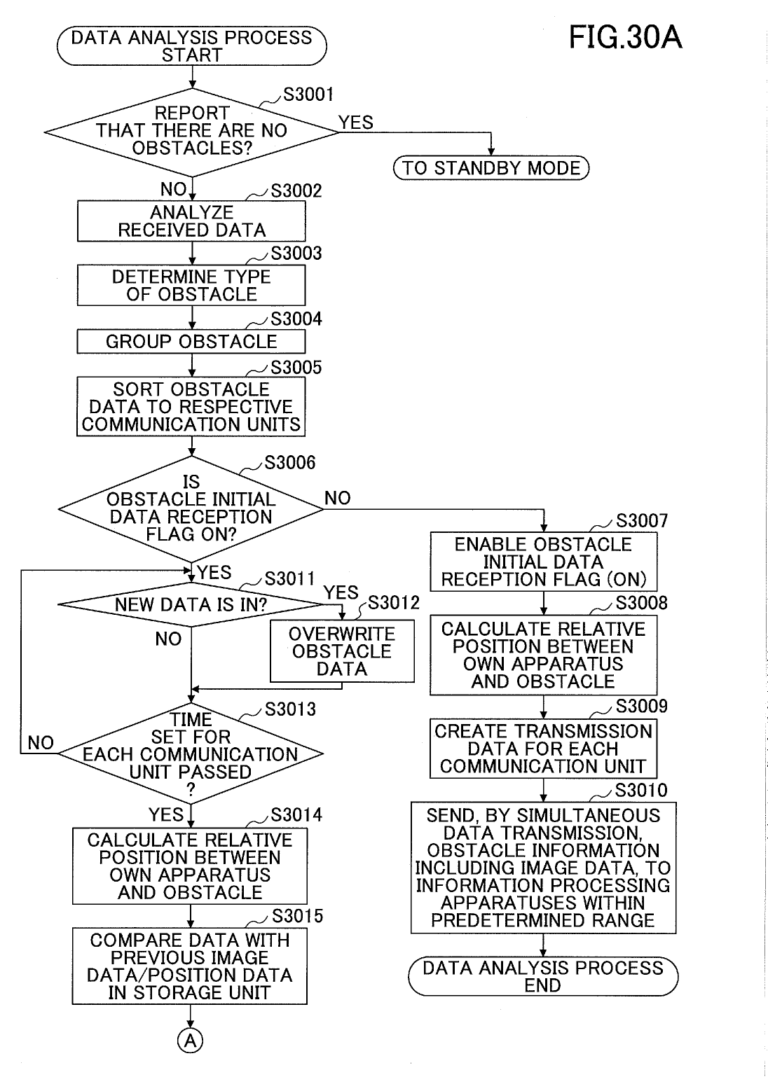

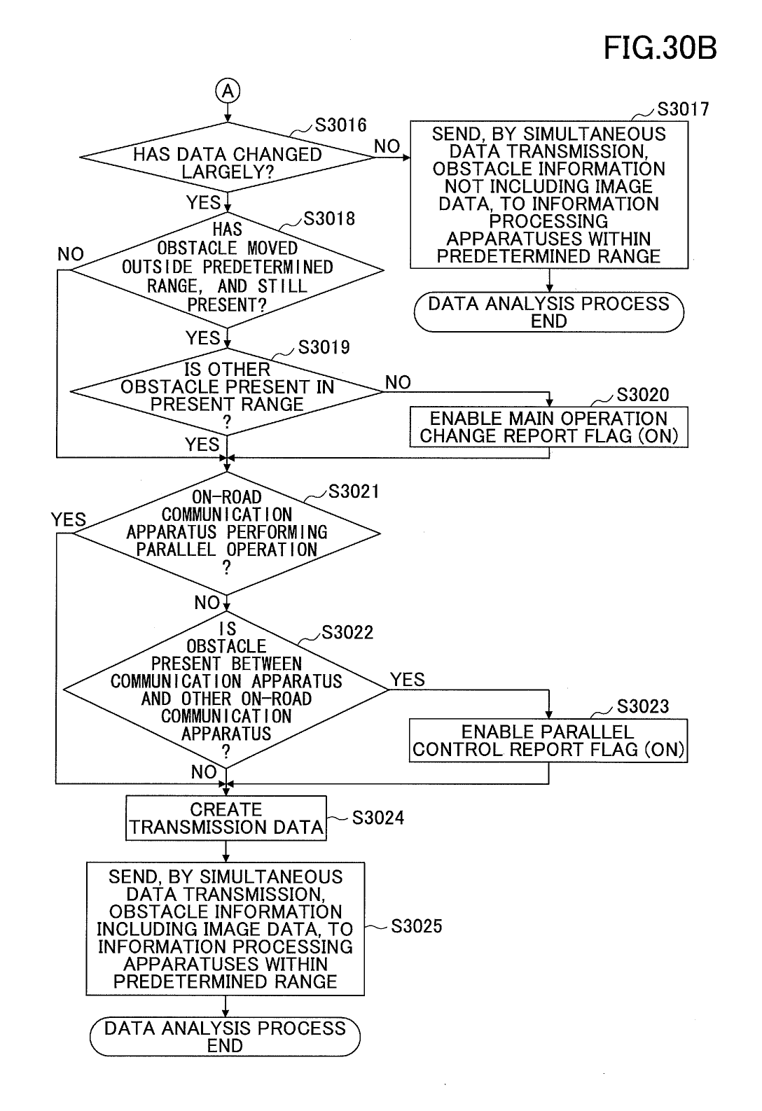

In step S2906, the data analysis unit 2502 of the communication apparatus 102 performs a data analysis process on the received data. Note that the data analysis process is described below with reference to FIGS. 30A and 30B.

After waiting for a specified time in step S2907, in step S2908, the communication apparatus 102 sends a data update instruction to the information processing apparatus 101 near the location where the obstacle has been detected earlier. For example, the communication apparatus 102 may include a plurality of antennas provided along the road 104, and send the data update instruction by using an antenna that has received the obstacle information earlier. Note that the operation of sending a data update instruction to the information processing apparatus 101 near the location where the obstacle has been detected, is one example; the data update instruction may be sent to information processing apparatuses 101 within a predetermined range by broadcast communication.

In step S2909, the communication apparatus 102 waits for data reception for a predetermined period, and in step S2910, when data cannot be received, the communication apparatus 102 repeats to send the data update instruction until a specified number of times is exceeded (step S2911). Furthermore, in step S2911, when the number of times of sending the data update instruction exceeds the specified number, in step S2912, the communication apparatus 102 disables the obstacle initial data reception flag (OFF), and shifts the process to the standby mode (FIG. 5). On the other hand, when the data is received in step S2910, the communication apparatus 102 executes the processes of step S2913 and onward.

In step S2913, when the main operation change report flag is enabled (ON), the communication apparatus 102 executes the processes of step S2916 and onward. On the other hand, when the main operation change report flag is disabled (OFF) in step S2913, the communication apparatus 102 executes the processes of step S2914 and onward.

In step S2914, the communication apparatus 102 determines whether the parallel control report flag is enabled (ON), which indicates whether the communication apparatus 102 is performing a parallel operation. When the parallel control report flag is enabled (ON), the communication apparatus 102 shifts the process to step S2915. On the other hand, when the parallel control report flag is disabled (OFF), the communication apparatus 102 returns the process to step S2906, and performs the same process.

When the process shifts to step S2915, the communication apparatus 102 sends a parallel control report to the communication apparatus 102 that is closer to the obstacle, and returns the process to step S2906, and performs the same process.

Next, a description is given of a process of a case where the main operation change report flag is enabled (ON) in step S2913.

In step S2913, when the main operation change report flag is enabled (ON), in step S2916, the communication apparatus 102 sends a main operation change report to another communication apparatus 102 that is closer to the obstacle.

In step S2917, the communication apparatus 102 confirms that the other communication apparatus 102, to which the main operation change report has been sent, has shifted to the obstacle detection mode. For example, the communication apparatus 102 determines whether (confirms that) the other communication apparatus 102 has shifted to the obstacle detection mode, based on whether a report indicating that the other communication apparatus 102 will shift to the detection mode has been received from the other communication apparatus 102.

When the communication apparatus 102 confirms that the other communication apparatus 102, to which the main operation change report has been sent, has shifted to the obstacle detection mode in step S2917, the communication apparatus 102 disables the main operation change report flag (OFF) in step S2920, and shifts the process to the standby mode. On the other hand, when the communication apparatus 102 cannot confirm that the other communication apparatus 102, to which the main operation change report has been sent, has shifted to the obstacle detection mode in step S2917, in step S2918, the communication apparatus 102 repeats to retry sending the main operation change report until a specified number of times is exceeded. Furthermore, when the number of times of retrying to send the main operation change report exceeds the specified number in step S2918, the communication apparatus 102 sends an error report to the system administrator in step S2919. Furthermore, in step S2920, the communication apparatus 102 disables the main operation change report flag (OFF), and shifts the process to the standby mode.

### (Data Analysis Process of Communication Apparatus)

FIGS. 30A and 30B are a flowchart indicating an example of a data analysis process performed by the communication apparatus 102 according to the fourth embodiment. According to this data analysis process, by analyzing the obstacle data sent from the information processing apparatus 101, the communication apparatus 102 can identify the obstacle type, sort the obstacle data to a communication unit, and send the analysis result to another information processing apparatus 101.

In step S3001, the communication apparatus 102 determines whether there is a report indicating that there are no obstacles. The report indicating that there are no obstacles may be reported from, for example, the information processing apparatus 101, or from another communication apparatus 102. Alternatively, the report indicating that there are no obstacles may be reported from the administrator, a management server, etc. When there is a report indicating that there are no obstacles, the communication apparatus 102 shifts the process to the standby mode (FIG. 5). On the other hand, when there is no report indicating that there are no obstacles, the communication apparatus 102 shifts the process to step S3002.

In step S3002, the communication apparatus 102 analyzes, by the data analysis unit 2502, the data of the obstacle received from the information processing apparatus 101, to analyze the type, the size, etc., of the obstacle. Furthermore, in this step, the communication apparatus 102 may compare the data with the data received previously, determine whether the obstacle moves, and use this determination as an index when sorting the data described below.

In step S3003, the data analysis unit 2502 of the communication apparatus 102 determines what the type of the obstacle is, how large the obstacle is, etc., according to the analysis result of step S3002.

In step S3004, the data sorting unit 2503 of the communication apparatus 102 sorts the obstacle data into one of the groups of obstacle types in the sorting information (FIG. 26) stored in advance, based on the type of obstacle determined in step S3003.

In step S3005, the report range determining unit 2504 of the communication apparatus 102 determines the communication unit for sending the information (data) of the obstacle (sorts the data to the communication unit), based on the type of obstacle sorted in step S3004 and sorting information stored in advance.

In step S3006, the communication apparatus 102 determines whether the obstacle initial data reception flag is enabled (ON), which indicates that the received data is the first detection information of an obstacle. When the obstacle initial data reception flag is enabled (ON) in step S3006, the communication apparatus 102 executes the processes of step S3011 and onward. On the other hand, when the obstacle initial data reception flag is disabled (OFF), the communication apparatus 102 shifts the process to step S3007. Note that the subsequent processes are performed by, for example, the respective communication units.

When the process shifts to step S3007, the communication apparatus 102 enables the obstacle initial data reception flag (from OFF to ON).

In step S3008, the relative position calculating unit 522 of the communication apparatus 102 calculates the relative position between the own apparatus (communication apparatus 102) and the obstacle.

In step S3009, the report unit 520 of the communication apparatus 102 creates transmission data (information of an obstacle) for each communication unit, based on the image data and the relative position data.

In step S3010, each communication unit sends, by simultaneous data transmission, the information of an obstacle including the image data created in step S3009, to the information processing apparatuses 101 within a predetermined range, and ends the data analysis process (shift to step S2907 of FIGS. 29A and 29B).

Next, a description is given of a process of a case where the obstacle initial data reception flag is enabled (ON) in step S3006.

When the process shifts to step S3011, the communication apparatus 102 branches the process according to whether new data has been input from the information processing apparatus 101. When new data has been input from the information processing apparatus 101, the communication apparatus 102 shifts the process to step S3012, overwrites the obstacle data, and then shifts the process to step S3013. On the other hand, when new data has not been input, the communication apparatus 102 does not overwrite the obstacle data, and shifts the process to step S3013.

When the process shifts to step S3013, the communication apparatus 102 determines whether the process waiting time set for each communication unit has passed. The process waiting time is set according to the data update frequency set in each of the communication unit A through the communication unit C. When the process waiting time set for each communication unit has passed, the communication apparatus 102 executes the processes of step S3011 and onward. On the other hand, when the process waiting time set for each communication unit has not passed, the communication apparatus 102 returns to step S3011 and repeats the process. Note that the data update frequency set in each communication unit is one example; the data update frequency may be the update frequency set in the communication apparatus 102.

When the process shifts to step S3014, the relative position calculating unit 522 of the communication apparatus 102 calculates the relative position of the own apparatus (communication apparatus 102) and the obstacle.

In step S3015, the communication apparatus 102 compares the image data of the obstacle with the previous data of the obstacle stored in the storage unit (storage unit 524), and determines whether there is a change in the data of the obstacle that is greater than or equal to a predetermined change amount.

In step S3016, when there is a change in the data of the obstacle that is greater than or equal to a predetermined change amount, the communication apparatus 102 shifts process to step S3018. On the other hand, when there is no change in the data of the obstacle that is greater than or equal to a predetermined change amount, the communication apparatus 102 shifts the process to step S3017. When the process shifts to step S3017, the report unit 520 of the communication apparatus 102 uses each communication unit to simultaneously send the information of the obstacle that does not include the image data to the information processing apparatuses 101, and ends the data analysis process (shifts to step S2907 of FIGS. 29A and 29B).

When the process shifts to step S3018, the communication apparatus 102 determines whether the obstacle has moved outside a predetermined range, and is still present. When the communication apparatus 102 determines that the obstacle has moved outside a predetermined range, and is still present, the communication apparatus 102 shifts the process to step S3019. On the other hand, when the communication apparatus 102 does not determine that the obstacle has moved outside a predetermined range, and is still present, the communication apparatus 102 shifts the process to step S3021.

When the process shifts to step S3019, the communication apparatus 102 determines whether there is an obstacle other than the obstacle that has been recognized up to now, in the present range. When the communication apparatus 102 determines that there is an obstacle other than the obstacle that has been recognized up to now, in the present range, the communication apparatus 102 shifts the process to step S3021. On the other hand, when the communication apparatus 102 determines that there is no obstacle other than the obstacle that has been recognized up to now, in the present range, in step S3020, the communication apparatus 102 enables the main operation change report flag (ON), and shifts the process to step S3021.

When the process shifts to step S3021, the communication apparatus 102 determines whether the communication apparatus 102 is performing parallel operation. When the communication apparatus 102 is performing parallel operation, the communication apparatus 102 shifts the process to step S3024. On the other hand, when the communication apparatus 102 is not performing parallel operation, the communication apparatus 102 shifts the process to step S3022.

When the process shifts to step S3022, the communication apparatus 102 determines whether an obstacle is present between the communication apparatus 102 and another communication apparatus 102. When an obstacle is present between the communication apparatus 102 and another communication apparatus 102, in step S3023, the communication apparatus 102 enables a parallel report flag (ON), and then shifts the process to step S3024. On the other hand, when an obstacle is not present between the communication apparatus 102 and another communication apparatus 102, the communication apparatus 102 does not change the parallel report flag, and then shifts the process to step S3024.

In step S3024, the report unit 520 of the communication apparatus 102 creates transmission data from the image data and the relative position data.

In step S3025, the report unit 520 of the communication apparatus 102 uses each communication unit to simultaneously send the information of an obstacle created in step S3024 to the information processing apparatuses 101 in a predetermined range, and ends the data analysis process (shifts to step S2907 of FIGS. 29A and 29B).

Next, a description is given of an example of a process performed by the information processing apparatus 101 according to the fourth embodiment.

### (Process of Standby Mode of Information Processing Apparatus)

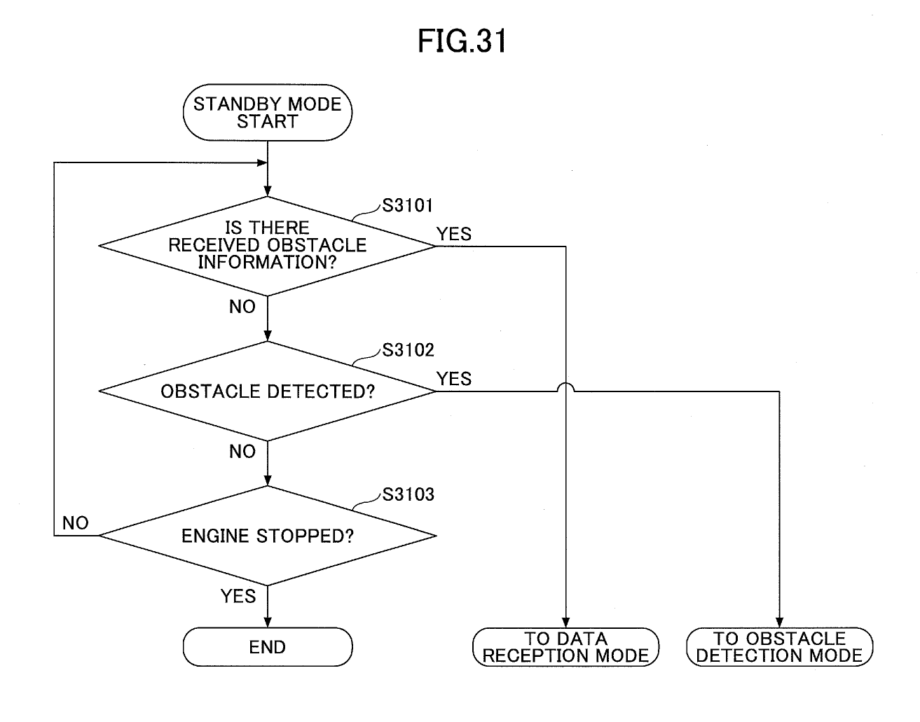

FIG. 31 is a flowchart indicating an example of a process of a standby mode performed by the information processing apparatus 101 according to the fourth embodiment.

In FIG. 31, for example, the information processing apparatus 101 starts a process of a standby mode, according to the startup of the engine of a vehicle, in which the information processing apparatus 101 is installed.

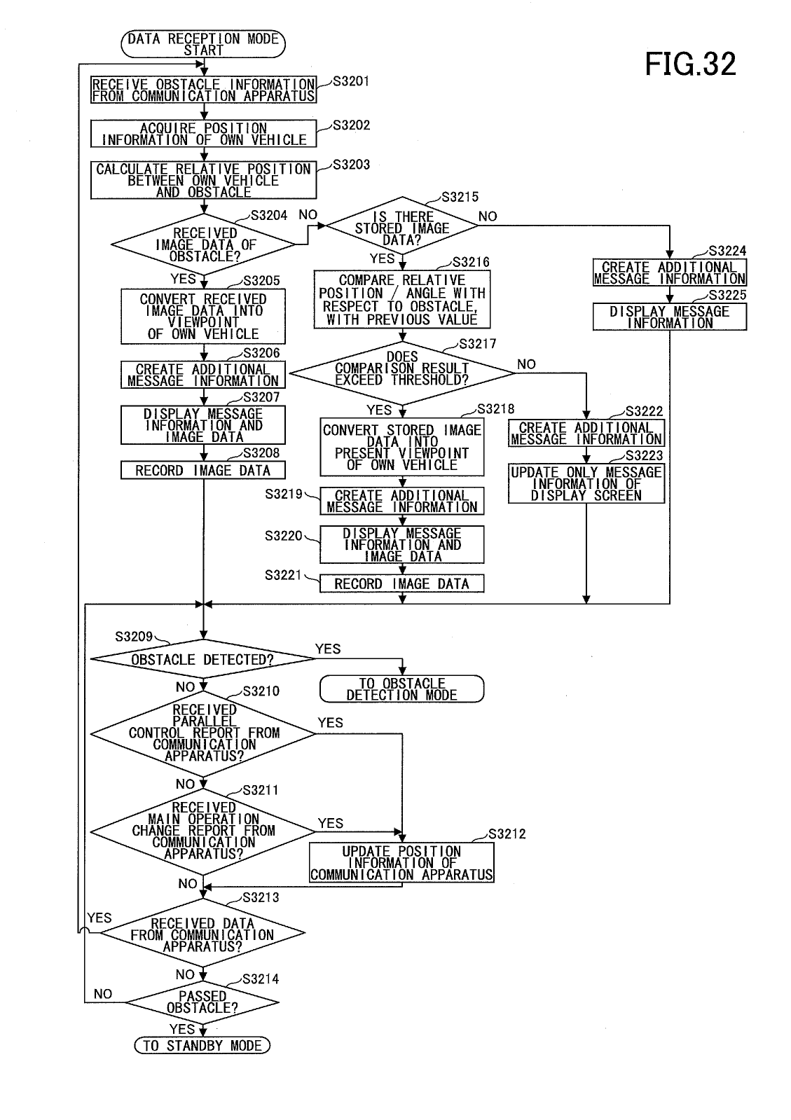

In step S3101, the information processing apparatus 101 determines whether there is obstacle information received from a predetermined external device such as the communication apparatus 102, etc. When there is no received obstacle information, the information processing apparatus 101 shifts the process to step S3102. On the other hand, when there is received obstacle information, the information processing apparatus 101 shifts the process to “data reception mode”. Note that the data reception mode is described below with reference to FIG. 32.

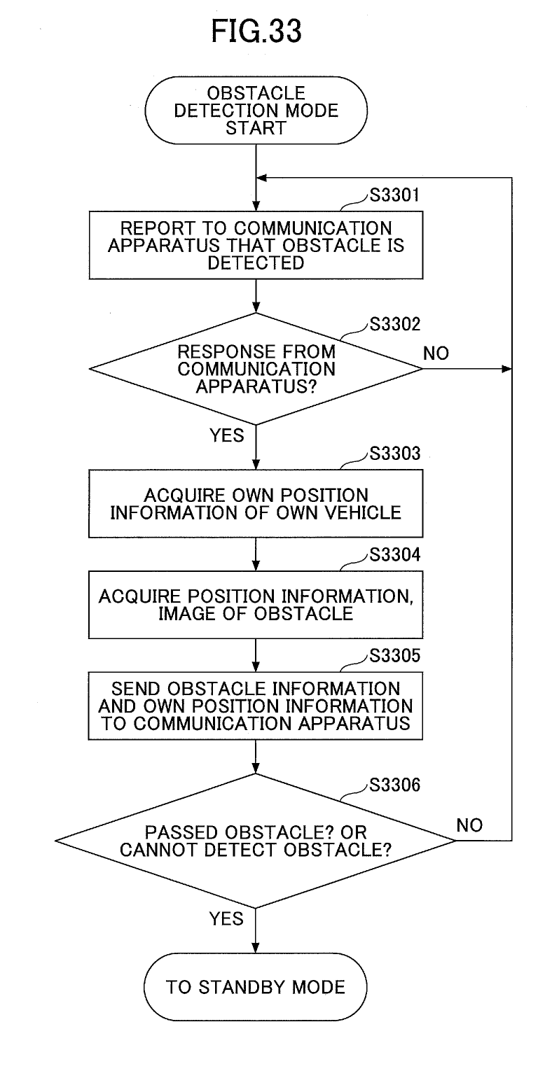

When the process shifts to step S3102, the information processing apparatus 101 determines whether the detection unit 503 has detected an obstacle. When an obstacle is not detected, the information processing apparatus 101 shifts the process to step S3103. On the other hand, when an obstacle is detected, the information processing apparatus 101 shifts the process to “obstacle detection mode”. Note that the obstacle detection mode is described below with reference to FIG. 33.

When the process shifts to step S3103, the information processing apparatus 101 determines whether the engine of the vehicle, in which the information processing apparatus 101 is installed, has stopped. When the engine of the vehicle has not stopped, the information processing apparatus 101 returns to step S3101, and repeats the same process. On the other hand, when the engine of the vehicle has stopped, the information processing apparatus 101 ends the process.

### (Process of Data Reception Mode of Information Processing Apparatus)

FIG. 32 is a flowchart indicating an example of a process of a data reception mode performed by the information processing apparatus 101 according to the fourth embodiment. Note that data reception mode is an example of a process of a case where the information processing apparatus 101 receives a report of information of an obstacle from an external device such as the communication apparatus 102.

In step S3201, the information receiving unit 506 of the information processing apparatus 101 receives obstacle information from the communication apparatus 102, and stores the obstacle information as, for example, the received obstacle information 516 in the storage unit 513.

In step S3202, the position information acquiring unit 515 of the information processing apparatus 101 acquires the position information of the vehicle (hereinafter, “own vehicle”) corresponding to the information processing apparatus 101.

In step S3203, the relative position calculating unit 510 calculates the relative position of the own vehicle with respect to the obstacle, by the position information of the own vehicle acquired by the position information acquiring unit 515 and the received obstacle information 516 stored in the storage unit 513. The relative position of the own vehicle with respect to the obstacle calculated by the relative position calculating unit 510 may be information such as the distance between the own vehicle and the obstacle or the time required to reach the obstacle (predicted value).

In step S3204, when the received obstacle information 516 includes image data of the obstacle, the information processing apparatus 101 shifts the process to step S3205. On the other hand, when the received obstacle information 516 does not include image data of the obstacle, the information processing apparatus 101 shifts the process to step S3215.

When the process shifts to step S3205, the conversion unit 509 of the information processing apparatus 101 creates a display image by converting the image data of the obstacle included in the received obstacle information 516, to the viewpoint of the own vehicle. For example, when the distance to the obstacle is long, the conversion unit 509 reduces the image data of the obstacle, and when the distance to the obstacle is short, the conversion unit 509 decreases the reduction ratio (or does not reduce) of the image data of the obstacle. Preferably, for example, when the angle of the view from the own vehicle to the obstacle is different from that of the image data of the obstacle, such as when the road 104 is curved, the conversion unit 509 converts the image data of the obstacle to the viewpoint of the own vehicle, by performing a rotation process on the image of the obstacle, etc.

In step S3206, the display control unit 508 of the information processing apparatus 101 creates message information to be displayed on the display input unit 507, by using the relative position information calculated in step S3203, etc. The message information created at this time preferably includes, for example, the information of the distance from the own vehicle to the obstacle, and the required time to reach the obstacle.

In step S3207, the display control unit 508 causes the display input unit 507 to display the display image created in step S3205 and the message information created in step S3206.

In step S3208, the information processing apparatus 101 stores the display image displayed in step S3207, as the display image 517 in the storage unit 513.

When the process shifts to step S3209, the information processing apparatus 101 determines whether the detection unit 503 has detected an obstacle. When an obstacle is not detected, the information processing apparatus 101 shifts the process to step S3210. On the other hand, when an obstacle is detected, the information processing apparatus 101 shifts the process to “obstacle detection mode”. Note that the process of the obstacle detection mode is described below with reference to FIG. 33.

In step S3210, the information processing apparatus 101 determines whether a parallel control report reporting that a plurality of communication apparatuses 102 will perform a parallel process, has been received from the communication apparatus 102. This parallel control report includes, for example, information of the communication apparatus 102 to become the main operation apparatus, etc.

In step S3210, when a parallel control report has been received, in step S3212, the information processing apparatus 101 updates the position information of the communication apparatus 102 to become the main operation apparatus, and shifts the process to step S3213. On the other hand, when a parallel control report has not been received in step S3210, the information processing apparatus 101 shifts the process to step S3211.

When the process shifts to step S3211, the information processing apparatus 101 determines whether a main operation change report reporting the change of the main operation apparatus, has been received from the communication apparatus 102. The main operation change report includes, for example, information of the communication apparatus 102 to become the new main operation apparatus, etc.

When the main operation change report has been received in step S3211, in step S3212, the information processing apparatus 101 updates the position information of the communication apparatus 102 to become the new main operation apparatus, and shifts the process to step S3213. On the other hand, when a main operation change report has not been received in step S3211, the information processing apparatus 101 shifts the process to step S3213.

When the process shifts to step S3213, the information processing apparatus 101 determines whether data (obstacle information, etc.) has been received from the communication apparatus 102, etc. When the data has been received, the information processing apparatus 101 returns the process to step S3201, and repeats the same process. On the other hand, when the data has not been received, the information processing apparatus 101 shifts the process to step S3214.

When the process shifts to step S3214, the information processing apparatus 101 determines whether the own vehicle has passed the obstacle, based on, for example, the present position of the own vehicle, the time required to reach the obstacle, etc. When the information processing apparatus 101 determines that the own vehicle has passed the obstacle, the information processing apparatus 101 shifts the process to the standby mode (FIG. 31). On the other hand, when the information processing apparatus 101 determines that the own vehicle has not passed the obstacle, the information processing apparatus 101 returns the process to step S3209 and repeats the same process.

The above describes a process where the received obstacle information 516 includes image data of the obstacle in step S3204; next, a description is given of a process where the received obstacle information 516 does not include image data of the obstacle.

In step S3204, when the received obstacle information 516 does not include image data of the obstacle, the process shifts to step S3215, and the information processing apparatus 101 determines whether the storage unit 513 includes the display image 517 stored in step S3208.

In step S3215, when the storage unit 513 does not include the stored display image 517, the display control unit 508 of the information processing apparatus 101 creates message information (step S3224), and causes the display input unit 507 to display the created message information (step S3225). On the other hand, when the storage unit 513 includes the stored display image 517, the information processing apparatus 101 executes the processes of step S3216 and onward.

When the process shifts to step S3216, the information processing apparatus 101 compares the relative position of the own vehicle with respect to the obstacle, with the previous value.

In step S3217, the information processing apparatus 101 determines whether the comparison result of the relative position of the own vehicle with respect to the obstacle exceeds a predetermined threshold. When the comparison result does not exceed the predetermined threshold, the display control unit 508 of the information processing apparatus 101 creates message information (step S3222), and updates only the created message information without updating the image (step S3223). On the other hand, when the comparison result exceeds the predetermined threshold, the information processing apparatus 101 executes the processes of step S3218 and onward.

In step S3218, the conversion unit 509 of the information processing apparatus 101 creates a display image, by converting the image data of the obstacle stored in the storage unit 513, to the viewpoint of the own vehicle.

In step S3219, the display control unit 508 of the information processing apparatus 101 creates message information to be displayed by the display input unit 507.

In step S3220, the display control unit 508 causes the display input unit 507 to display the display image created in step S3218 and the message information created in step S3219.

In step S3221, the information processing apparatus 101 stores the display image displayed in step S3220, as the display image 517 in the storage unit 513, and shifts the process to step S3209.

By the above process, when a plurality of communication apparatuses 102 start a parallel operation, or when the main operation apparatus has been changed, the information processing apparatus 101 can perform a predetermined process with respect to the communication apparatus 102 to become the new main operation apparatus.

### (Process of Detection Mode of Information Processing Apparatus)

FIG. 33 is a flowchart indicating an example of a process of a detection mode performed by the information processing apparatus according to the fourth embodiment. Note that obstacle detection mode (detection mode) is an example of a process when the information processing apparatus 101 detects an obstacle.

In step S3301, the information sending unit 505 of the information processing apparatus 101 reports to the communication apparatus 102 that the detection unit 503 has detected an obstacle.

In step S3302, the information processing apparatus 101 determines whether there is a response from the communication apparatus 102. When there is no response from the communication apparatus 102, the information processing apparatus 101 returns to step S3301 and the same process is repeated. On the other hand, when there is a response from the communication apparatus 102, the information processing apparatus 101 shifts the process to step S3303.

When the process shifts to step S3303, the acquiring unit 504 of the information processing apparatus 101 acquires position information indicating the position, the movement direction, etc., of the own vehicle, by the position information acquiring unit 515.

In step S3304, the acquiring unit 504 of the information processing apparatus 101 acquires information relevant to the position of the obstacle detected by the detection unit 503. For example, the acquiring unit 504 acquires distance information indicating the distance between the own vehicle and the obstacle acquired by the distance information acquiring unit 514, an image of the obstacle obtained by the monitor unit 502, etc.

In step S3305, the information sending unit 505 of the information processing apparatus 101 sends, to the communication apparatus 102, the obstacle information including information relevant to the position of the obstacle and image data acquired by the acquiring unit 504.

In step S3306, for example, the information processing apparatus 101 determines whether the detection unit 503 cannot detect obstacles any more. Alternatively, for example, the information processing apparatus 101 may determine whether the own vehicle has passed the obstacle, based on the distance information, etc., indicating the distance between the own vehicle and the obstacle calculated by the relative position calculating unit 510. When the own vehicle has passed the obstacle, or when the obstacle cannot be detected anymore, the information processing apparatus 101 shifts the process to the standby mode (FIG. 31). On the other hand, when the own vehicle has not passed the obstacle, or when the obstacle can be detected, the information processing apparatus 101 returns to step S3301 and repeats the same process.

As described above, the information processing apparatus 101 detects the obstacle 103 around the vehicle by using the monitor unit 502 for monitoring the surroundings of the vehicle. Furthermore, the information processing apparatus 101 acquires the information relevant to the position of the detected obstacle 103 and the image data of the obstacle 103, and sends, to the communication apparatus 102, the obstacle information including the acquired information relevant to the position of the obstacle 103 and the image data of the obstacle 103.

Furthermore, when the information processing apparatus 101 receives information relevant to the position of the obstacle from the communication apparatus 102, the information processing apparatus 101 causes the display input unit 507 to display the information relevant to the obstacle, based on the received obstacle information.

As described above, according to the present embodiment, the communication apparatus 102 can use a plurality of communication units having different communication ranges, to provide the information processing apparatus 101 with information according to the obstacle 103 and the information processing apparatus 101.

### Fifth Embodiment

In the fourth embodiment, for example, in the case of a system configuration as illustrated in FIG. 23A, the information processing apparatus 101-2 that is near the communication apparatus 102 will receive information of an obstacle for middle distance and information of an obstacle for long distance, in addition to the information of an obstacle for short distance. Furthermore, also in the case of a system configuration as illustrated in FIG. 23B, for example, in an area where the first communication range of the communication apparatus 102-1 and the second communication range of the communication apparatus 102-2 overlap each other, the communication apparatus 102 will receive information of an obstacle for middle distance in addition to the information of an obstacle for short distance.

Accordingly, the important information received by the communication apparatus 102 may be buried in information that is not necessarily important, and the communication apparatus 102 may have to process the information that is not necessarily important.

In the fifth embodiment, a description is given of a method of solving the above problems. Furthermore, a description is given of a method of automatically selecting (changing) the sorting information according to the surrounding status, etc.

### <Functional Configuration>

### (Functional Configuration of Communication Apparatus)

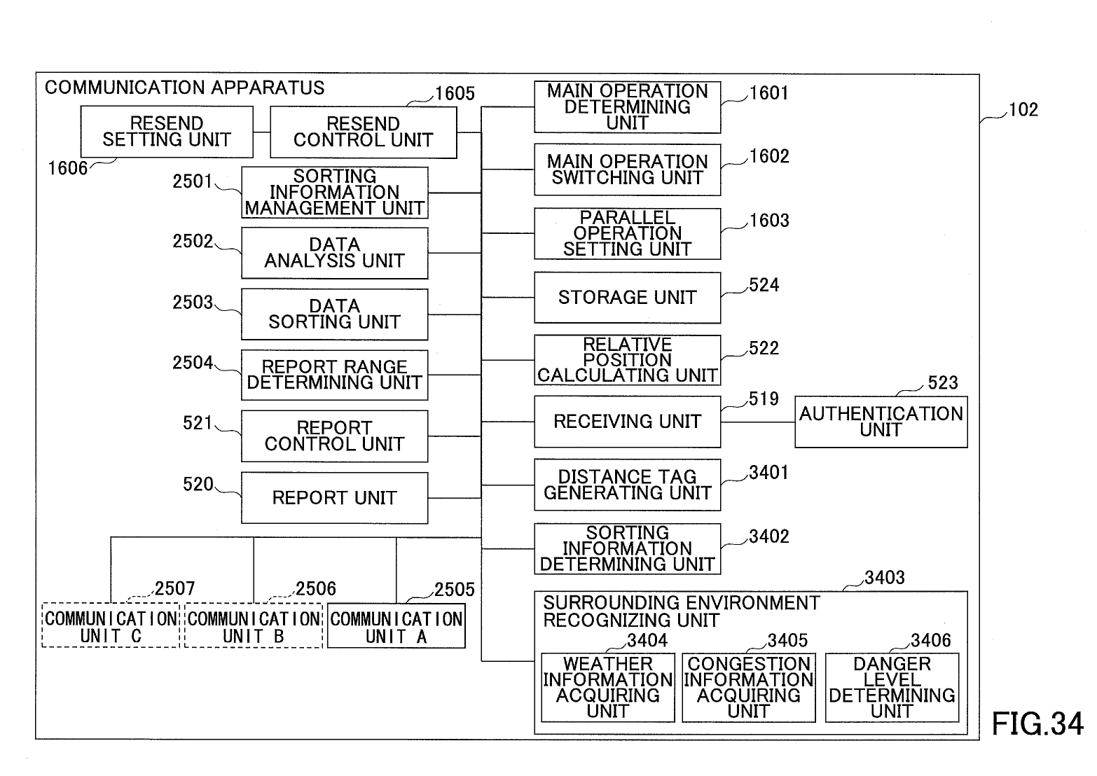

FIG. 34 illustrates a functional configuration of the communication apparatus 102 according to the fifth embodiment. In FIG. 34, the communication apparatus 102 according to the present embodiment includes a distance tag generating unit 3401, a sorting information determining unit 3402, and a surrounding environment recognizing unit 3403, in addition to the configurations of the communication apparatus 102 according to the fourth embodiment illustrated in FIG. 25. Note that the distance tag generating unit 3401, the sorting information determining unit 3402, and the surrounding environment recognizing unit 3403 are realized by, for example, programs operating in the CPU 401.

The distance tag generating unit 3401 is a unit for generating a distance tag, which indicates that the information is, for example, information for a “short distance”, information for a “middle distance”, information for a “long distance”, etc., among the report ranges illustrated in FIG. 26. As described above, the information processing apparatus 101 may simultaneously receive a plurality of pieces of information from a plurality of communication units (the communication unit A through the communication unit C). Therefore, the communication apparatus 102 according to the present embodiment includes a distance tag in the information of an obstacle reported to the information processing apparatus 101, and sends the information of an obstacle including the distance tag. Accordingly, the information processing apparatus 101 can selectively acquire the information of an obstacle that is necessary at the present position of the own apparatus.

The sorting information determining unit 3402 determines the sorting information to be used, from the plurality of pieces of sorting information stored in the storage unit 524 in advance, based on the danger level calculated according to the information acquired by the surrounding environment recognizing unit 3403.

The surrounding environment recognizing unit 3403 is a unit for recognizing, for example, the weather, the road congestion status, the road freezing information according to the weather, etc. For example, the surrounding environment recognizing unit 3403 includes a weather information acquiring unit 3404 for acquiring weather information, a congestion information acquiring unit 3405 for acquiring the congestion information of the road, etc. Furthermore, the surrounding environment recognizing unit 3403 includes a danger level determining unit 3406 for calculating the danger level of the present surrounding environment based on these information items. Note that the sorting information determining unit 3402 may include a function for making a setting as to whether the sorting information is to be manually set or automatically set.

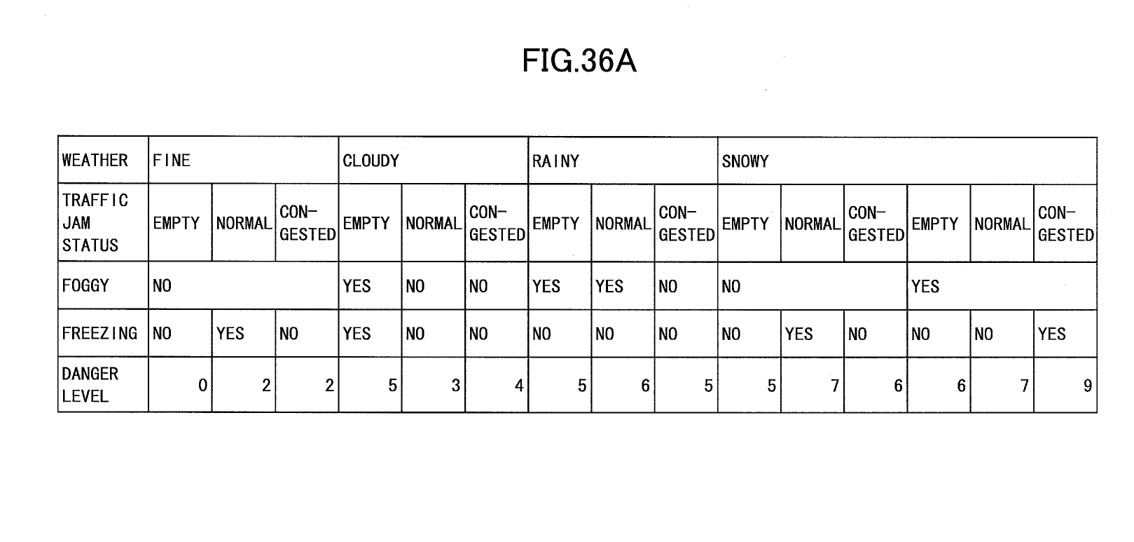

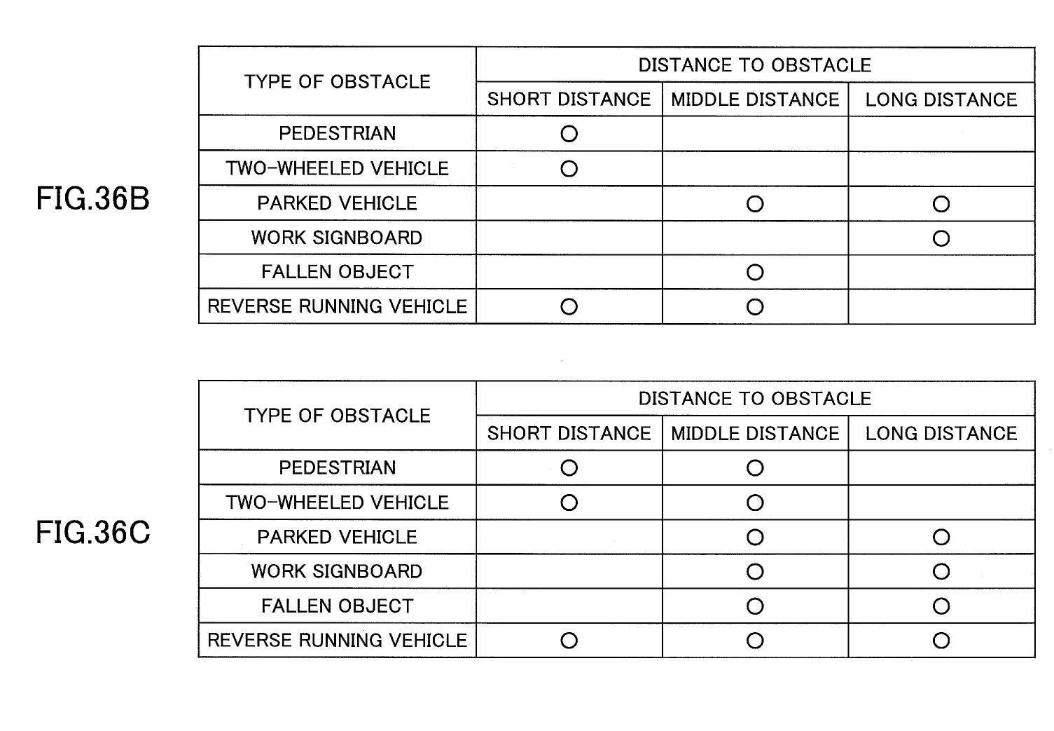

FIGS. 36A through 36C indicate examples of the sorting information according to the fifth embodiment.

It is assumed that the communication apparatus 102 stores, for example, sorting information of danger levels as illustrated in FIG. 36A, in the storage unit 524 in advance. The danger level determining unit 3406 uses this sorting information of danger levels to determine the danger level, for example, based on the weather information acquired by the weather information acquiring unit 3404 and the congestion information acquired by the congestion information acquiring unit 3405. In the example of FIG. 36A, as the value of the danger level increases, a higher danger level is indicated.

For example, in the sorting information of danger levels indicated in FIG. 36A, when the weather is “fine”, the traffic jam status is “empty”, foggy is “no”, and freezing is “no”, the danger level is determined to be “0”, and it can be determined that the danger level is low. Similarly, when the weather is “snowy”, the traffic jam status is “congested”, foggy is “yes”, and freezing is “yes”, the danger level is determined to be “9”, and it can be determined that the danger level is high.

Furthermore, it is assumed that the communication apparatus 102 stores sorting information of a plurality of communication ranges according to the danger level as illustrated in FIGS. 36B and 36C, in the storage unit 524 in advance. FIG. 36B indicates the sorting information of the communication ranges in a case where the danger level is “2”, and FIG. 36C indicates the sorting information of the communication ranges in a case where the danger level is “7”. In the examples of FIGS. 36B and 36C, as the danger level increases, the information of an obstacle is set to be reported to a wider range.

For example, when the danger level is “2”, the pedestrian information is sent only from the communication unit for a short distance; however, when the danger level is “7”, the transmission range is increased, and the pedestrian information is sent from the communication unit for a short distance and the communication unit for a middle distance. It is assumed that the communication apparatus 102 stores sorting information of communication ranges corresponding to all danger levels, in the storage unit 524 in advance.

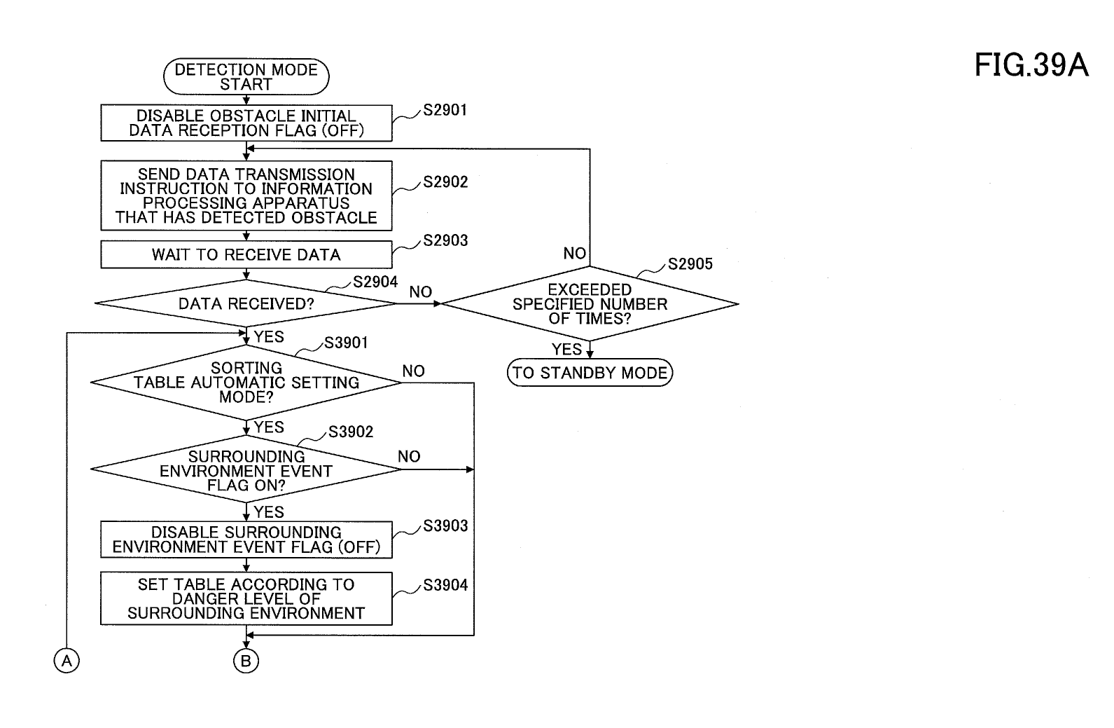

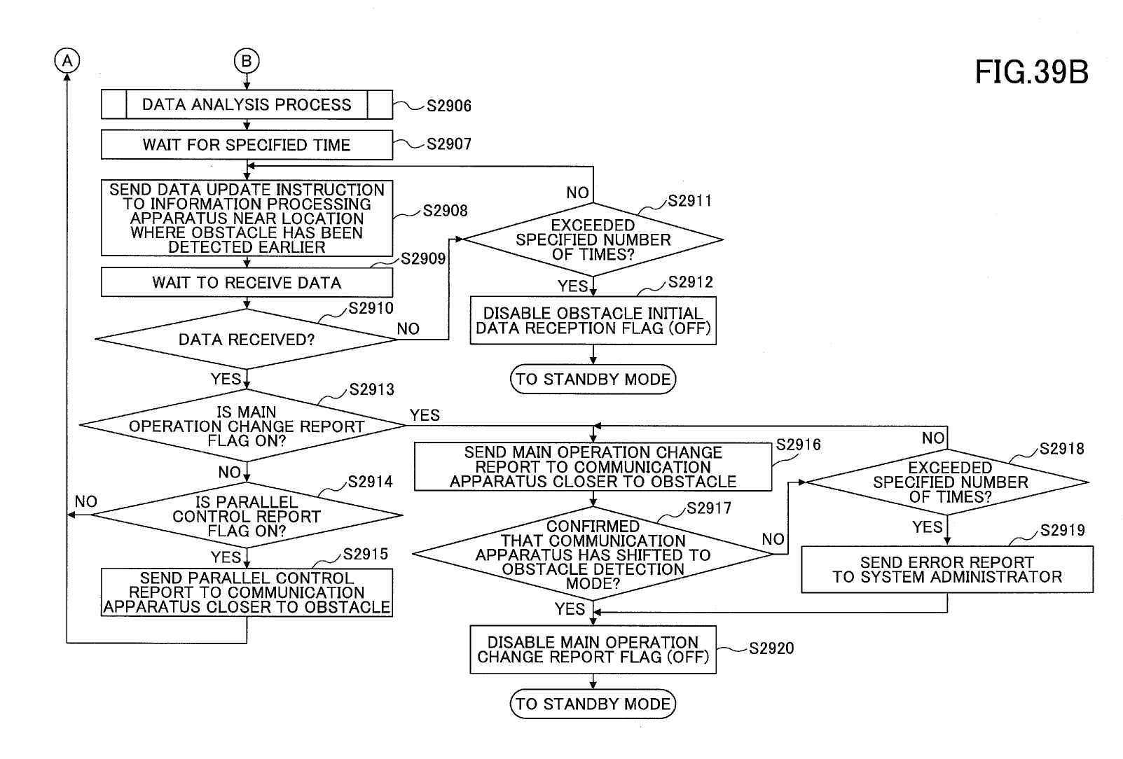

Note that the sorting information indicated in FIGS. 36A through 36C are merely examples. For example, the sorting information of danger levels may be for determining the danger level using information of the surrounding environment other than the weather information or the congestion information. Furthermore, the sorting information of communication ranges may have different settings from those of FIGS. 39B and 36C.

### (Functional Configuration of Information Processing Apparatus)

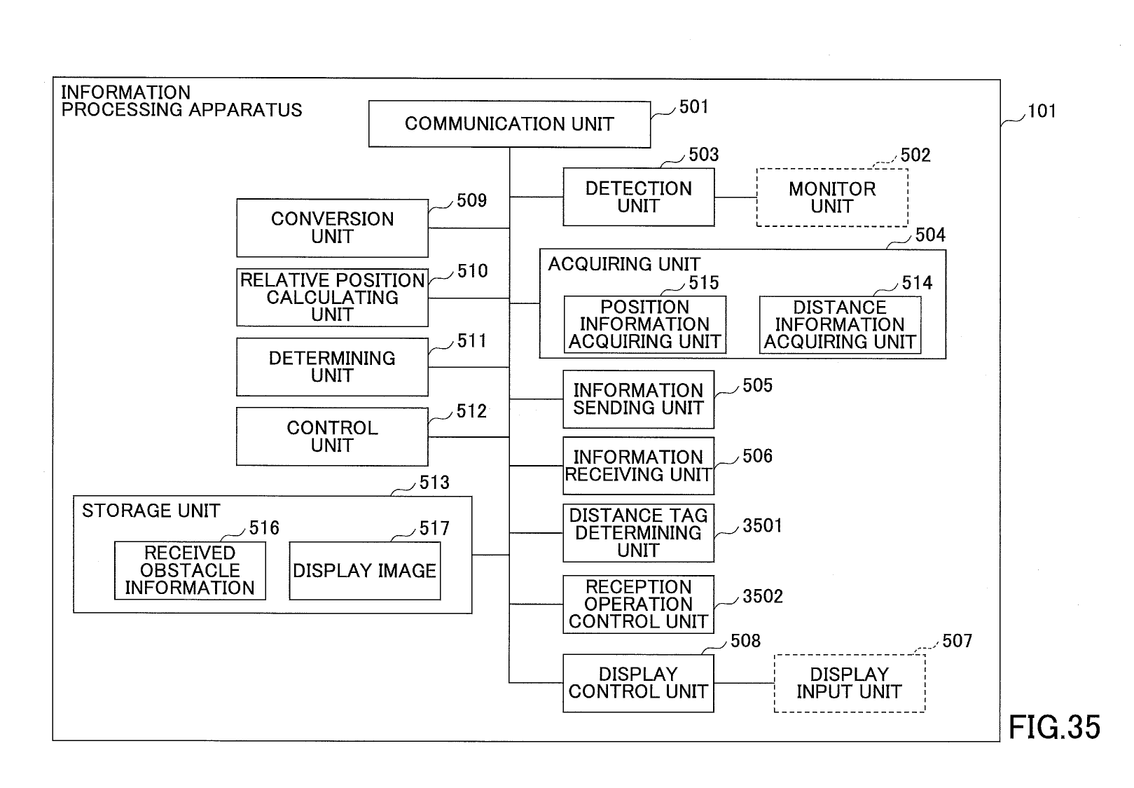

FIG. 35 illustrates a functional configuration of the information processing apparatus 101 according to the fifth embodiment. The information processing apparatus 101 according to the present embodiment includes a distance tag determining unit 3501 and a reception operation control unit 3502, in addition to the configurations of the information processing apparatus 101 according to the first embodiment illustrated in FIG. 5. Note that the distance tag determining unit 3501 and the reception operation control unit 3502 are realized by, for example, programs operating in the CPU 301.

The distance tag determining unit 3501 compares the information of the distance tang included in the information of an obstacle received from the communication apparatus 102, with the present position information of the information processing apparatus 101, and determines a valid distance tag.

The reception operation control unit 3502 receives information of an obstacle including a distance tag determined as valid by the distance tag determining unit 3501, and discards unnecessary information, for example,

By the above configuration, the information processing apparatus 101 can selectively acquire necessary information based on the distance tag, when a plurality of pieces of information of obstacles are received from the communication apparatus 102.

### <Process Flow>

The process of the standby mode performed by the communication apparatus 102 according to the present embodiment may be the same as the process according to the fourth embodiment illustrated in FIG. 27. Furthermore, the data analysis process performed by the communication apparatus 102 according to the present embodiment may be the same as the process according to the fourth embodiment illustrated in FIGS. 30A and 30B.

### (Process of Monitoring Surrounding Environment of Communication Apparatus)

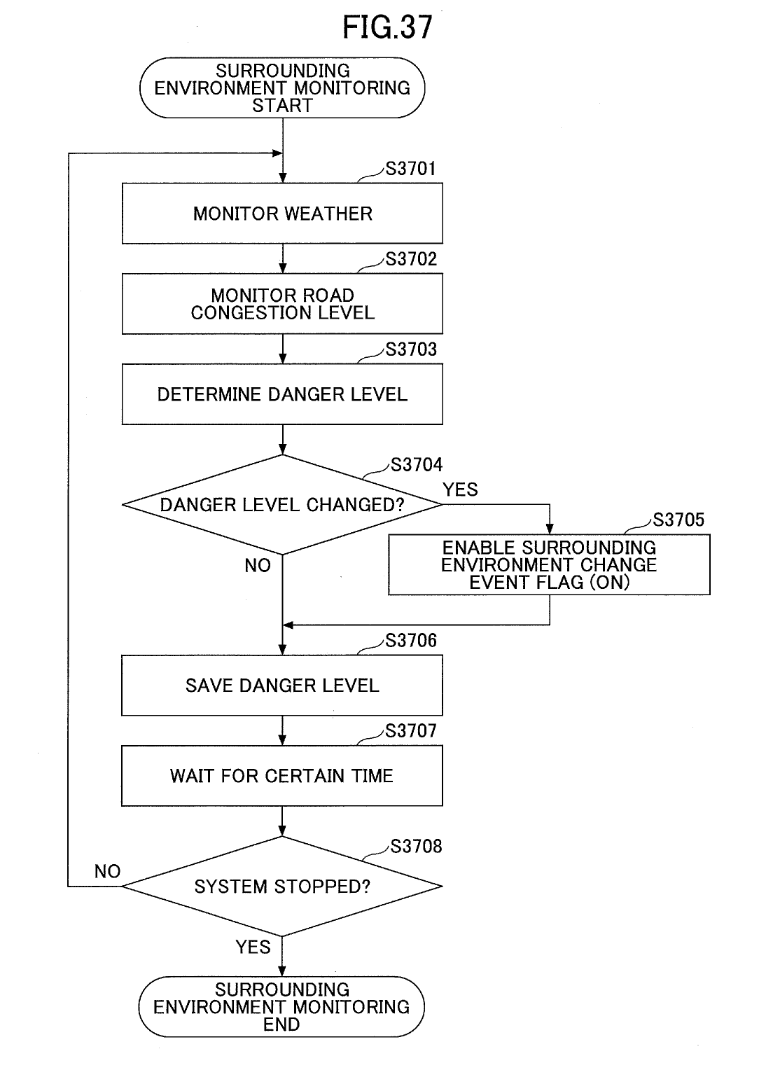

FIG. 37 is a flowchart indicating an example of a process of monitoring the surrounding environment performed by the communication apparatus 102 according to the fifth embodiment. For example, when the system power of the communication apparatus 102 is turned on, the surrounding environment recognizing unit 3403 of the communication apparatus 102 starts the process of monitoring the surrounding environment.

In step S3701, the weather information acquiring unit 3404 of the surrounding environment recognizing unit 3403 monitors the present weather, and acquires weather information. Note that the method of acquiring the weather information may be, for example, a method of acquiring information from an information providing server in the network, etc., or a method of detecting information of the temperature, the humidity, the rainfall level, etc., by the weather information acquiring unit 3404, and autonomously determining the weather, etc.

In step S3702, the congestion information acquiring unit 3405 of the surrounding environment recognizing unit 3403 monitors the congestion level of the road, and acquires congestion information. Note that the method of acquiring the congestion information may be, for example, a method of acquiring information from an information providing server in the network, etc., or a method of autonomously determining the congestion level by the congestion information acquiring unit 3405 based on a captured image of the road, etc. Alternatively, the congestion information acquiring unit 3405 may acquire congestion information from the information processing apparatus 101 (a car navigation device, etc.).

In step S3703, the danger level determining unit 3406 of the surrounding environment recognizing unit 3403 determines the danger level by checking the information status of the above surrounding environment against sorting information of danger levels as illustrated in FIG. 36A.

In step S3704, the surrounding environment recognizing unit 3403 determines whether the danger level determined in step S3703 has changed from the danger level determined previously. When the danger level has changed, in step S3705, the surrounding environment recognizing unit 3403 enables the surrounding environment change event flag (ON), and shifts the process to step S3706. On the other hand, when the danger level has not changed, the surrounding environment recognizing unit 3403 does not change the surrounding environment change event flag, and shifts the process to step S3706.

When the process shifts to step S3706, the surrounding environment recognizing unit 3403 saves the present danger level in, for example, the storage unit 524, etc.

In step S3707, the surrounding environment recognizing unit 3403 waits until a certain time passes.

In step S3708, the surrounding environment recognizing unit 3403 determines whether the system (communication apparatus 102, etc.) is stopped. When the system is not stopped, the surrounding environment recognizing unit 3403 returns the process to step S3701, and repeats the same process. On the other hand, when the system is stopped, the surrounding environment recognizing unit 3403 ends the process of monitoring the surrounding environment.

### (Setting Change Process of Communication Apparatus)

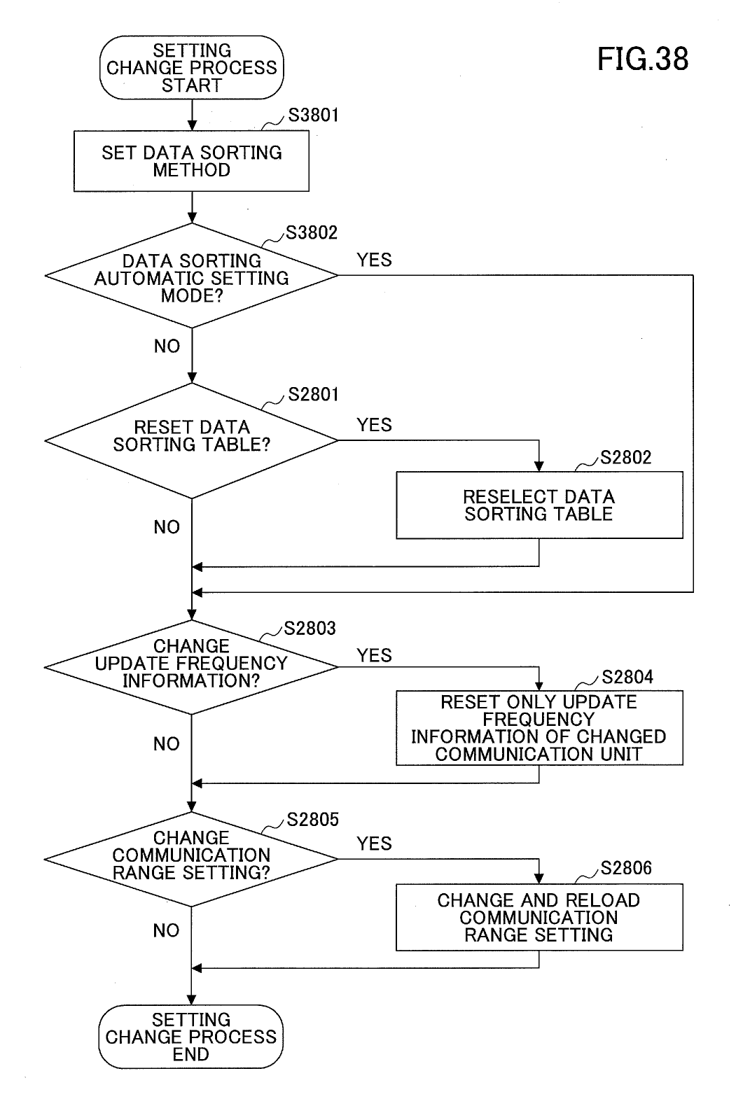

FIG. 38 is a flowchart indicating an example of a setting change process performed by the communication apparatus 102 according to the fifth embodiment. Note that the processes of steps S2801 through S2806 of FIG. 38 are the same as those of the setting change process according to the fourth embodiment illustrated in FIG. 28, and therefore the differences are mainly described herein.

In step S3801, the sorting information determining unit 3402 of the communication apparatus 102 determines whether to set the sorting information manually or automatically, according to, for example, a predetermined operation by the user (administrator), a predetermined report, or setting information set in advance, etc.

In step S3802, when the determined setting of the sorting information is not an automatic setting mode, the communication apparatus 102 shifts the process to step S2801, and has the sorting information set manually, similar to the fourth embodiment. On the other hand, when the determined setting is an automatic setting mode, the communication apparatus 102 shifts the process to step S2803 (in this case, the setting of the sorting information is not performed).

### (Process of Detection Mode of Communication Apparatus)

FIGS. 39A and 39B are a flowchart indicating an example of a process of a detection mode performed by the communication apparatus 102 according to the fifth embodiment. Note that the processes of steps S2901 and S2902 of FIGS. 39A and 39B are the same as those of the process of the detection mode according to the fourth embodiment illustrated in FIGS. 29A and 29B, and therefore the differences are mainly described herein.

In step S2904, when the communication apparatus 102 receives data, the communication apparatus 102 executes the processes of step S3901 and onward.

In step S3901, the communication apparatus 102 determines whether the setting of the sorting information (sorting table) is an automatic setting mode. When the determined setting of the sorting information is not an automatic setting mode, the communication apparatus 102 shifts the process to step S2906. On the other hand, when the determined setting of the sorting information is an automatic setting mode, the communication apparatus 102 shifts the process to step S3902.

When the process shifts to step S3902, the communication apparatus 102 determines whether the surrounding environment event flag is enabled (ON). When the surrounding environment event flag is disabled (OFF), the communication apparatus 102 shifts the process to step S2906. On the other hand, when the surrounding environment event flag is enabled (ON), the communication apparatus 102 shifts the process to step S3903. Note that the surrounding environment event flag is assumed to be enabled (set as ON) when there is a change in the surrounding environment of the communication apparatus 102.

When the process shifts to step S3903, the communication apparatus 102 disables the surrounding environment event flag (from ON to OFF), and shifts the process to step S3904.

When the process shifts to step S3904, the sorting information determining unit 3402 of the communication apparatus 102 sets the sorting information according to the danger level determined by the surrounding environment recognizing unit 3403.

By the above process, when there is a change in the surrounding environment, the sorting information according to the change in the surrounding environment is automatically set.

### (Process of Data Reception Mode of Information Processing Apparatus)

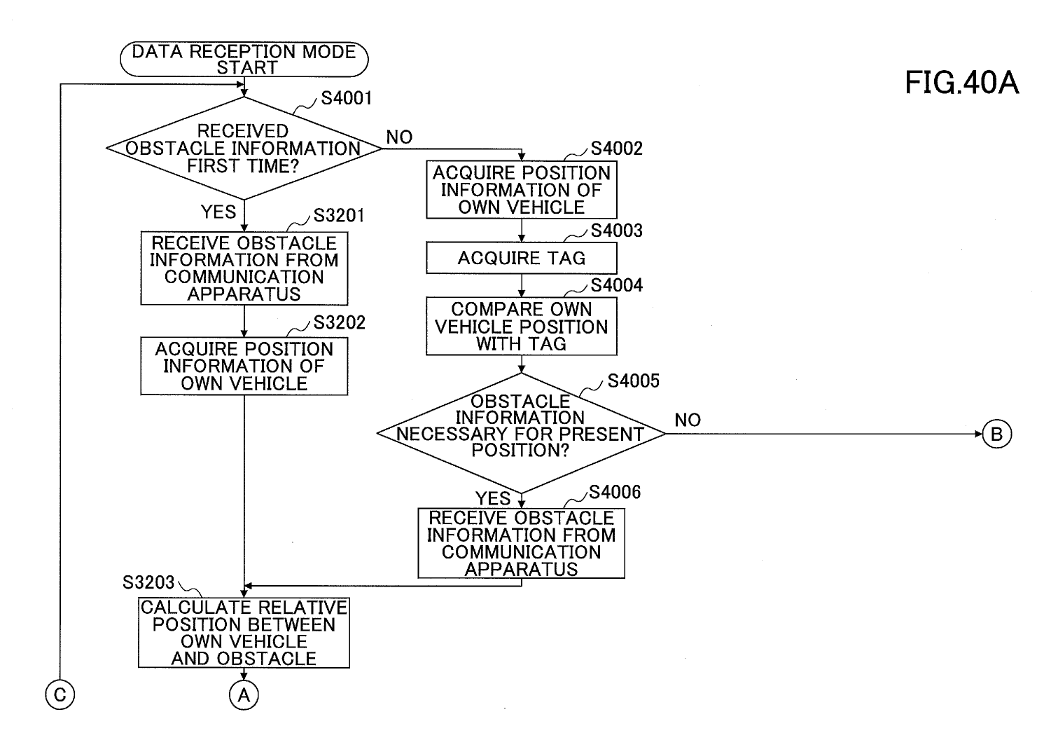

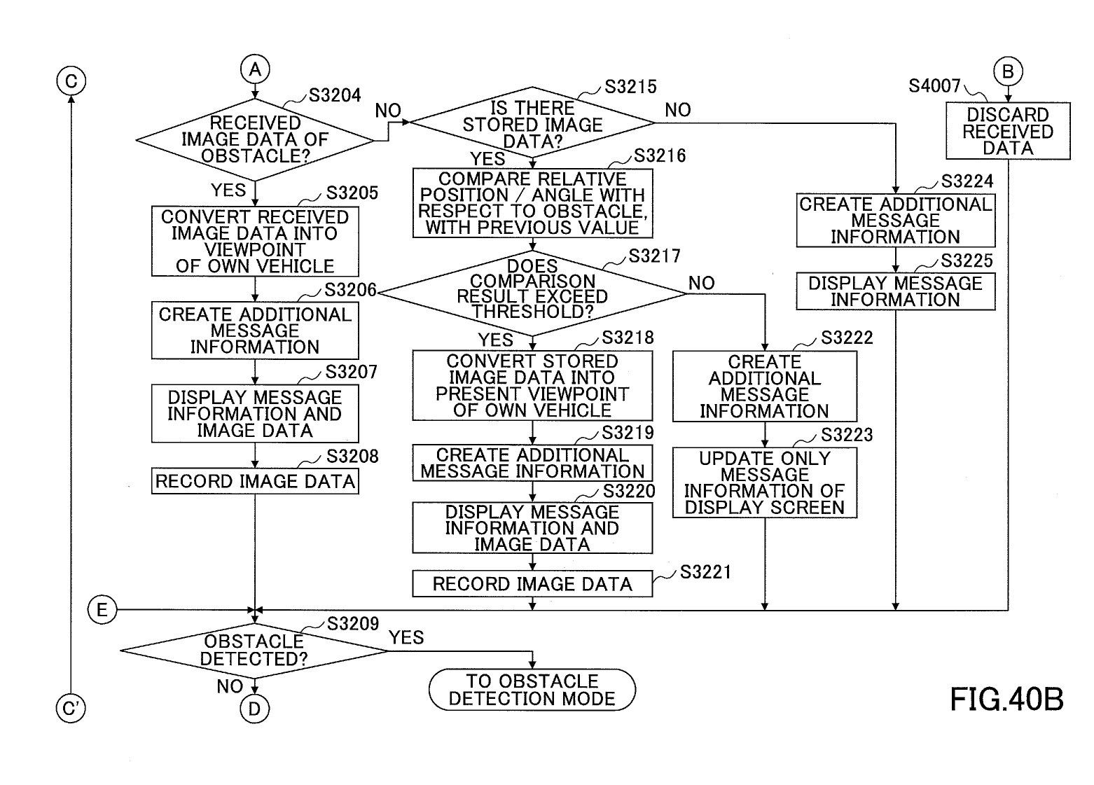

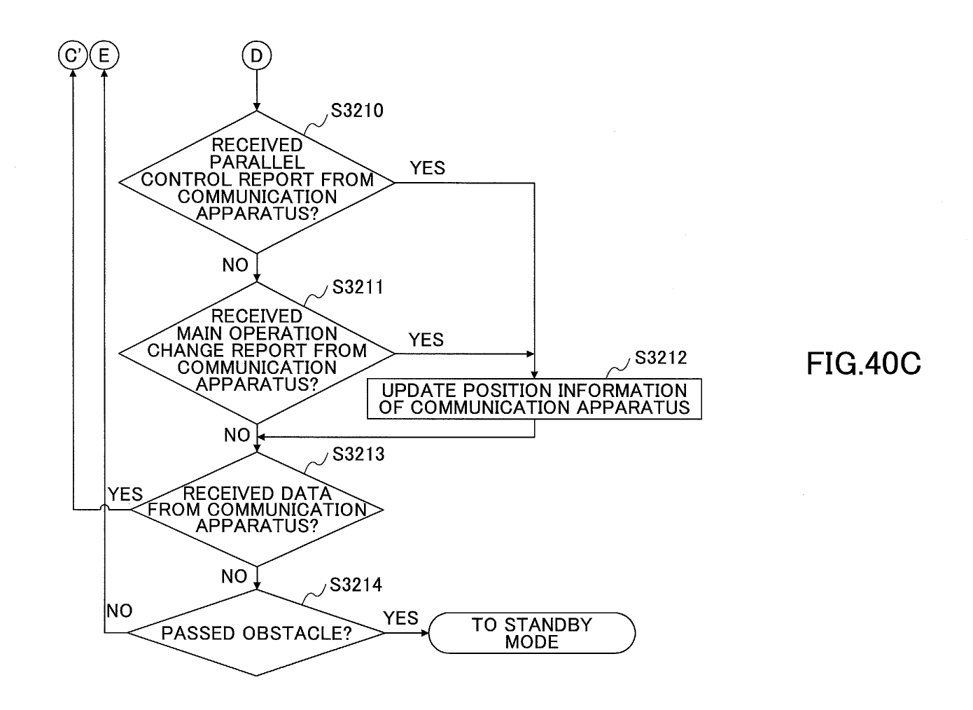

FIGS. 40A through 40C are a flowchart indicating an example of a process of a data reception mode performed by the information processing apparatus 101 according to the fifth embodiment. Note that the processes of steps S3201 through S3214 of FIGS. 40A through 40C are the same as those of the process of a data reception mode according to the fourth embodiment illustrated in FIG. 32, and therefore the differences are mainly described herein. Note that the process of the standby mode by the information processing apparatus 101 may be the same as the process of the standby mode according to the fourth embodiment illustrated in FIG. 31. Furthermore, the process of the detection mode by the information processing apparatus 101 may be the same as the process of the detection mode according to the fourth embodiment illustrated in FIG. 33.

In step S4001, the information processing apparatus 101 determines whether information of an obstacle has been received for the first time, since the data reception mode has started. When information of an obstacle has been received for the first time, the information processing apparatus 101 shifts the process to step S3201. On the other hand, when the received information of an obstacle is not the first time, that is, when the information of an obstacle is received the second time or more, the information processing apparatus 101 shifts the process to step S4002.

When the process shifts to step S4002, the acquiring unit 504 of the information processing apparatus 101 acquires the position information of the own vehicle. Accordingly, the information processing apparatus 101 can calculate the distance between the own vehicle and the obstacle.

In step S4003, the distance tag determining unit 3501 of the information processing apparatus 101 acquires the distance tag included in the information received by the information receiving unit 506.

In step S4004, the distance tag determining unit 3501 compares the distance between the own vehicle and the obstacle, with the distance tag, and in step S4005, the distance tag determining unit 3501 determines whether the received information of an obstacle is necessary information at the present position of the own vehicle.

In step S4005, when the distance tag determining unit 3501 determines that the received information of an obstacle is necessary information at the present position of the own vehicle, the information processing apparatus 101 shifts the process to step S3203. On the other hand, when the distance tag determining unit 3501 determines that the received information of an obstacle is not necessary information at the present position of the own vehicle, in step S4007, the information processing apparatus 101 discards the received data, and shifts the process to step S3209.

By the above process, when the information processing apparatus 101 receives overlapping information of obstacles from a plurality of communication units (the communication unit A through the communication unit C) of the communication apparatus 102, the information processing apparatus 101 can selectively acquire information of an obstacle according to the present position of the own vehicle. Accordingly, the information processing apparatus 101 can reduce the load of processing relevant to a plurality of pieces of information of obstacles received from a plurality of communication units, and can reduce the instances of providing the user with information that is not necessarily necessary.

### Sixth Embodiment

In the fourth and fifth embodiments, a description is given of a configuration in which the communication apparatus 102 uses a plurality of communication units having different communication ranges to report the information of an obstacle to the information processing apparatus 101. Accordingly, the information processing system 100 is able to provide information of an obstacle to information processing apparatuses 101 located in a wider range.

In a sixth embodiment, the range to which the communication apparatus 102 can provide the information of an obstacle is enlarged or supplemented by using the information processing apparatus 101 that is installed in a vehicle that is travelling in an oncoming lane.

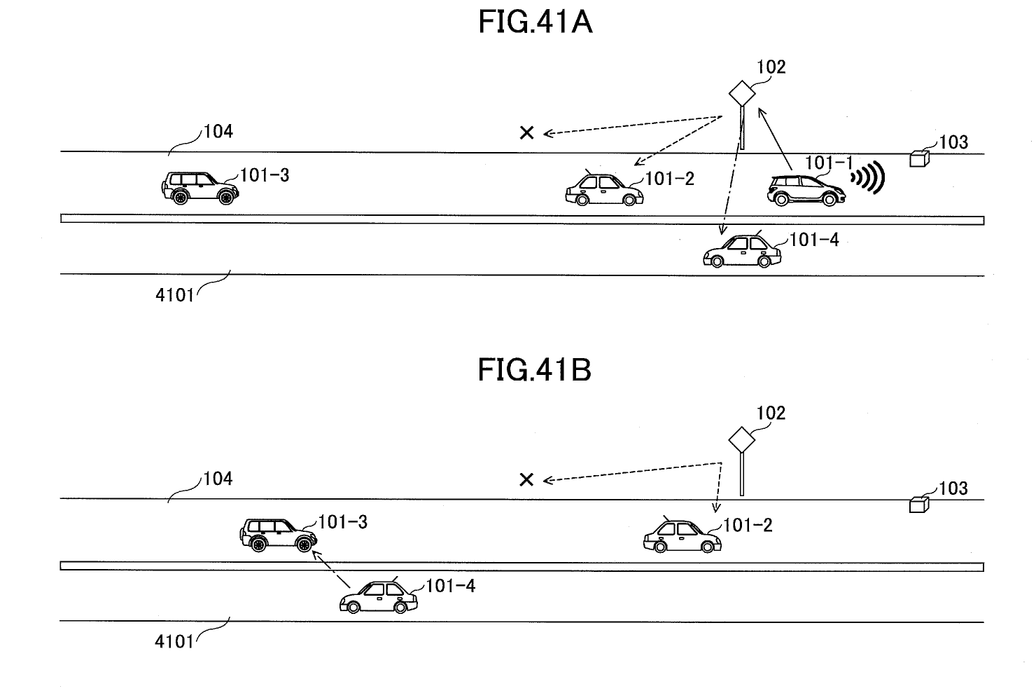

FIGS. 41A and 41B are for describing an overview of the information processing system 100 according to the sixth embodiment.

In FIG. 41A, it is assumed that a plurality of information processing apparatuses 101-1 through 101-3 are moving in a direction from the left to the right as viewed in the figure, along the road 104. Furthermore, it is assumed that the communication apparatus 102 sends information of an obstacle 103 detected by the information processing apparatus 101-1, to surrounding information processing apparatuses 101.

Note that in FIG. 41A, it is assumed that the information of an obstacle sent by the communication apparatus 102 does not reach the information processing apparatus 101-3. The reason why the information of an obstacle does not reach the information processing apparatus 101-3 is, for example, any one of a failure in the communication unit for long distance, no available lines, radio disturbance, outside the reach range of radio waves, etc.

In this case, the information processing system 100 according to the present embodiment reports information of an obstacle to the information processing apparatus 101-3 via the information processing apparatus 101-4 that is travelling along an oncoming lane 4101. For example, the communication apparatus 102 reports the information of an obstacle to the information processing apparatus 101-4 that is travelling along the oncoming lane. Note that the information of an obstacle reported to the information processing apparatus 101-4 is preferably simplified information of an obstacle, so that the load on the information processing apparatus 101-4 is reduced as much as possible. For example, the information processing apparatus 101-4 may selectively acquire message information excluding image information, from the information of an obstacle sent by the communication apparatus 102.

FIG. 41B illustrates a state after predetermined time has passed from the state of FIG. 41A. In FIG. 41B, the information processing apparatus 101-4 reports the information of an obstacle received from the communication apparatus 102 in FIG. 41A, to the information processing apparatus 101-3.

By the above configuration, the information processing system 100 can enlarge or supplement the range of reporting the information of an obstacle, by using the information processing apparatus 101-4 travelling in the oncoming lane 4101.

### <Functional Configuration>

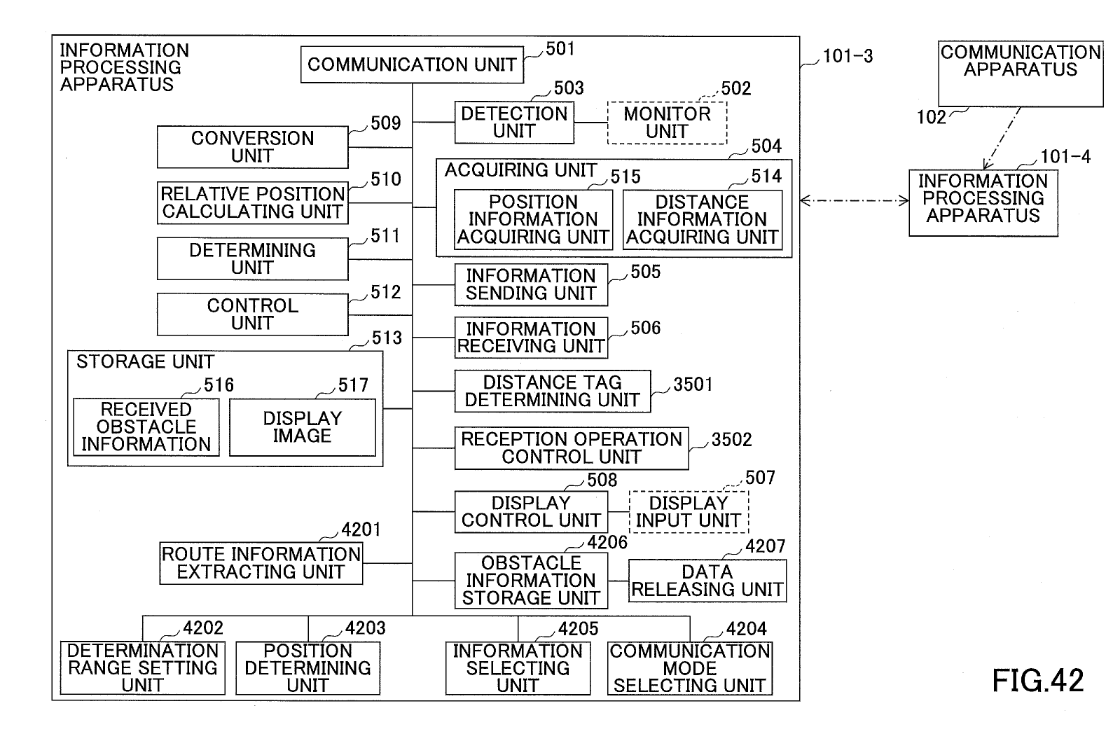

FIG. 42 illustrates a functional configuration of the information processing system 100 according to the sixth embodiment. Note that in FIG. 42, it is assumed that the information processing apparatus 101-3 and the information processing apparatus 101-4 have the same configurations.

### (Functional Configuration of Information Processing Apparatus)

The information processing apparatus 101 according to the present embodiment includes a route information extracting unit 4201, a determination range setting unit 4202, a position determining unit 4203, a communication mode selecting unit 4204, an information selecting unit 4205, an obstacle information storage unit 4206, and a data releasing unit 4207, in addition to the configurations of the information processing apparatus 101 according to the fifth embodiment illustrated in FIG. 35. Note that the above units are realized by, for example, programs operating in the CPU 301.

The route information extracting unit 4201 is a unit for acquiring the route for heading toward the destination by the vehicle in which the information processing apparatus 101 is installed. For example, when the information processing apparatus 101 is a car navigation device, etc., installed in the vehicle, the route information extracting unit 4201 is realized by a car navigation function included in the information processing apparatus 101. Alternatively, the route information extracting unit 4201 may acquire the route for the vehicle to head toward the destination, for example, from a car navigation device, a smartphone, a tablet terminal, etc.

The determination range setting unit 4202 is a unit for setting the range for determining that an obstacle is relevant to the own device, from the route extracted by the route information extracting unit 4201.

The position determining unit 4203 determines whether the received information of an obstacle corresponds to an obstacle relevant to the information processing apparatus 101, from the route extracted by the route information extracting unit 4201, the range set by the determination range setting unit 4202, and the position information of an obstacle received from the communication apparatus 102. For example, when the range for determination is set as 50 m, the position determining unit 4203 determines that an obstacle, which is within 50 m from the route extracted by the route information extracting unit 4201, is an obstacle relevant to the information processing apparatus 101. When the result of determination by the position determining unit 4203 is that the information is of an obstacle relevant to the information processing apparatus 101, the information processing apparatus 101 performs a usual process, and when the information is of an obstacle not relevant to the information processing apparatus 101, for example, the reception operation control unit 3502 discards the information.

The communication mode selecting unit 4204 is a unit for making a setting as to whether the information processing apparatuses 101 are to share the information of an obstacle. For example, the information processing apparatus 101 transmits and receives information of an obstacle with another information processing apparatus 101, according to a setting by the user.

The information selecting unit 4205 is a unit for determining the importance level of the received information of an obstacle, and selecting whether to use the information of an obstacle or to discard the information of an obstacle. Note that a specific example of the information selecting process performed by the information selecting unit 4205 is described below.

The obstacle information storage unit 4206 stores information of an obstacle (for example, simplified obstacle information) received from another information processing apparatus 101. Note that the information of an obstacle received from another information processing apparatus 101 is preferably simplified information that does not include image data, etc., from the viewpoint of the data amount.

The data releasing unit 4207 deletes the information of an obstacle stored in the obstacle information storage unit 4206 according to a predetermined condition (for example, after a predetermined time passes).

### <Information Selection Process>

Here, a description is given of an example of an information selection process performed by the information selecting unit 4205.

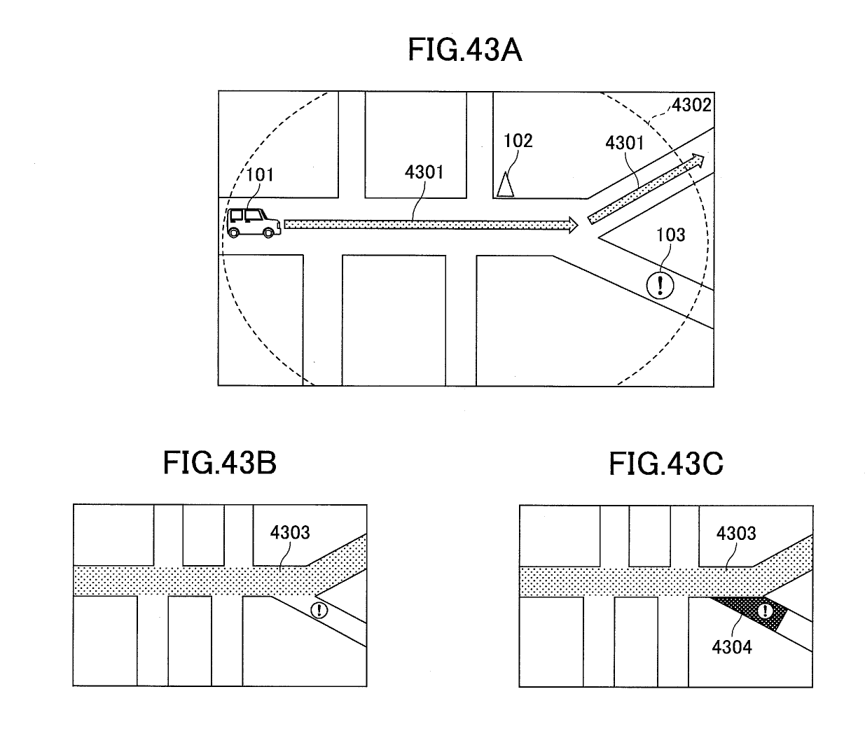

FIGS. 43A through 43C illustrate an example of whether to receive obstacle information according to the sixth embodiment.

FIG. 43A illustrates an image of a route extracted by the route information extracting unit 4201. In FIG. 43A, the two arrows 4301 indicate the route along which the information processing apparatus 101 (or a vehicle in which the information processing apparatus 101 is installed) proceeds. Furthermore, it is assumed that the information processing apparatus 101 is within the communication range 4302 of the communication apparatus 102. Furthermore, it is assumed that there is an obstacle 103 at a point different from the route along which the information processing apparatus 101 proceeds.

In this case, the information processing apparatus 101 is positioned within the communication range 4302 of the communication apparatus 102, and therefore receives information of an obstacle 103 sent by the communication apparatus 102.

In this case, as illustrated in FIG. 43B, for example, the information selecting unit 4205 of the information processing apparatus 101 can implement control so as not to use the information of an obstacle 103 at a point different from the route 4303 along which the information processing apparatus 101 proceeds.

Alternatively, as illustrated in FIG. 43C, the information selecting unit 4205 of the information processing apparatus 101 may implement control so as to use information of an obstacle within a predetermined range 4304 from the route 4303 along which the information processing apparatus 101 proceeds. This is because if the obstacle 103 is a moving object, there is a possibility that the obstacle 103 will move to the route 4303.

Furthermore, the information selecting unit 4205 also implements control of selecting the information of an obstacle to be used, from between the information of an obstacle received from the communication apparatus 102 and the information of an obstacle received from another information processing apparatus 101.

For example, it is assumed that an obstacle appears while the information processing apparatus 101 is travelling in a location where the radio disturbance is high at a certain time point, and the information processing apparatus 101 cannot receive information from the communication apparatus 102, so the information processing apparatus 101 receives information from another information processing apparatus 101 proceeding along an oncoming lane. In this case, the information processing apparatus 101 that receives the information generates information to be provided to the user, based on the (simplified) information of an obstacle received from the other information processing apparatus 101. During this time, when the information processing apparatus 101 moves to a point where the radio disturbance is relatively low and receives information of an obstacle from the communication apparatus 102, the information selecting unit 4205 implements control to preferentially use the information of an obstacle received from the communication apparatus 102.

Furthermore, when the information processing apparatus 101 receives information of an obstacle from both the communication apparatus 102 and another information processing apparatus 101, for example, the information selecting unit 4205 implements control to preferentially use the information of an obstacle received from the communication apparatus 102.

### <Process Flow>

### (Process of Standby Mode of Information Processing Apparatus)

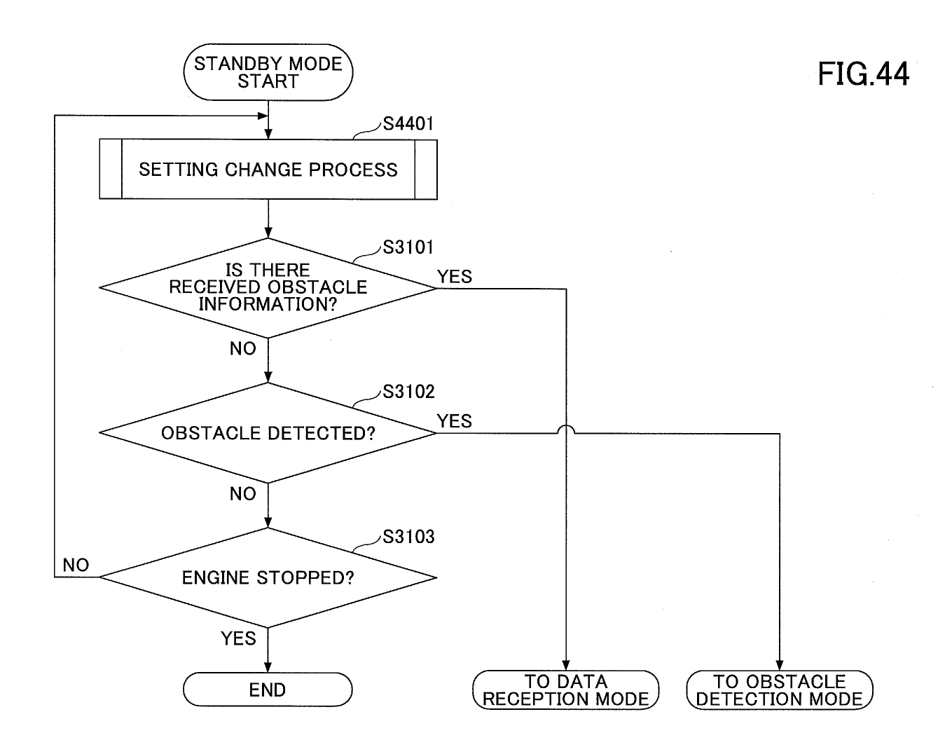

FIG. 44 is a flowchart indicating an example of a process of a standby mode performed by the information processing apparatus 101 according to the sixth embodiment. Note that the processes of steps S3101 through S3103 of FIG. 44 are the same as those of the process of the standby mode according to the fourth embodiment illustrated in FIG. 31, and therefore the differences are mainly described herein.

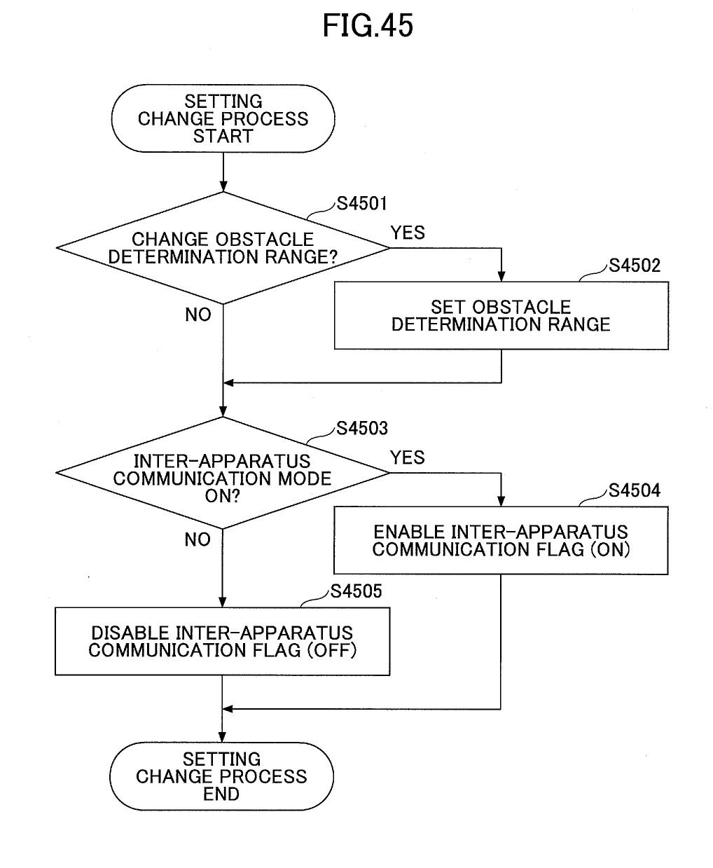

In step S4401, when the information processing apparatus 101 according to the present embodiment starts the process of the standby mode, the information processing apparatus 101 performs a setting change process. Note that the setting change process is described with reference to FIG. 45.

### (Setting Change Process of Information Processing Apparatus)

FIG. 45 is a flowchart indicating an example of a setting change process performed by the information processing apparatus 101 according to the sixth embodiment.

In step S4501, the information processing apparatus 101 determines whether to change the setting of the range for determining an obstacle, from the route extracted by the route information extracting unit 4201, for example, based on a user's operation, etc. When the setting is to be changed, in step S4502, the determination range setting unit 4202 sets the range for determining an obstacle, for example, based on a user's operation, etc., and shifts the process to step S4503. On the other hand, when the setting is not to be changed, the information processing apparatus 101 does not set the range for determining an obstacle, and shifts the process to step S4503.

When the process shifts to step S4503, the communication mode selecting unit 4204 of the information processing apparatus 101 determines whether to perform communication of sending and receiving information of an obstacle with another information processing apparatus 101 (hereinafter, “inter-apparatus communication”), for example, based on a user's operation, etc. When performing inter-apparatus communication, in step S4504, the communication mode selecting unit 4204 enables an “inter-apparatus communication flag” (ON) indicating to perform inter-apparatus communication. On the other hand, when inter-apparatus communication is not to be performed, the communication mode selecting unit 4204 disables an “inter-apparatus communication flag” (OFF) in step S4505.

### (Process of Data Reception Mode of Information Processing Apparatus)

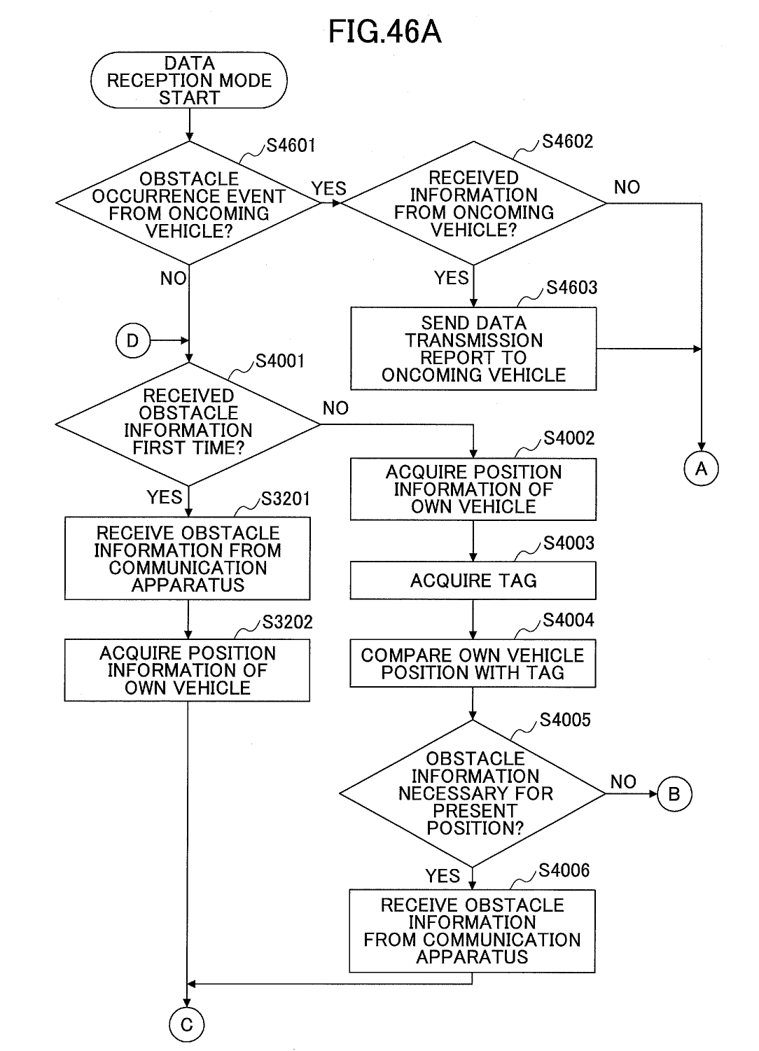

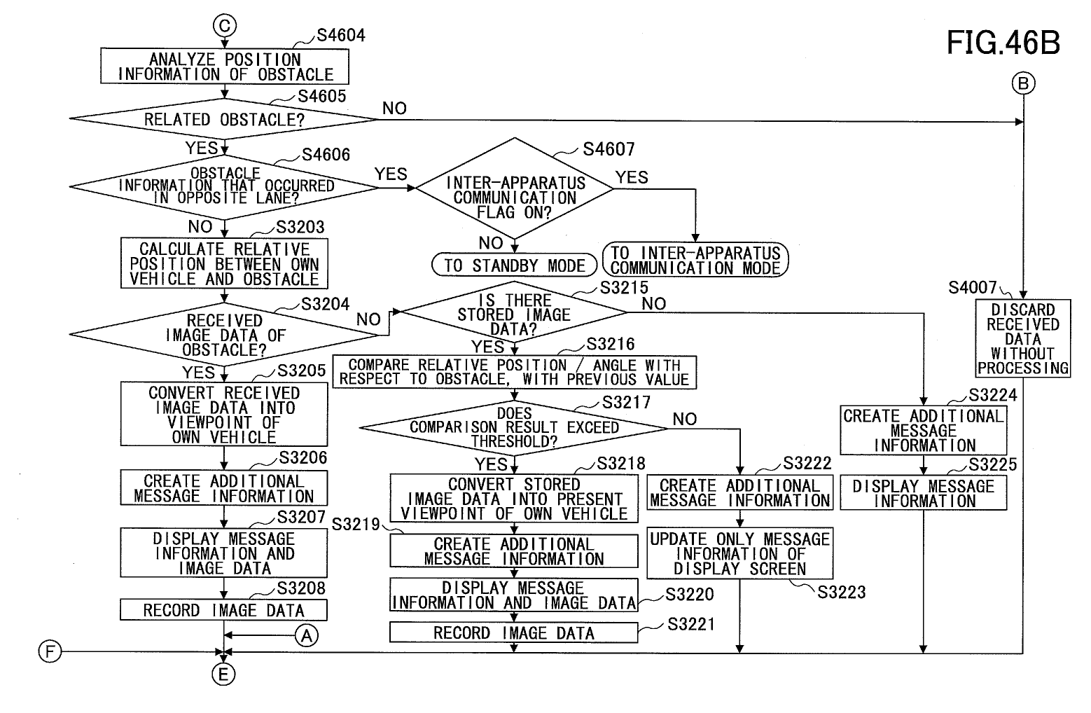

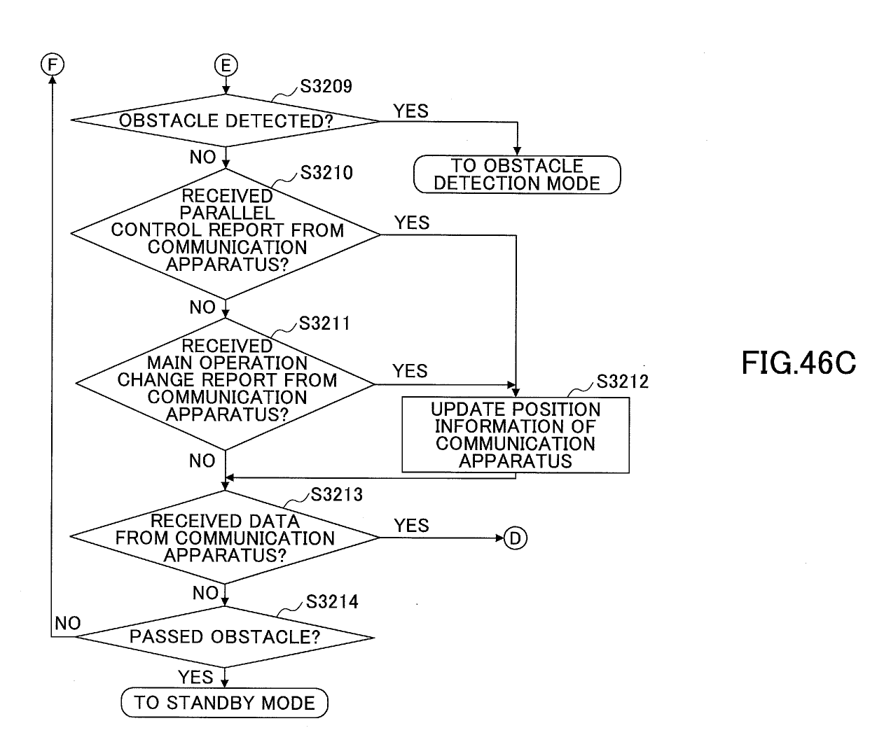

FIGS. 46A through 46C are flowcharts indicating an example of a process of a data reception mode performed by the information processing apparatus 101 according to the sixth embodiment. Note that the processes of steps S4001 through S4007 of FIGS. 46A through 46C are the same as those of the process of a data reception mode according to the fifth embodiment illustrated in FIGS. 40A through 40C. Furthermore, the processes of steps S3201 through S3214 of FIGS. 46A through 46C are the same as those of the process of a data reception mode according to the fourth embodiment illustrated in FIG. 32. Therefore, the differences are mainly described herein.

In step S4601, when the information receiving unit 506 of the information processing apparatus 101 receives information, the information receiving unit 506 determines whether the received information is an obstacle occurrence event from the information processing apparatus 101 of an oncoming vehicle. Note that the obstacle occurrence event is information indicating that the information processing apparatus 101 of the oncoming vehicle includes obstacle information that has been received from the communication apparatus 102 and stored. When the received information is not an obstacle occurrence event from the information processing apparatus 101 of an oncoming vehicle, the information processing apparatus 101 shifts the process to step S4001. On the other hand, when the received information is an obstacle occurrence event from the information processing apparatus 101 of an oncoming vehicle, the information processing apparatus 101 shifts the process to step S4602.

When the process shifts to step S4602, the information processing apparatus 101 determines whether to receive information from the information processing apparatus 101 of the oncoming vehicle. When the information is to be received from the information processing apparatus 101 of the oncoming vehicle, in step S4603, the information processing apparatus 101 sends a data transmission report to the information processing apparatus 101 of the oncoming vehicle, shifts the process to step S3209, and waits to receive subsequent data. On the other hand, when the information is not to be received from the information processing apparatus 101 of the oncoming vehicle, the information processing apparatus 101 shifts the process to step S3209, and waits to receive subsequent data. Note that the data transmission report is information for requesting the information processing apparatus 101 of the oncoming vehicle sending the obstacle occurrence event, to send the information of an obstacle.

Preferably, the above-described “obstacle occurrence event”, the “data transmission report”, the “information of an obstacle”, etc., include information indicating the movement direction, indicating the corresponding movement direction of each information item. For example, in the case of a high-speed way, the information indicating the movement direction may indicate “unbound”, “down bound”, “to Tokyo”, “to Osaka”, etc. In the case of a general road, the information may indicate a direction such as “north”, “south”, etc. Accordingly, the information processing apparatus 101 can determine whether the received information is information of its own lane or information of the oncoming lane.

Furthermore, in step S4604, the position determining unit 4203 of the information processing apparatus 101 determines whether the position of the obstacle of the received information is included in the route extracted by the route information extracting unit 4201, and furthermore, within the range set by the determination range setting unit 4202.

In step S4605, the position determining unit 4203 determines whether the received information of an obstacle is relevant to the own apparatus (information processing apparatus 101), based on the determination result of step S4604. When the position determining unit 4203 determines that the received information of an obstacle is relevant to the own apparatus, the information processing apparatus 101 shifts the process to step S4606. On the other hand, when the position determining unit 4203 determines that the received information of an obstacle is not relevant to the own apparatus, in step S4007, the information processing apparatus 101 determines that the obstacle of the received information will not affect the information processing apparatus 101, and shifts the process to step S3209.

In step S4606, the information processing apparatus 101 determines whether the received information is information of an obstacle that has occurred in the opposite lane. When the received information is not information of an obstacle that has occurred in the opposite lane (when the received information is information of an obstacle that has occurred in the own lane), the information processing apparatus 101 shifts the process to step S3202. On the other hand, when the received information is information of an obstacle that has occurred in the opposite lane, the information processing apparatus 101 shifts the process to step S4607.

When the process shifts to step S4607, the information processing apparatus 101 determines whether the inter-apparatus communication flag is enabled (ON). When the inter-apparatus communication flag is disabled (OFF), the information processing apparatus 101 shifts the process to the standby mode. On the other hand, when the inter-apparatus communication flag is enabled (ON), the information processing apparatus 101 shifts the process to the inter-apparatus communication mode (communication process between apparatuses).

### (Communication Process Between Information Processing Apparatuses)

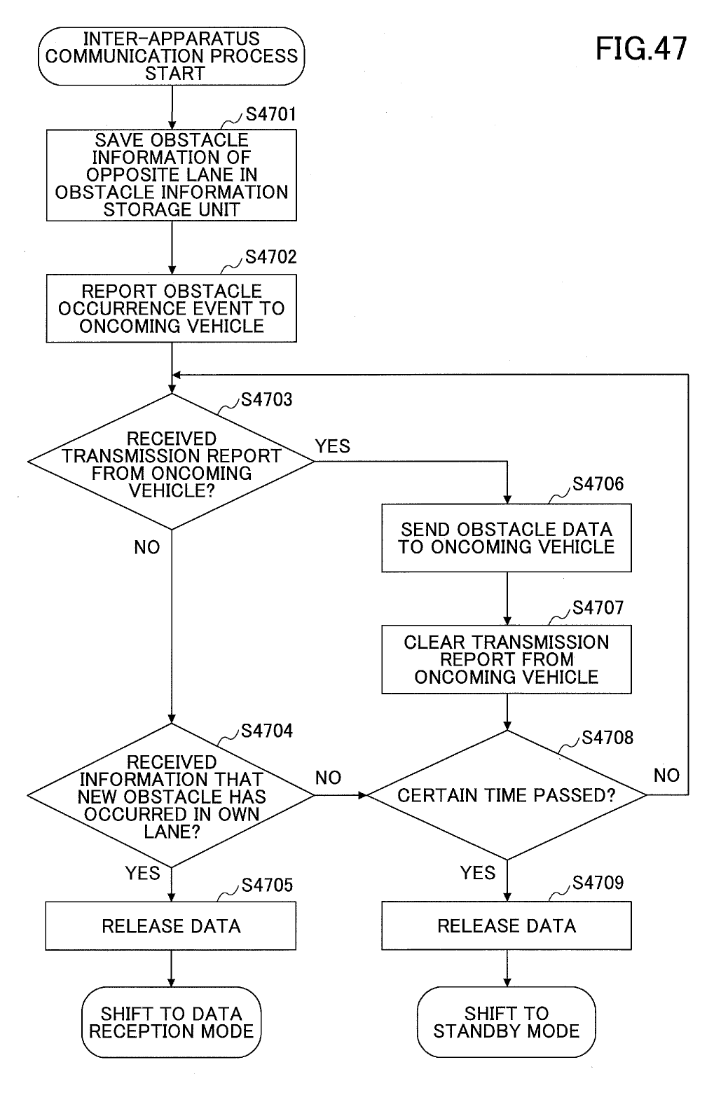

FIG. 47 is a flowchart indicating an example of a communication process between information processing apparatuses 101 according to the sixth embodiment.

In step S4701, the information processing apparatus 101 saves (stores) the information received from the communication apparatus 102, in the obstacle information storage unit 4206.

In step S4702, the information processing apparatus 101 reports an obstacle occurrence event to the information processing apparatus 101 of the oncoming vehicle (vehicle in lane where obstacle is occurring).

In step S4703, the information processing apparatus 101 determines whether a transmission report has been received from the information processing apparatus 101 of the oncoming vehicle. When a transmission report has been received, the information processing apparatus 101 shifts the process to step S4706. On the other hand, when a transmission report has not been received, the information processing apparatus 101 shifts the process to step S4704.

When the process shifts to step S4706, the information processing apparatus 101 sends information of an obstacle to the information processing apparatus 101 of the oncoming vehicle (vehicle traveling in lane where the obstacle has occurred).

In step S4707, the information processing apparatus 101 clears (deletes) the transmission report received from the information processing apparatus 101 of the oncoming vehicle.

When the process shifts to step S4708, the information processing apparatus 101 determines whether a predetermined time (for example, five minutes) has passed from the time when the oncoming vehicle has received the data for the first time from the communication apparatus 102. When the predetermined time has not passed, the information processing apparatus 101 returns the process to step S4703 and repeats the same process. On the other hand, when the predetermined time has passed, in step S4709, the information processing apparatus 101 releases the data (deletes the information) in the obstacle information storage unit 4206, and shifts the process to the standby mode.

On the other hand, when the process shifts to step S4704, the information processing apparatus 101 determines whether a new obstacle has occurred in the own lane, for example, by receiving information of an obstacle from the communication apparatus 102, etc. When a new obstacle has occurred in the own lane, in step S4705, the information processing apparatus 101 releases the data (discards the information) stored in the obstacle information storage unit 4206, and shifts the process to the data reception mode. On the other hand, when a new obstacle has not occurred in the own lane, the information processing apparatus 101 shifts the process to step S4708.

Note that the priority level of the information used in the communication between information processing apparatuses 101 is low, and therefore when another process occurs (for example, information is received from the communication apparatus 102, etc.), the process may be interrupted and a process of a higher priority level may be executed.

Furthermore, the process of the obstacle detection mode performed by the information processing apparatus 101 may be the same as the process of the detection mode according to the fifth embodiment illustrated in FIGS. 39A and 39B.

By the above process, for example, it is possible to enlarge or supplement the range of providing information of an obstacle by the communication apparatus 102, for example, by using the information processing apparatus 101 which is installed in a vehicle proceeding in an oncoming lane.

### <Overview>

An information processing apparatus (101) according to the present embodiment is an information processing apparatus (101) for providing information to a user of a vehicle, and includes a detector (503) configured to detect a first obstacle (103) around the vehicle, by using a monitoring unit (502) configured to monitor an area around the vehicle. Furthermore, the information processing apparatus (101) includes an acquirer (504) configured to acquire information relating to a position of the detected first obstacle (103). Furthermore, the information processing apparatus (101) includes an information transmitter (505) configured to transmit first obstacle information including the acquired information relating to the position of the first obstacle (103), to a first external apparatus (102).

Furthermore, the information processing apparatus (101) includes an information receiver (506) configured to receive second obstacle information including information relating to a position of a second obstacle (103) from a second external apparatus (101). Furthermore, the information processing apparatus (101) includes a display controller (508) configured to display, on a displayer (507), information (107, 108, etc.) relating to the second obstacle (103), based on the received second obstacle information.

By the above configuration, when the information processing apparatus (101) detects an obstacle around the vehicle, the information processing apparatus (101) can send obstacle information relating to the detected first obstacle, to the external apparatus (102).

Furthermore, for example, when the information processing apparatus (101) receives, from the external apparatus (102), obstacle information relating to the second obstacle detected by another information processing apparatus (101), the information processing apparatus (101) can display the information (107, 108, etc.) relating to the second obstacle, based on the received obstacle information.

Accordingly, the information processing system (100) according to the present embodiment can quickly and easily report information of an obstacle (103), etc., at any point on a road, to a user of a vehicle travelling near the obstacle.

Note that the above reference numerals in parenthesis are appended to facilitate understanding; however, the reference numerals are merely examples, and do not limit the scope of the present invention.

For example, the communication apparatus 102 is an example of a first external apparatus that sends obstacle information relating to a first obstacle detected by the information processing apparatus 101. The first external apparatus may be, for example, another information processing apparatus 101 or vehicle around the information processing apparatus 101, etc., or a management server with which communication can be performed via a network, etc.

Similarly, the communication apparatus 102 is an example of a second external apparatus from which the information processing apparatus 101 receives second obstacle information. The second external apparatus may be, for example, another information processing apparatus 101 or vehicle around the information processing apparatus 101, etc., or a management server with which communication can be performed via a network, etc. Furthermore, the first external apparatus and the second external apparatus may be the same apparatus or different apparatuses.

As described above, the information processing system 100 according to the present embodiment may have various system configurations.

According to one embodiment of the present invention, an information processing apparatus and an information processing system are provided, which can quickly and easily report information of an obstacle, etc., at any point on a road, to a user of a vehicle travelling near the obstacle.

The information processing apparatus and the information processing system are not limited to the specific embodiments described herein, and variations and modifications may be made without departing from the spirit and scope of the present invention.

The present application is based on and claims the benefit of priority of Japanese Priority Patent Application No. 2015-012056, filed on Jan. 26, 2015, and Japanese Priority Patent Application No. 2015-120558, filed on Jun. 15, 2015, the entire contents of which are hereby incorporated herein by reference.

What is claimed is:

1. An information processing apparatus for providing information to a user of a vehicle, the information processing apparatus comprising:
a detector configured to detect a first obstacle around the vehicle, by using a monitoring unit configured to monitor an area around the vehicle;
an acquirer configured to acquire information relating to a position of the detected first obstacle;
an information transmitter configured to transmit first obstacle information including the acquired information relating to the position of the first obstacle, to a first external apparatus;
an information receiver configured to receive second obstacle information including information relating to a position of a second obstacle, from a second external apparatus; and
a display controller configured to display, on a displayer, information relating to the second obstacle, based on the received second obstacle information.

2. The information processing apparatus according to claim 1, wherein
the monitoring unit includes a camera configured to capture an image of the area around the vehicle, and
the detector detects the first obstacle based on the captured image.

3. The information processing apparatus according to claim 1, wherein
the first obstacle information includes an image of the detected first obstacle.

4. The information processing apparatus according to claim 1, wherein
the acquirer includes
a first acquirer configured to acquire position information of the vehicle, and
a second acquirer configured to acquire distance information indicating a distance between the vehicle and the detected first obstacle, wherein
the information relating to the position of the first obstacle includes the position information of the vehicle and the distance information indicating the distance between the vehicle and the detected first obstacle.

5. The information processing apparatus according to claim 1, wherein
the information relating to the second obstacle, which is caused to be displayed by the display controller, includes information relating to a distance or a time from the vehicle to the second obstacle.

6. The information processing apparatus according to claim 1, wherein
the second obstacle information includes an image of the second obstacle, and
the information relating to the second obstacle, which is caused to be displayed by the display controller, includes a display image based on the image of the second obstacle.

7. The information processing apparatus according to claim 6, further comprising:
a converter configured to convert the received image of the second obstacle into an image according to the vehicle, to generate the display image.

8. An information processing system comprising:
an information processing apparatus for providing information to a user of a vehicle; and
at least one external apparatus installed along a road, wherein
the information processing apparatus includes
a detector configured to detect a first obstacle around the vehicle, by using a monitoring unit configured to monitor an area around the vehicle,
an acquirer configured to acquire information relating to a position of the detected first obstacle,
an information transmitter configured to transmit first obstacle information including the acquired information relating to the position of the first obstacle, to a first external apparatus,
an information receiver configured to receive second obstacle information including information relating to a position of a second obstacle, from a second external apparatus, and
a display controller configured to display, on a displayer, information relating to the second obstacle, based on the received second obstacle information, and wherein
the at least one external apparatus includes
a receiver configured to receive the first obstacle information including the information relating to the position of the first obstacle sent from the information processing apparatus, and
a reporter configured to report the received first obstacle information or information based on the first obstacle information, to at least one of the information processing apparatuses or at least one of the vehicles within a predetermined range.

9. The information processing system according to claim 8, wherein
the at least one external apparatus includes
a report controller configured control a report content, a report frequency, or a necessity of reporting, with respect to the information reported by the reporter.

10. A non-transitory computer-readable recording medium storing a program that causes a computer that constitutes an information processing apparatus for providing information to a user of a vehicle, to execute a process, the process comprising:
detecting a first obstacle around the vehicle, by using a monitoring unit configured to monitor an area around the vehicle;
acquiring information relating to a position of the detected first obstacle;
transmitting first obstacle information including the acquired information relating to the position of the first obstacle, to a first external apparatus;
receiving second obstacle information including information relating to a position of a second obstacle, from a second external apparatus; and
displaying, on a displayer, information relating to the second obstacle, based on the received second obstacle information.
